(19) United States
(12) Patent Application Publication
(10) Pub. No.: US 2008/0160445 A1
(43) Pub. Date: Jul. 3, 2008

(54) Planographic printing plate material, and method of preparing planographic printing plate employing the same

(75) Inventor: Yoshiyuki Nonaka, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 12/004,328

(22) Filed: Dec. 20, 2007

(30) Foreign Application Priority Data
Dec. 27, 2006 (JP) JP2006-351553

(51) Int. Cl. G11B 7/244

(52) U.S. Cl. 430/270.14; 430/309

(57) ABSTRACT

An objective is to provide a positive-working planographic printing plate material exhibiting scratch resistance useful for high productivity in large size printing, and excellent sensitivity and development latitude against a developer having a low pH or a worn-out inactive developer, as well as a method of preparing a planographic printing plate employing the planographic printing plate material. Also disclosed is a positive-working planographic printing plate material possessing a support and provided thereon, a light-sensitive layer, wherein the light-sensitive layer possesses a compound containing a residue of a cyclic ureide compound having a cyclic structure having at least two amide bonds (—NHCO—) in a cycle.

This application claims priority from Japanese Patent Application No. 2006-351553 filed on Dec. 27, 2006, which is incorporated hereinto by reference.

### TECHNICAL FIELD

The present invention relates to a positive-working light-sensitive planographic printing plate material, that is, a planographic printing plate material used in a computer to plate (hereinafter referred to as CTP) system, and particularly to a planographic printing plate material capable of forming an image via exposure to near infrared laser, which exhibits excellent sensitivity, development latitude, scratch resistance and resistance to chemicals, as well as a method of preparing a planographic printing plate employing the planographic printing plate material.

### BACKGROUND

In recent years, printing image data are digitized and a so-called CTP system is widely used which comprises exposing a planographic printing plate material employing laser signals to which the digitized data are converted. Presently, laser technique is markedly developed, and a compact solid or semiconductor laser with high output power, which has an emission wavelength of from near-infrared to infrared regions, is available from the market. Such a laser is very useful as a light source for manufacturing a printing plate employing digitized data from a computer.

Along with advancing the delivery date of prints, high productivity with an exposure device, i.e., exposure time and conveyance time have recently been shortened. In printing, productivity in the case of two surface prints, four surface prints and the like for large size print has also been improved. In such the situation, scratches caused by the conveyance are generated to printing plate materials with a developing device employed for the large size print. However, a satisfactory exposure device has not yet been obtained though studying an exposure device intensively. Thus, improvement of a printing plate material is also demanded.

On the other hand, as an infrared laser sensitive planographic printing plate material, there is proposed a positive working planographic printing plate material comprising a recording layer containing an aqueous alkali solution soluble resin (A) having a phenolic hydroxyl group and such as a cresol novolak resin and an infrared absorbing dye (B) (refer to Patent Document 1). In this positive working planographic printing plate material, association structure of the cresol novolak resin is changed at exposed portions by heat generated from the infrared absorbing dye, whereby solubility difference (solubility speed difference) between the exposed and unexposed portions is produced. Employing the solubility difference, development of the exposed planographic printing plate material is carried out to form an image. However, there was a problem such that a development restraining property (clear sensitivity) of the recording layer at non-image portions could not be sufficiently obtained since development latitude was narrow because of the small difference of solubility speed, and heat quantity was also reduced in the area close to a support.

In order to improve such the sensitivity shortage and a problem such as narrow development latitude, disclosed is a planographic printing plate material in which the sensitivity and development latitude are improved by introducing an amide group or such into a novolak resin via esterification reaction, or introducing a quinonediazide group via esterification of a sulfonic acid or such, aiming at association structure of the cresol novolak resin, i.e., improvement of hydrogen bonding (refer to Patent Documents 2 and 3, for example). However, satisfactory sensitivity and development latitude has not yet been obtained though they are slightly improved via introduction of the above-described substitutents. Further, sufficient scratch resistance caused by a high-speed exposure device employed for the above-described large size print has not yet been obtained.

Further, a novolak resin having a substituent capable of forming a noncovalent electron pair bonding site having a hydrogen bond is disclosed (refer to Patent Document 4, for example). In the case of the above-described hydrogen bond, the same substituent-to-substituent forms a pair, whereby interaction of hydrogen bonds at not less than 2 sites is formed to improve development latitude, resistance to chemicals and so forth, but they are insufficient in the case of a developer having a pH of not more than 13.0 or a worn-out developer, and the high-speed exposure device employed for the above-described large size print also exhibits insufficient scratch resistance.

(Patent Document 1) WO 97/39894

(Patent Document 2) Published Japanese translation of PCT international Publication No. 2002-510404

(Patent Document 3) Japanese Patent O.P.I. Publication No. 11-288089

(Patent Document 4) Published Japanese translation of PCT international Publication No. 2004-526986

### SUMMARY

The present invention has been made on the basis of the above-described situation. It is an object of the present invention to provide a positive-working planographic printing plate material exhibiting scratch resistance useful for high productivity in large size printing, and excellent sensitivity and development latitude against a developer having a low pH or a worn-out inactive developer, as well as a method of preparing a planographic printing plate employing the planographic printing plate material. Also disclosed is a positive-working planographic printing plate material comprising a support and provided thereon, a light-sensitive layer, wherein the light-sensitive layer comprises a compound containing a residue of a cyclic ureide compound having a cyclic structure having at least two amide bonds (—NHCO—) in a cycle.

### DESCRIPTION OF THE PREFERRED EMBODIMENTS

The above object of the present invention is accomplished by the following structures.

(Structure 1) A positive-working planographic printing plate material comprising a support and provided thereon, a light-sensitive layer, wherein the light-sensitive layer comprises a compound containing a residue of a cyclic ureide compound having a cyclic structure having at least two amide bonds (—NHCO—) in a cycle.

(Structure 2) The positive-working planographic printing plate material of Structure 1, wherein the compound containing a residue of a cyclic ureide compound comprises a compound containing a residue of another cyclic ureide compound, and at least two hydrogen bonds.

(Structure 3) The positive-working planographic printing plate material of Structure 1 or 2, wherein the compound containing a residue of a cyclic ureide compound forms a supermolecule via hydrogen bonding.

(Structure 4) The positive-working planographic printing plate material of any one of Structures 1-3, wherein the cyclic ureide compound having the cyclic structure is urazol, a parabanic acid, uracil, thymine, orotic acid or an isocyanuric acid.

(Structure 5) The positive-working planographic printing plate material of any one of Structures 1-4, wherein the light-sensitive layer comprises an acid decomposable compound and an acid generating compound.

(Structure 6) The positive-working positive-working planographic printing plate material of Structure 5, wherein the acid decomposable compound is represented by Formula (1):

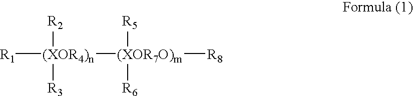

wherein R₁ represents a hydrogen atom, an alkyl group, an aryl group, an alkoxy group, an aryloxy group or a halogen atom; each of R₂ and R₅ represents a hydrogen atom, an alkyl group or an aryl group; each of R₃ and R₆ represents an alkyl group or an aryl group; R₄ represents an ethyleneoxy group or a propyleneoxy group; R₂ and R₃, or R₅ and R₆ may combine with each other to form a substituted ring; R₇ represents an alkylene group; R₈ represents a hydrogen atom, —XR₂R₃R₁ or —XR₅R₆R₁; X represents a carbon atom or a silicon atom; n represents an integer of 1 or more; and m represents an integer of 0 or more.

(Structure 7) The positive-working planographic printing plate material of Structure 6, wherein the compound represented by Formula (1) is acetal.

(Structure 8) The positive-working planographic printing plate material of any one of Structures 1-7, wherein the light-sensitive layer comprises an upper light-sensitive layer and a lower light-sensitive layer, and at least one of the light-sensitive layers comprises the residue of the cyclic ureide compound having the cyclic structure.

(Structure 9) The positive-working planographic printing plate material of Structure 8, wherein the lower light-sensitive layer comprises a compound represented by Formula (1) or a compound represented by the following Formula (2):

R¹—C(X)₂—(C═O)—R² Formula (2)

wherein R¹ represents a hydrogen atom, a bromine atom, a chlorine atom, an alkyl group, an aryl group, an acyl group, an alkylsulfonyl group, an arylsulfonyl group, an iminosulfonyl group or a cyano group; R² represents a hydrogen atom or a monovalent organic substituent, but R¹ and R² may combine with each other to form a ring; and X represents a bromine atom or a chlorine atom.

(Structure 10) The positive-working planographic printing plate material of any one of Structures 1-9, wherein the light-sensitive layer comprises a compound containing a melamine group or a triazine group.

(Structure 11) The positive-working planographic printing plate material of Structure 10, wherein the compound is a resin.

(Structure 12) The positive-working planographic printing plate material of Structure 10 or 11, wherein the light-sensitive layer comprises the compound containing a residue of a cyclic ureide compound hydrogen-bonded to the compound containing a melamine group or a triazine group.

(Structure 13) The positive-working planographic printing plate material of any one of Structures 1-12, wherein the light-sensitive layer comprises an infrared absorbing compound.

(Structure 14) The positive-working planographic printing plate material of any one of Structures 1-13, wherein the support is made of aluminum.

(Structure 15) The positive-working planographic printing plate material of any one of Structures 1-14, wherein the positive-working planographic printing plate material is an alkaline-developing planographic printing plate material.

(Structure 16) A method of preparing a planographic printing plate comprising the steps of:

exposing the positive-working planographic printing plate material of any one of Structures 1-15 to infrared laser having a wavelength of 780-1200 nm; and treating the planographic printing plate material with an alkaline developer to remove non-image portions.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

In the present invention, disclosed is a positive-working planographic printing plate material possessing a support and provided thereon, a light-sensitive layer, wherein the light-sensitive layer possesses a compound containing a residue of a cyclic ureide compound having a cyclic structure having at least two amide bonds (—NHCO—) in a cycle. This technical feature relates to Structures of 1-16. Next, the present invention will be described in detail.

### (Compound Containing Residue of Cyclic Ureide Compound)

The cyclic ureide compound of the present invention has a cyclic structure having at least two amide bonds (—NHCO—) in a cycle. The residue of the cyclic ureide compound is a group acquired by removing at least one of a hydrogen atom with an amide bond in the cyclic ureide compound and a hydrogen atom without an amide bond. In addition, the compound containing a residue of a cyclic ureide compound of the present invention comprises one in which the residue of the cyclic ureide compound is bonded to hydrogen, that is, or a cyclic ureide compound itself.

The cyclic ureide compound of the present invention is capable of having at least two hydrogen bonds combined with another compound with respect to the one compound. In this case, a supermolecule is also possible to be formed. In addition, “supermolecule” herein is referred to as a compound in which a plurality of molecules are gathered together with bonds except for covalent bond (coordinate bond, hydrogen bond and so forth) via comparatively week interaction.

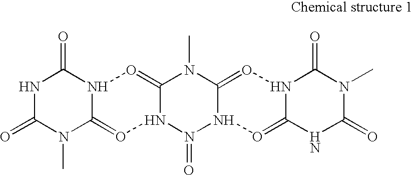

Examples of the cyclic ureide compound of the present invention include bioluric acid, uric acid, imidazolidinone, urazol, triazlolinedione, parabanic acid, uracil, thymine, orotic acid and isocyanuric acid. Of these, urazol, parabanic acid, uracil, thymine, orotic acid and isocyanuric acid are preferable in view of sensitivity and scratch resistance, uracil, thymine and isocyanuric acid are more preferable, and isocyanuric acid is still more preferable. Accordingly, the above-described cyclic ureide compound and derivatives thereof are provided as the compound containing a residue of a cyclic ureide compound of the present invention.

The compound containing a residue of an isocyanuric acid as a cyclic ureide compound of the present invention is represented by the following structure.

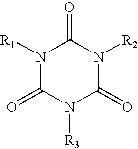

wherein each of R₁, R₂ and R₃ independently represents a hydroxyl group, a carboxyl group, an amino group, a cyano group, an alkoxy group, acyl group, an amide group or an alkyl group having 1-3 carbon atoms substituted by the group. The following compound is listed as a compound containing a residue of isocyanuric acid.

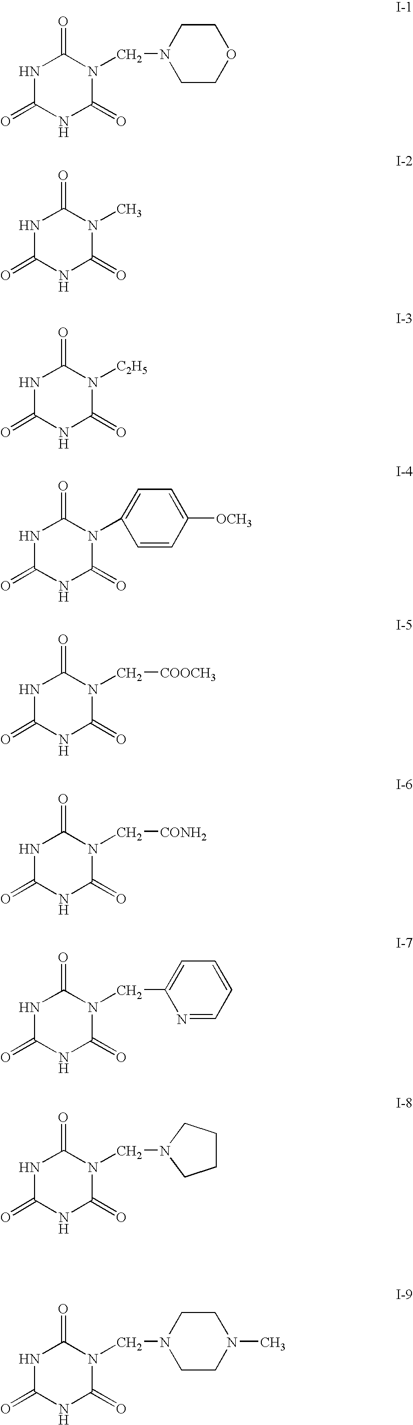

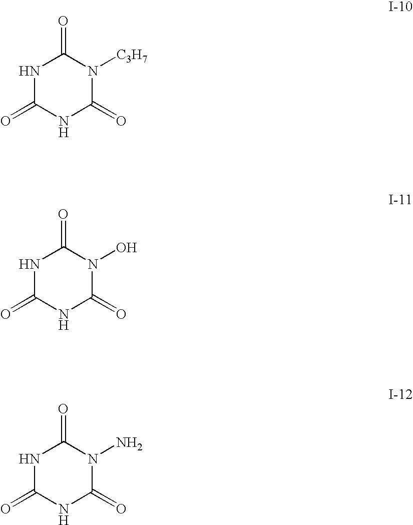

The following compounds are listed as the compound containing a residue of uracilic acid.

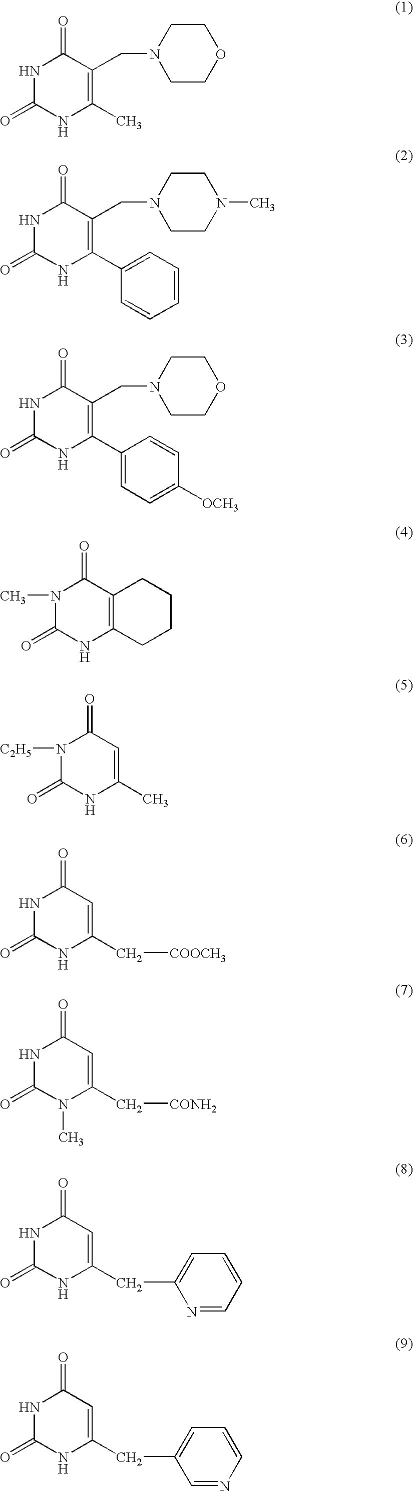

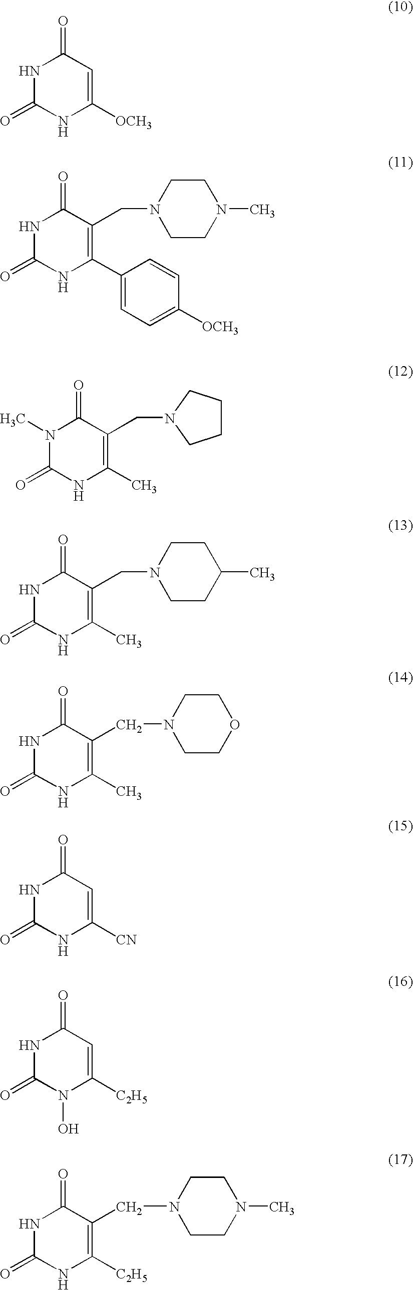

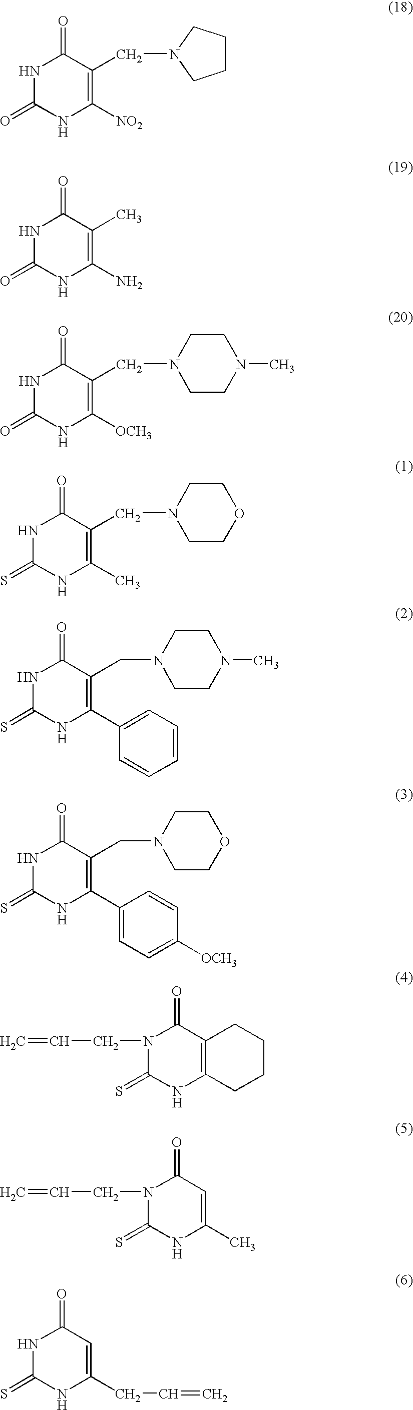

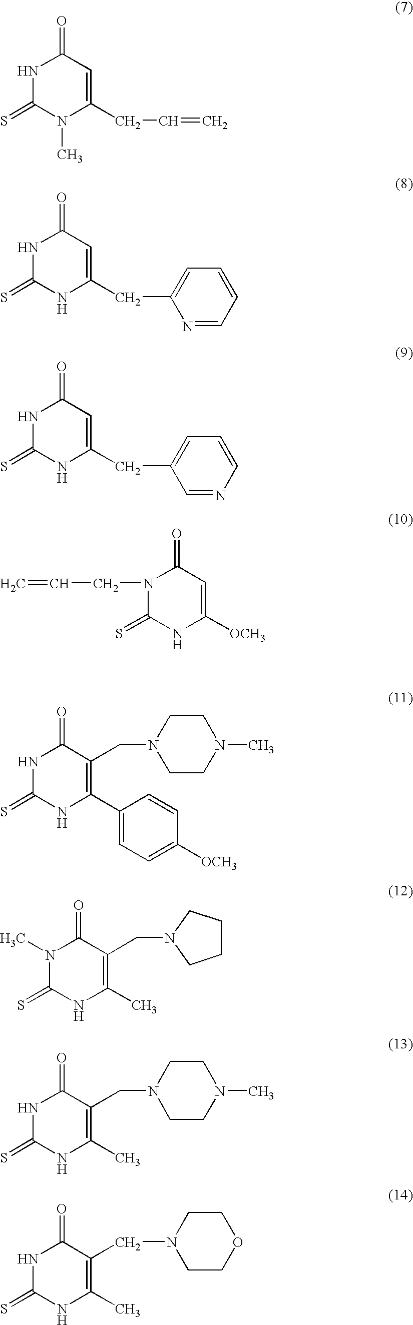

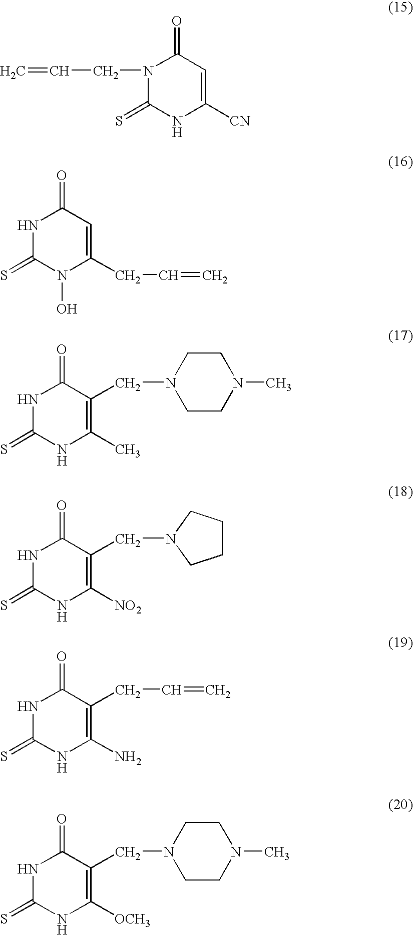

The compounds containing the residue of the above-described cyclic ureide compounds of the present invention may be used singly or in combination with at least two kinds.

In the present invention, the compounds containing the residue of the foregoing cyclic ureide compounds form hydrogen bonds with each other, and two hydrogen bonds per compound are possible to be preferably formed. It is also preferable that the compound containing the residue of the foregoing cyclic ureide compound is possible to form a supermolecule via hydrogen bonding.

Accordingly, it is specifically preferable in this case that the compounds containing the residue of the foregoing cyclic ureide compounds is an isocyanuric acid, a uracilic acid or derivatives thereof.

The compound containing a residue of a cyclic ureide compound of the present invention preferably has a content of 10-90% by weight, based on the weight of a light-sensitive layer constituting a printing plate material of the present invention in view of the effect produced in the present invention, but more preferably has a content of 30-80% by weight. In the case of a content of 10-90% by weight, sensitivity and development latitude obtained via the effect produced in the present invention, together with no degradation of scratch resistance are desirably improved.

In addition, when the light-sensitive layer is composed of at least two layers, at least one of the layers is required to contain the compound containing a residue of the foregoing cyclic ureide compound.

### (Aqueous Alkali Solution Soluble Resin)

In the present invention, an aqueous alkali solution soluble resin (referred to also as alkali soluble resin) is preferably employed as a light-sensitive layer forming element.

The aqueous alkali solution soluble resin means a resin which dissolves at 25° C. in an amount o at least 0.1 g/liter in an aqueous potassium hydroxide solution with a pH of 13.

As the aqueous alkali solution soluble resins preferably employed in the present invention, a phenolic hydroxyl group-containing resin, an acryl resin or an acetal resin is preferably used in view of ink receptivity or alkali solubility. The aqueous alkali solution soluble resins can be used singly or in combination with at least two kinds thereof.

In the case of preparing a light-sensitive layer composed of a two layer structure, an aqueous alkali solution soluble resin used in a lower layer is preferably an acryl resin or an acetal resin in view of aqueous alkali solution solubility, and an aqueous alkali solution soluble resin used in an upper layer is preferably a phenolic hydroxyl group-containing resin, and more preferably a novolak resin in view of ink receptivity.

### (Phenolic Hydroxyl Group-Containing Resin)

As the phenolic hydroxyl group-containing resin, there is mentioned a novolak resin which is prepared by condensation of various phenols with aldehydes.

Examples of the phenols include phenol, m-cresol, p-cresol, a mixed cresol (mixture of m- and p-cresols), a mixture of phenol and cresol (m-cresol, p-cresol or a mixture of m- and p-cresols), pyrogallol, acrylamide having a phenolic hydroxyl group, methacrylamide having a phenolic hydroxyl group, acrylate having a phenolic hydroxyl group, methacrylate having a phenolic hydroxyl group, and hydroxyl styrene.

Other examples of the phenols include substituted phenols such as iso-propylphenol, t-butylphenol, t-amylphenol, hexylphenol, cyclohexylphenol, 3-methyl-4-chloro-6-t-butylphenol, iso-propylcresol, t-butylcresol, and t-amylcresol. Preferred phenols are t-butylphenol and t-butylcresol. Examples of the aldehydes include aliphatic aldehydes such as formaldehyde, acetaldehyde, acrolein and crotonaldehyde; and aromatic aldehydes. Formaldehyde and acetaldehyde are preferred, and formaldehyde is especially preferred.

The preferred examples of the novolak resins include phenol-formaldehyde resin, m-cresol-formaldehyde resin, p-cresol-formaldehyde resin, m-/p-cresol (mixed cresol)-formaldehyde resin, and phenol-cresol (m-cresol, p-cresol, o-cresol, m-/p-cresol (mixed), m-/o-cresol (mixed) or o-/p-cresol (mixed))-formaldehyde resin. Especially preferred is m-/p-cresol (mixed cresol)-formaldehyde resin.

It is preferred that the novolak resin has a weight average molecular weight of at least 1,000, and a number average molecular weight of at least 200. It is more preferred that the novolak resin has a weight average molecular weight of 1,500-300,000, a number average molecular weight of 300-250,000, and a polydispersity (weight average molecular weight/number average molecular weight) of 1.1-10. It is still more preferred that the novolak resin has a weight average molecular weight of 2,000-10,000, a number average molecular weight of 500-10,000, and a polydispersity (weight average molecular weight/number average molecular weight) of 1.1-5. In the above molecular weight range, layer strength, alkali solubility, anti-chemical properties and interaction between the novolak resin and a light-to-heat conversion material of a layer containing the novolak resin can be suitably adjusted. The weight average molecular weight of novolak resin contained in the upper or lower layer can be also adjusted. Since the resistance to chemicals and layer strength is required to be high in the upper layer, the weight average molecular weight of novolak resin contained in the upper layer is preferably relatively high, and preferably 2,000-10,000.

In addition, the weight average molecular weight of the novolak resin is determined in terms of polystyrene employing monodisperse standard polystyrene according to GPC (gel permeation chromatography).

The novolak resin in the present invention can be synthesized according to a method disclosed in for example, “Shi Jikken Kagaku Koza [19] Polymer Chemistry [1]”, published by Maruzen Shuppan, p. 300 (1993). That is, phenol or substituted phenols (for example, xylenol or cresol) is dissolved in a solvent, mixed with an aqueous formaldehyde solution, and reacted in the presence of an acid, in which dehydration condensation reaction occurs at the o- or p-position of the phenol or substituted phenols to form a novolak resin. The resulting novolak resin is dissolved in an organic solvent, then mixed with a non-polar solvent and allowed to stand for several hours. The novolak resin mixture forms two phases separated, and the lower phase is concentrated, whereby a novolak resin with a narrow molecular weight distribution is obtained.

The organic solvent used is acetone, methyl alcohol or ethyl alcohol. The non-polar solvent used is hexane or petroleum ether. Further, the synthetic method is not limited to the above. As is disclosed in for example, Japanese Patent O.P.I. Publication No. 2001-506294, the novolak resin is dissolved in a water-soluble organic polar solvent, and then mixed with water to obtain precipitates, whereby a fraction of the novolak resin can be obtained. Further. As a method to obtain a novolak resin with a narrow molecular weight distribution, there is a method in which a novolak resin obtained by dehydration condensation is dissolved in an organic solvent and the resulting solution is subjected to silica gel chromatography for molecular weight fractionation.

Dehydration condensation of phenol with formaldehyde or dehydration condensation of substituted phenols with formaldehyde at o- or p-position of the substituted phenols is carried out as follows: Phenol or substituted phenols are dissolved in a solvent to obtain a solution having a phenol or substituted phenol concentration of 60-90% by weight, and preferably 70-80% by weight. Then, formaldehyde is added to the resulting solution so that the concentration ratio (by mole) of the formaldehyde to the phenol or substituted phenol is 0.2-2.0, preferably 0.4-1.4, and more preferably 0.6-1.2, and further acid catalyst is added at a reaction temperature of 10-150° C. so that the concentration ratio (by mole) of the acid catalyst to the phenol or substituted phenol is 0.01-0.1, and preferably 0.02-0.05. The resulting mixture is stirred for several hours while maintaining that temperature range. The reaction temperature is preferably 70-150° C., and more preferably 90-140° C.

The novolak resin can be used singly or as a mixture of two or more kinds thereof. A combination of two or more kinds of novolak resin makes it possible to effectively provide various properties such as layer strength, alkali solubility, anti-chemical properties and interaction between the novolak resin and a light-to-heat conversion material. When two or more kinds of novolak resin are used in the image formation layer, the weight average molecular weight or m/p ratio difference between them is preferably great. For example, the weight average molecular weight difference between the two or more kinds of novolak resins is preferably at least 1000, and more preferably at least 2000, and the m/p ratio difference between the two or more kinds of novolak resins is preferably at least 0.2, and more preferably at least 0.3.

The phenolic hydroxyl group-containing resin content of the upper layer in the positive-working planographic printing plate material of the invention is preferably 30-99% by weight, more preferably 45-95% by weight, and still more preferably 60-90% by weight, based on the total weight of the upper layer, in view of resistance to chemicals or printing durability.

### (Acryl Resin)

The acryl resin is preferably a copolymer containing the following constituent units. Examples of preferably usable other constituent units include constituent units introduced from commonly known monomers such as acrylic acid esters, (meth)acrylic acid esters, acrylamides, (meth)acrylamides, vinyl esters, styrenes, (meth)acrylic acid, acrylonitrile, maleic anhydride, maleic imide, and lactones.

Examples of the usable acrylic acid esters include methyl acrylate, ethyl acrylate, (n- or i-)propyl acrylate, (n-, i- or sec- or tert-)butyl acrylate, amyl acrylate, 2-ethylhexyl acrylate, dodecyl acrylate, 2-chloroethyl acrylate, 2-hydroxyethyl acrylate, 2-hydroxypropyl acrylate, 5-hydroxypentyl acrylate, cyclohexyl acrylate, allyl acrylate, trimethylpropane monoacrylate, pentaerythritol monoacrylate, glycidyl acrylate, benzyl acrylate, chlorobenzyl acrylate, 2-(p-hydroxypheny)ethyl acrylate, furfuryl acrylate, tetrahydrofurfuryl acrylate, phenyl acrylate, chlorophenyl acrylate, and sulfamoylphenyl acrylate.

Specific examples of the methacrylic acid esters include methyl methacrylate, ethyl methacrylate, (n- or i-)propyl methacrylate, (n-, i- or sec- or tert-)butyl. methacrylate, amyl methacrylate, 2-ethylhexyl methacrylate, dodecyl methacrylate, 2-chloroethyl methacrylate, 2-hydroxyethyl methacrylate, 2-hydroxypropyl methacrylate, 5-hydroxypentyl methacrylate, cyclohexyl methacrylate, allyl methacrylate, trimethylpropane monomethacrylate, pentaerythritol monomethacrylate, glycidyl methacrylate, benzyl methacrylate, chlorobenzyl methacrylate, 2-(p-hydroxypheny)ethyl methacrylate, furfuryl methacrylate, tetrahydrofurfuryl methacrylate, phenyl methacrylate, chlorophenyl methacrylate, and sulfamoylphenyl methacrylate.

Examples of the acrylamides include acrylamide, N-methyl acrylamide, N-ethyl acrylamide, N-propyl acrylamide, N-butyl acrylamide, N-benzyl acrylamide, N-hydroxyethyl acrylamide, N-phenyl acrylamide, N-tolyl acrylamide, N-(p-hydroxyphenyl)acrylamide, N-(sulfamoylphenyl)acrylamide, N-(phenylsulfonyl)acrylamide, N-(tolylsulfonyl)acrylamide, N,N-dimethyl acrylamide, N-methyl-N-phenyl acrylamide, N-hydroxyethyl-N-methyl acrylamide, and N-(p-toluenrsulfonyl)acrylamide.

Examples of methacrylamides include methacrylamide, N-methyl methacrylamide, N-ethyl methacrylamide, N-propyl methacrylamide, N-butyl methacrylamide, N-benzyl methacrylamide, N-hydroxyethyl methacrylamide, N-phenyl methacrylamide, N-tolyl methacrylamide, N-(p-hydroxyphenyl)methacrylamide, N-(sulfamoylphenyl)methacrylamide, N-(phenylsulfonyl)methacrylamide, N-(tolylsulfonyl)methacrylamide, N,N-dimethyl methacrylamide, N-methyl-N-phenyl methacrylamide, N-(p-toluenrsulfonyl)methacrylamide, and N-hydroxyethyl-N-methyl methacrylamide.

Examples of lactones include pantoyl lactone(meth)acrylate, α-(meth)acryloyl-γ-butyrolactone, and β-(meth)acryloyl-γ-butyrolactone.

Examples of maleic imides include meleimide, N-acryloyl acrylamide, N-acetyl methacrylamide, N-propyl methacrylamide, and N-(p-chlorobenzoyl)methacrylamide.

Examples of vinyl ester include vinyl acetate, vinyl butyrate, and vinyl benzoate.

Examples of styrenes include styrene, methylstyrene, dimethylstyrene, trimethylstyrene, ethylstyrene, propylstyrene, cyclohexylstyrene, chloromethylstyrene, trifluoromethylstyrene, ethoxystyrene, acetoxystyrene, methoxystyrene, dimethoxystyrene, chlorostyrene, dichlorostyrene, bromostyrene, iodostyrene, fluorostyrene, and carboxystyrene.

Examples of acrylonitriles include acrylonitrile and methacrylonitrile.

Among these monomers, acrylates or methacrylates having a carbon atom number of not more than 20, acrylamides, methacrylamides, acrylic acid, methacrylic acid, acrylonitriles, or maleic imides are preferably used.

The weight average molecular weight Mw of the acryl resin or the modified acryl resin in the present invention is preferably at least 2000, more preferably 5000-100000, and still more preferably 10000-50000. The above molecular weight range makes it possible to adjust layer strength, alkali solubility, or resistance to chemicals of the layer, whereby the advantageous effects of the invention are easily obtained.

In the present invention, the acryl resins may be in the form of random polymer, blocked polymer, or graft polymer, and is preferably a blocked polymer capable of separating a hydrophilic group from a hydrophobic group, in that it can adjust solubility to a developer.

The acryl resins in the present invention may be used singly or as a mixture of two or more kinds thereof.

### (Acetal Resin)

The polyvinyl acetal resins used in the present invention can be synthesized by acetalyzing polyvinyl alcohol with aldehydes and reacting the residual hydroxyl group with acid anhydrides.

Examples of the aldehydes include formaldehyde, acetaldehyde, propionaldehyde, butylaldehyde, pentylaldehyde, hexylaldehyde, glyoxalic acid, N,N-dimethylformamide, di-n-butylacetal, bromoacetaldehyde, chloroaldehyde, 3-hydroxy-n-butylaldehyde, 3-methoxy-n-butylaldehyde, 3-dimethylamino-2,2-dimethylpropionaldehyde, and cyanoacetaldehyde. In the present invention, the aldehyde are not limited thereto.

The acetal resin in the present invention is preferably a polyvinyl acetal resin represented by the following Formula (PVAC):

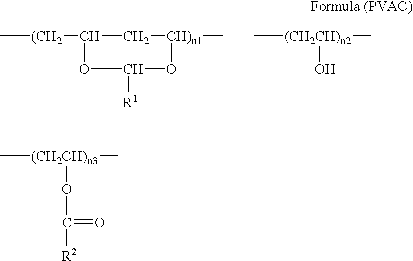

Constituent unit (i) Constituent unit (ii) Constituent Unit (iii)

In Formula (PVAC), n1 represents 5-85 mol %, n2 represents 0-60 mol %, and n3 represents 0-60 mol %.

Constituent unit (i) is a group induced by vinyl acetal, Constituent unit (ii) is a group induced by vinyl alcohol, and Constituent unit (iii) is a group induced by vinyl ester. In addition, n1-n3 each represent a constituent ratio (mol %) of each of constituent units.

In constituent unit (i), R¹ represents a substituted alkyl group, a hydrogen atom, a carboxyl group or a dimethylamino group.

Examples of the substituent include a carboxyl group, a hydroxyl group, a chlorine atom, a bromine atom, a urethane group, a ureido group, a tertiary amino group, an alkoxy group, a cyano group, a nitro group, an amide group, and an ester group. Examples of R¹ include a hydrogen atom, a methyl group, an ethyl group, a propyl group, a butyl group, a pentyl group, a carboxyl group, a halogen atom (—Br or Cl), a cyanomethyl group, 3-hydroxybutyl group, 3-methoxybutyl group and a phenyl group.

Further, n1 is 5-85% by mole, and preferably 25-70% by mole. In the case of n1 less than 5% by mole, layer strength becomes weaker, whereby printing durability is degraded, and in the case of n1 exceeding 85% by mole, solubility to a coating solvent is lowered. In constituent unit (ii), n2 is 0-60% by mole, and 10-45% by mole. This constituent unit (ii) has affinity for water. The above-described range of n2 is preferable in view of printing durability. In constituent unit (iii), R² represents an aliphatic hydrocarbon group, an alicyclic hydrocarbon group or an aromatic hydrocarbon group containing an unsabstituted alkyl group or carboxyl group, and these hydrocarbon groups each have 1-20 carbons. Of these, an alkyl group having 1-10 carbons is preferable, and a methyl group and an ethyl group are specifically preferable in view of developability. Further, n3 is preferably 0-20% by mole, and more preferably 0-10% by mole.

An acid content of the polyvinyl acetal resin in the present invention is preferably 0.5-5.0 meq/g (from 84 to 280 in terms of KOH mg), and more preferably 0.1-3.0 meq/g.

Further, the weight average molecular weight of the polyvinyl acetal resin is preferably about 5,000-400,000, and more preferably about 20,000-300,000, being measured according to gel permeation chromatography. The above molecular weight range makes it possible to adjust layer strength, alkali solubility, or solubility to chemicals, whereby the advantageous effects of the present invention are easily obtained.

These polyvinyl acetal resins may be used singly or as a mixture of two or more kinds thereof.

The acetalyzation of polyvinyl alcohol can be carried out according to conventional methods disclosed in for example, U.S. Pat. Nos. 4,665,124, 4,940,646, 5,169,898, 5,700,619, and 5,792,823, and Japanese Patent No. 09328519.

### (Melamine Group or Triazine Group-Containing Compound)

In the present invention, a light-sensitive layer preferably comprises a compound containing a melamine group or a triazine group. As shown in the following chemical structure 2, the compound containing a residue of a cyclic ureide compound of the present invention, and a melamine group or a triazine group form a hydrogen bond to further improve the effect of the present invention. In addition, the hydrogen bond forms a supermolecule between the above-described two compounds to further improve the effect of the present invention.

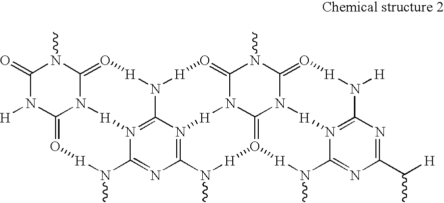

A compound represented by the following Formula (MM1) is preferable as a melamine group-containing compound.

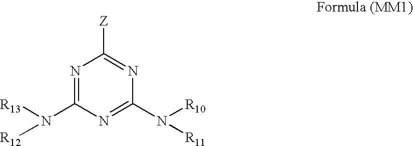

In Formula (MM1), Z represents —NRR′ or a phenyl group. R, R′, R₁₀, R₁₁, R₁₂ and R₁₃ each represents a hydrogen atom, —CH₂OH, —CH₂ORa or —CO—ORa where Ra represents an alkyl group.

Melamine represented by Formula (MM1) or benzoguanamine is commercially available, and a methylol product thereof is prepared via condensation of melamine or benzoguanamine with formalin. Ethers can be prepared by modifying a methylol product with each of various alcohols by a commonly known method. The alkyl group represented by Ra in Formula (MM1) is preferably one having 1-4 carbon atoms, which may be straight-chained or branched.

Specific examples of the compound represented by Formula (MM1) include the following compounds, but the present invention is not limited thereto.

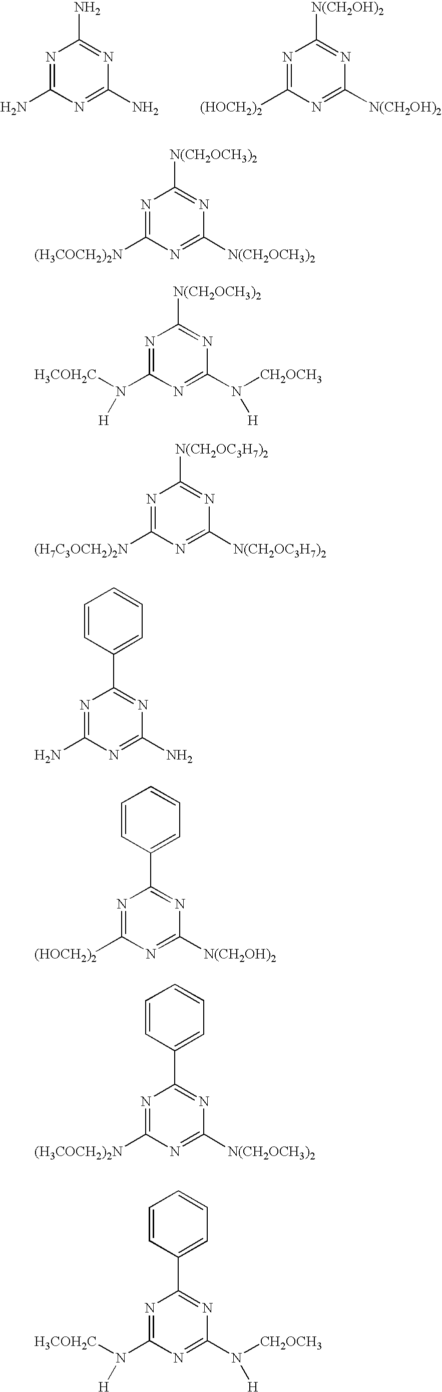

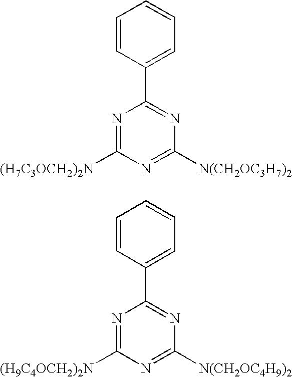

Usable examples of the melamine group-containing compound include a compound represented by the following Formula (MM2), a melamine resin which a plurality of triazine nuclei are bonded via a bond represented by the following Formula (MM3) and compounds represented by the following Formulae (MM4) and (MM5).

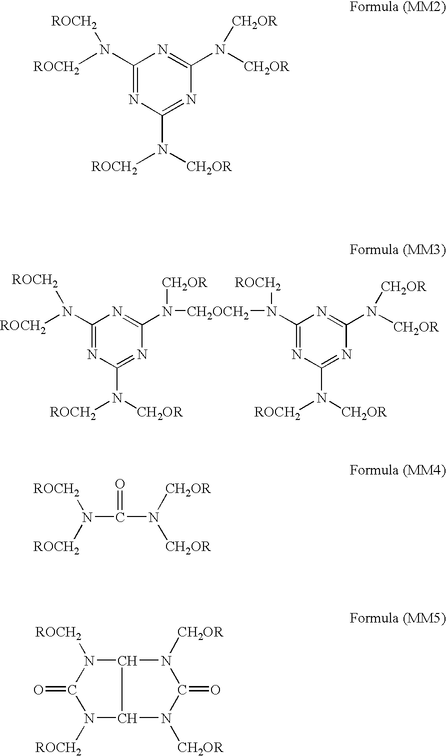

In Formulae (MM2)-(MM5), R represents a hydrogen atom or an alkyl group having 1-4 carbon atoms.

A compound represented by the following Formula (TA) is preferable as a triazine group-containing compound.

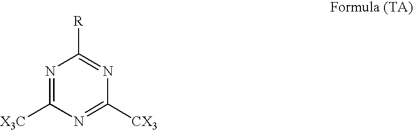

In Formula (TA), R represents a phenylvinylene group, an aryl group (for example, a phenyl group, a naphthyl group or such) or a substitution product thereof, which may be substituted by an alkyl group, a halogen-substituted alkyl group or an alkoxy group, and X₃ represents a halogen atom.

Next, the following compounds represented by Formula (TA) are listed.

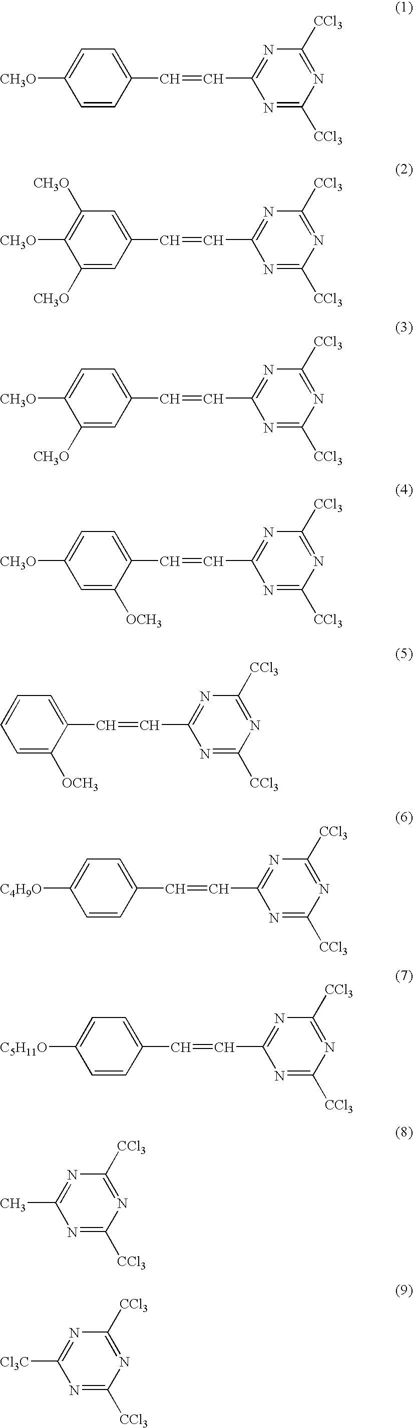

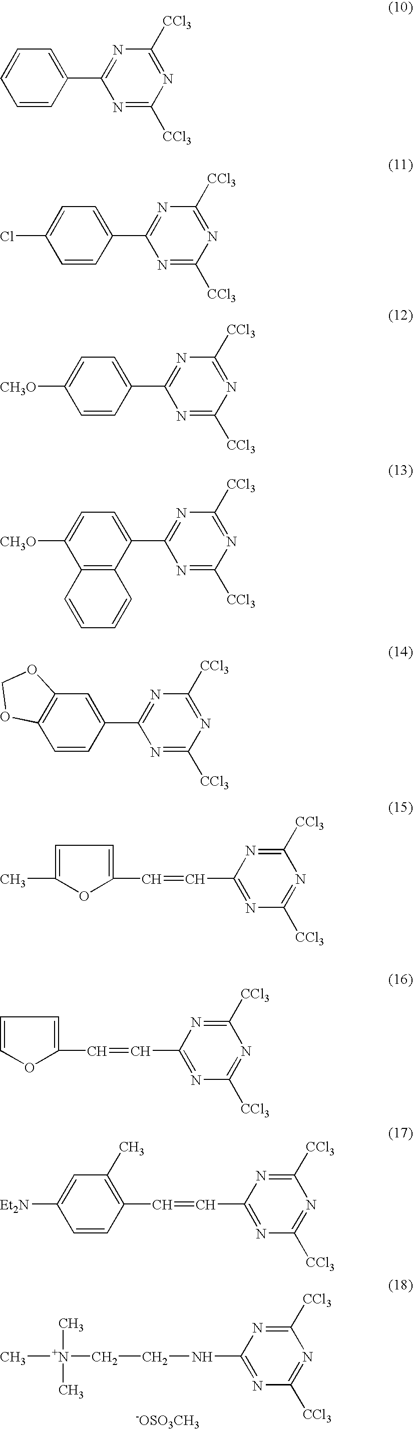

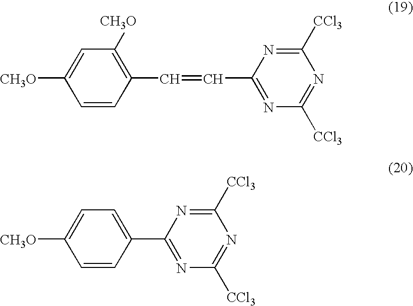

Also usable are compounds containing a triazine group described in Japanese Patent O.P.I. Publication Nos. 4-44737, 9-90633 and 4-226454.

A melamine group-containing compound or a triazine-containing compound is preferably added in a content ratio of 1/50-1/1, based on a resin constituting a light-sensitive layer in view of sensitivity and development latitude, more preferably added in a content ratio of 1/20-1/2, and still more preferably 1/10-1/3.

### (Fluoroalkyl Group-Containing Acryl Resin)

The fluoroalkyl group-containing acryl resin is a resin having a fluoroalkyl group, and containing an acrylic acid derivative as a constituent unit.

The fluoroalkyl group-containing acryl resin is preferably a resin obtained by polymerizing a compound represented by the following Formula (FACP) below, and more preferably a copolymer thereof.

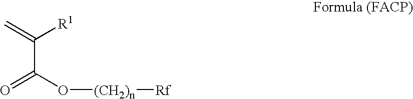

In Formula (FACP), Rf represents a substituent containing a fluoroalkyl group or a perfluoroalkyl group, which has at least 3 fluorine atoms; n is 1 or 2; and R¹ represents a hydrogen atom or an alkyl group having 1-4 carbon atoms. Rf is, for example, —CₘF₂ₘ⁺¹ or —(CF₂)ₘH, where m is an integer of 4-12.

Use of the fluoroalkyl group or perfluoroalkyl group represented by Rf, which has at least 3 fluorine atoms presumably lowers the heat transfer coefficient of a recording layer, and inhibits exposure unevenness resulting from an exposure device for multichannel use applied for high productivity, since the recording layer having fluorine atom concentration distribution in the thickness direction is formed.

The number of fluorine atoms per monomer unit, introduced as a method of controlling the foregoing concentration distribution, is preferably at least 3, more preferably at least 6, and still more preferably at least 9.

The above-described fluorine atom number range produces an excellent effect to orient a specific copolymer on the surface of the layer, whereby excellent ink receptivity is obtained.

Further, the content of fluorine atoms contained in the specific copolymer is preferably 5-30 mmol/g, and more preferably 8-25 mmol/g in view of the effect of improved surface orientation of the specific copolymer, and balancing between developability and ink receptivity.

A constituent component of the above-described acryl resin can be used as the other copolymer component.

Examples thereof include acrylate, methacrylate, acrylamide, methacrylamide, styrene and a vinyl monomer. Acrylate, methacrylate, acrylamide, or methacrylamide is particularly preferable.

The fluoroalkyl group-containing acryl resin preferably has an average molecular weight of 3,000-200,000, and more preferably has an average molecular weight of 6,000-100,000.

The addition amount of the fluoroalkyl group-containing acryl resin in the upper or lower layer is preferably 0.01-50% by weight, more preferably 0.1-30% by weight, and still more preferably 1-15% by weight, in view of image unevenness, sensitivity and development latitude.

Further, in the case of a light-sensitive layer having a two light-sensitive layer structure, the upper layer is preferably used in view of a development restraining property of the light-sensitive layer and solubility resistance caused by chemicals used for printing.

Examples of the specific structure of the fluoroalkyl group-containing acryl resin will be shown below. In addition, the numerical numbers in the following formulae represent mol % of each monomer componnent.

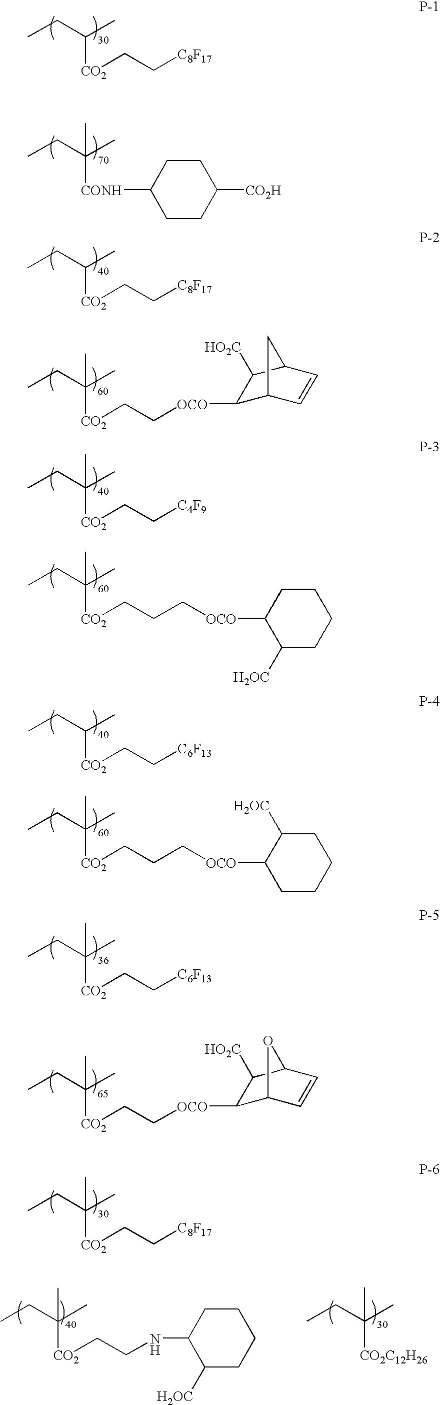

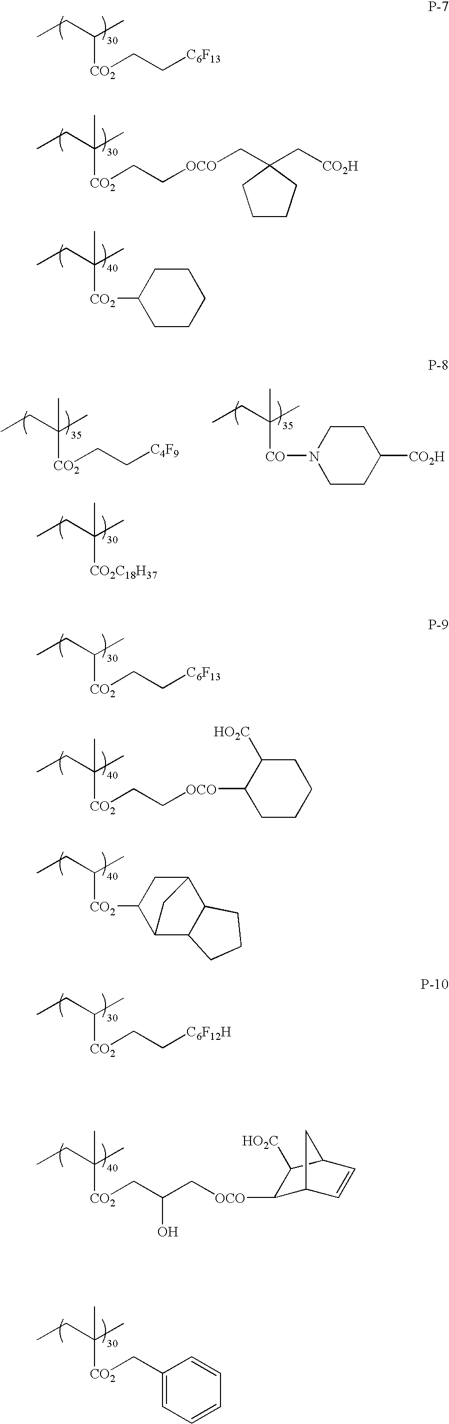

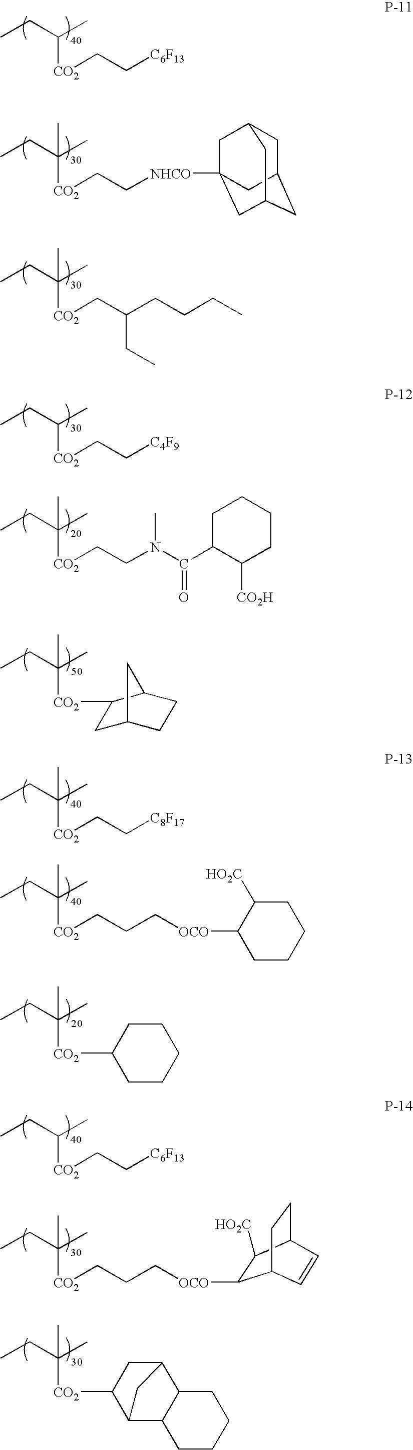

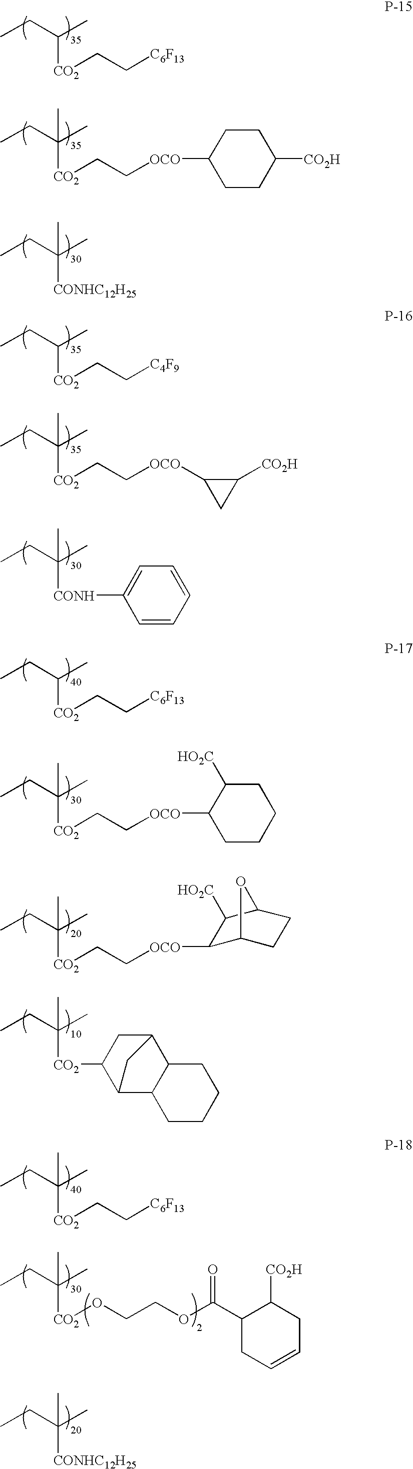

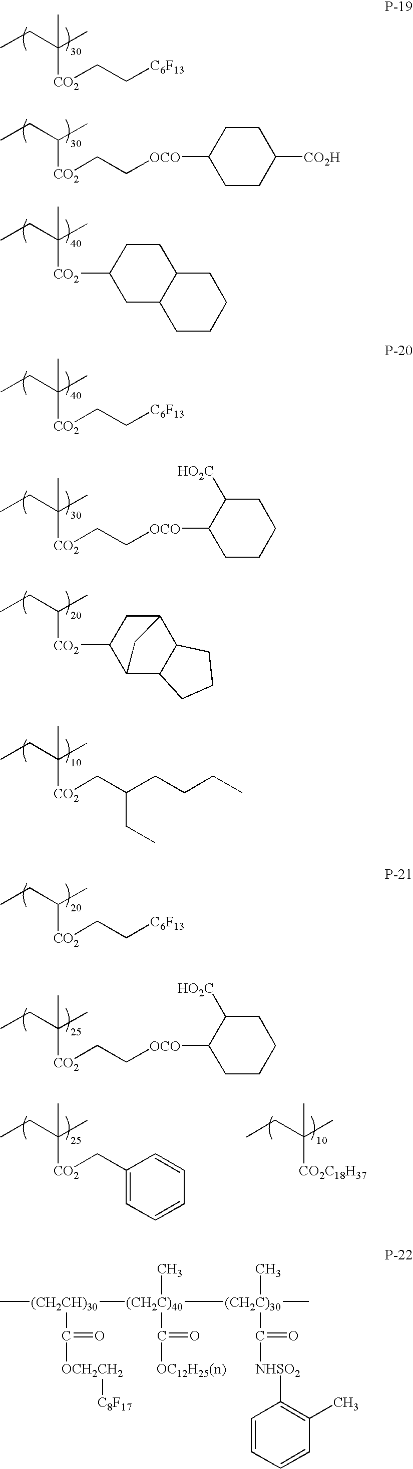

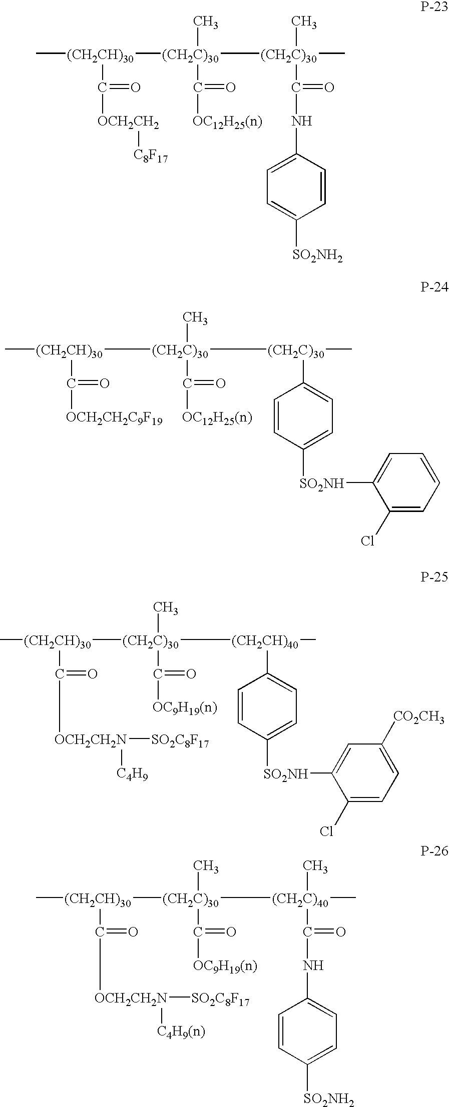

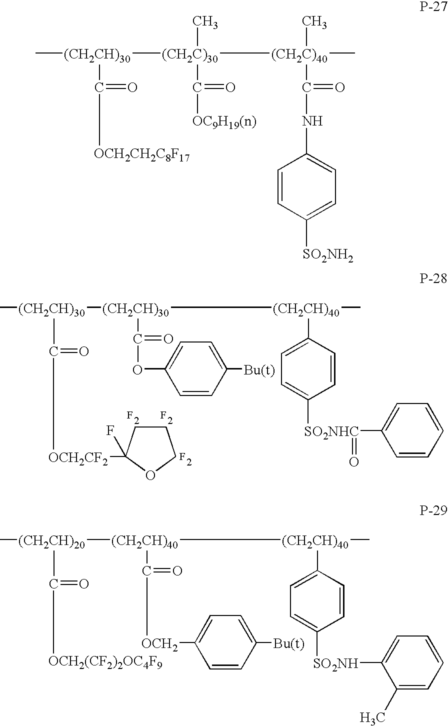

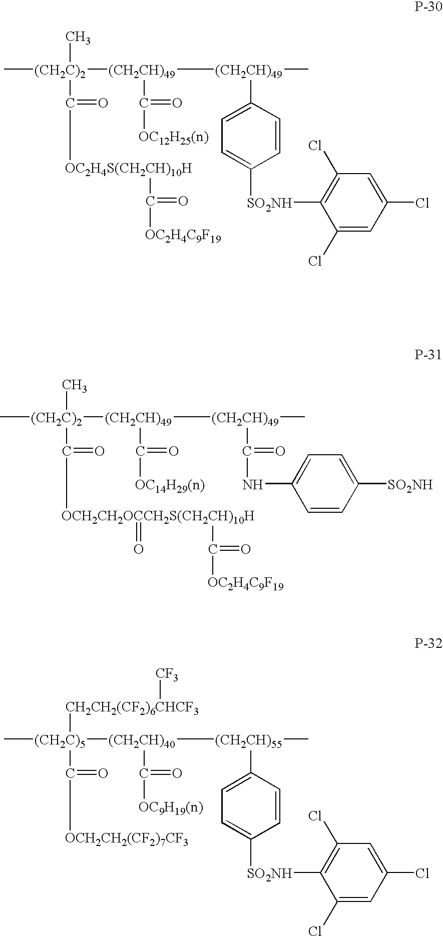

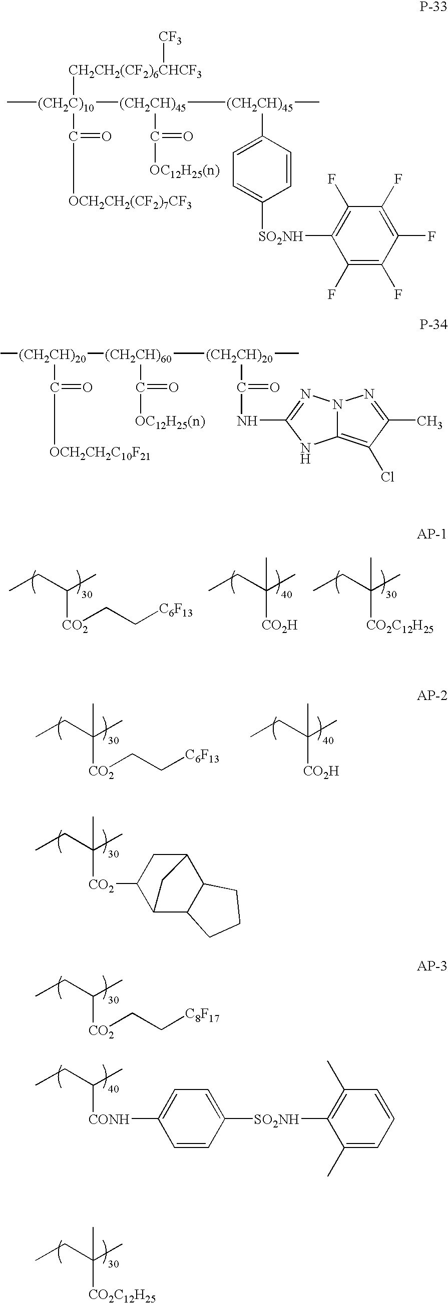

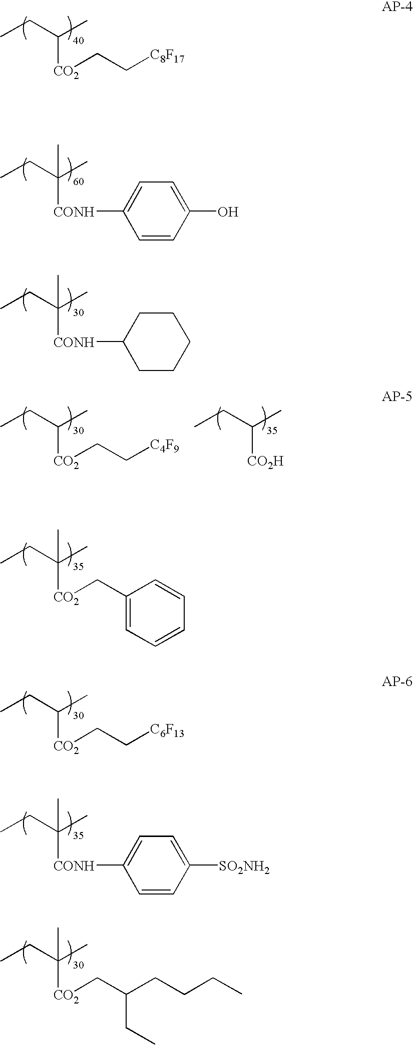

### (Infrared Absorbing Compound)

In the present invention, a light-sensitive layer preferably contains an infrared absorbing compound. The infrared absorbing compound has an infrared absorbing wavelength range of at least 700 nm, but preferably has an infrared absorbing wavelength range of 750-1200 nm, and exhibits light-to-heat conversion ability in this wavelength range. Specifically usable are various pigments or dyes which generate heat by absorbing light in this wavelength range.

The infrared absorbing compound is used in combination with two kinds, and in the case of a light-sensitive layer having a two light-sensitive layer structure, the infrared absorbing compound is usable as at least one of the upper layer and the lower layer. The infrared absorbing compound is preferably used as both the upper layer and the lower layer specifically in view of sensitivity and development latitude.

### (Pigment)

As pigment, commercially available pigments and pigments described in Color Index (C.I.) Binran, “Saishin Ganryo Binran” (ed. by Nihon Ganryo Gijutsu Kyokai, 1977), “Saishin Ganryo Oyo Gijutsu” (CMC Publishing Co., Ltd., 1986), and “Insatsu Inki Gijutsu” (CMC Publishing Co., Ltd., 1984) can be used.

Kinds of the pigment include black pigment, yellow pigment, orange pigment, brown pigment, red pigment, violet pigment, blue pigment, green pigment, fluorescent pigment, metal powder pigment, and metal-containing colorants. Typical examples of the pigment include insoluble azo pigment, azo lake pigment, condensed azo pigment, chelate azo pigment, phthalocyanine pigment, anthraquinone pigment, perylene or perynone pigment, thioindigo pigment, quinacridone pigment, dioxazine pigment, isoindolinone pigment, quinophthalone pigment, lake pigment, azine pigment, nitroso pigment, nitro pigment, natural pigment, fluorescent pigment, inorganic pigment, and carbon black.

The pigment preferably has a particle diameter of 0.01-10 μm, more preferably has a particle diameter of 0.05-1 μm, and still more preferably has a particle diameter of 0.1-1 μM.

As a dispersion method of pigments, a conventional dispersion method used in manufacture of printing ink or toners can be used. Dispersion devices include an ultrasonic disperser, a sand mill, an atliter, a pearl mill, a super mill, a ball mill, an impeller, a disperser, a KD mill, a colloid mill, a dynatron, a three-roll mill, and a pressure kneader. The details are described in “Saishin Ganryo Oyou Gijutsu” (CMC Publishing Co., Ltd., 1986).

The pigment can be added in an amount of 0.01-10% by weight, based on the total solid content constituting a light sensitive-layer, and preferably in an amount of 0.1-5% by weight, in view of uniformity and durability of a light sensitive-layer, and sensitivity.

### (Dye)

As the dyes, well-known dyes, i.e., commercially available dyes or dyes described in literatures (for example, “Senryo Binran”, edited by Yuki Gosei Kagaku Kyokai, published in 1970) can be used. Examples thereof include azo dyes, metal complex azo dyes, pyrazoline azo dyes, anthraquinone dyes, phthalocyanine dyes, carbonium dyes, quinonimine dyes, methine dyes, and cyanine dyes. Among these dyes or pigments, dyes absorbing an infrared light or a near-infrared light are preferred in that a laser emitting an infrared light or a near-infrared light can be employed. Examples of the dyes absorbing an infrared light or a near-infrared light include cyanine dyes disclosed in Japanese Patent O.P.I. Publication Nos. 58-125246, 59-84356, and 60-78787, methine dyes disclosed in Japanese Patent O.P.I. Publication Nos. 58-173696, 58-181690, and 58-194595, naphthoquinone dyes disclosed in Japanese Patent O.P.I. Publication Nos. 58-112793, 58-224793, 59-48187, 59-73996, 60-52940, and 60-63744, squarylium dyes disclosed in Japanese Patent O.P.I. Publication Nos. 58-112792, and cyanine dyes disclosed in British Patent No. 434,875. Further, near infrared absorbing sensitizing dyes described in U.S. Pat. No. 5,156,938 are suitably employed as the dyes. In addition, preferably employed are substituted arylbenzo(thio)pyrylium salts described in U.S. Pat. No. 3,881,924; trimethine-thiapyrylium salts described in Japanese Patent O.P.I. Publication No. 57-142645 (U.S. Pat. No. 4,327,169); pyrylium based compounds described in Japanese Patent O.P.I. Publication Nos. 58-181051, 58-220143, 59-41363, 59-84248, 59-84249, 59-146063, and 59-146061; cyanine dyes described in Japanese Patent O.P.I. Publication No. 59-216146; pentamethinethiopyrylium salts described in U.S. Pat. No. 4,283,475; pyrylium compounds described in Japanese Patent Publication No. 5-13514 and 5-19702, and Epolight III-178, Epolight III-130 or Epolight III-125.

Of these dyes, particularly preferred dyes are cyanine dyes, phthalocyanine dyes, oxonol dyes, squarylium dyes, pyrylium dyes, thiopyrylium dyes, and nickel thiolate complexes. A cyanine dye represented by Formula (CD) is most preferred in providing high interaction with the alkali soluble resin, excellent stability and excellent economical performance.

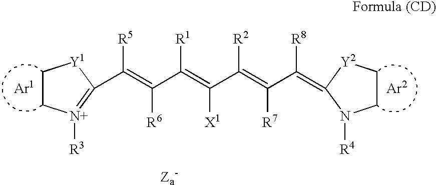

In Formula (CD), X¹ represents a hydrogen atom, a halogen atom, —NPh₂, —X²-L¹ or the following group.

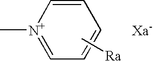

wherein Xa⁻ is defined similarly to the after-mentioned Za⁻; Ra represents a substituent selected from the group consisting of a hydrogen atom, an alkyl group, an aryl group, a substituted or unsubstituted amino group and a halogen atom.

In the foregoing —X²-L¹ of Formula (CD), X² represents an oxygen atom or a sulfur atom, and L¹ represents a hydrocarbon group having 1-12 carbon atoms, a hetero atom-containing aromatic ring group or a hetero atom-containing hydrocarbon group having 1-12 carbon atoms. In addition, the hetero atom herein represents N, S, O, a halogen atom or Se.

R¹ and R² independently represent a hydrocarbon group having 1-12 carbon atoms, provided that R¹ and R² may combine with each other to form a 5- or 6-membered ring.

Ar¹ and Ar² independently represent a substituted or unsubstituted aromatic hydrocarbon group, and may be identical or different.

Preferred examples of the aromatic hydrocarbon group include a benzene ring or a naphthalene ring, and preferred examples of the substituent include a hydrocarbon group having a carbon atom number of not more than 12, a halogen atom or an alkoxy group having a carbon atom number of not more than 12. Y¹ and Y² independently represent a sulfur atom or a diaklylmethylene group having a carbon atom number of not more than 12, and may be the same or different. R³ and R⁴ independently represent a substituted or unsubstituted hydrocarbon group having a carbon atom number of not more than 20, and may be the same or different. Examples of the substituent include an alkoxy group having a carbon atom number of not more than 12, a carboxyl group or a sulfo group. R⁵, R⁶, R⁷ and R⁸ independently represent a hydrogen atom or a hydrocarbon group having a carbon atom number of not more than 12, and may be the same or different. R⁵, R⁶, R⁷ and R⁸ represent preferably a hydrogen atom in view of availability. Za⁻ represents an anionic group, provided that when the cyanine dye represented by Formula (CD) has an anionic substituent in the structure with no charge neutralization, Za⁻ is not necessary. Preferred examples of Za⁻ include a halogen ion, a perchlorate ion, a tetrafluoroborate ion, a hexafluorophosphate ion, and a sulfonate ion. Especially preferred Za⁻ is a perchlorate ion, a hexafluorophosphate ion, or an arylsulfonate ion.

Specific examples of the cyanine dye represented by Formula (CD) above will be listed below.

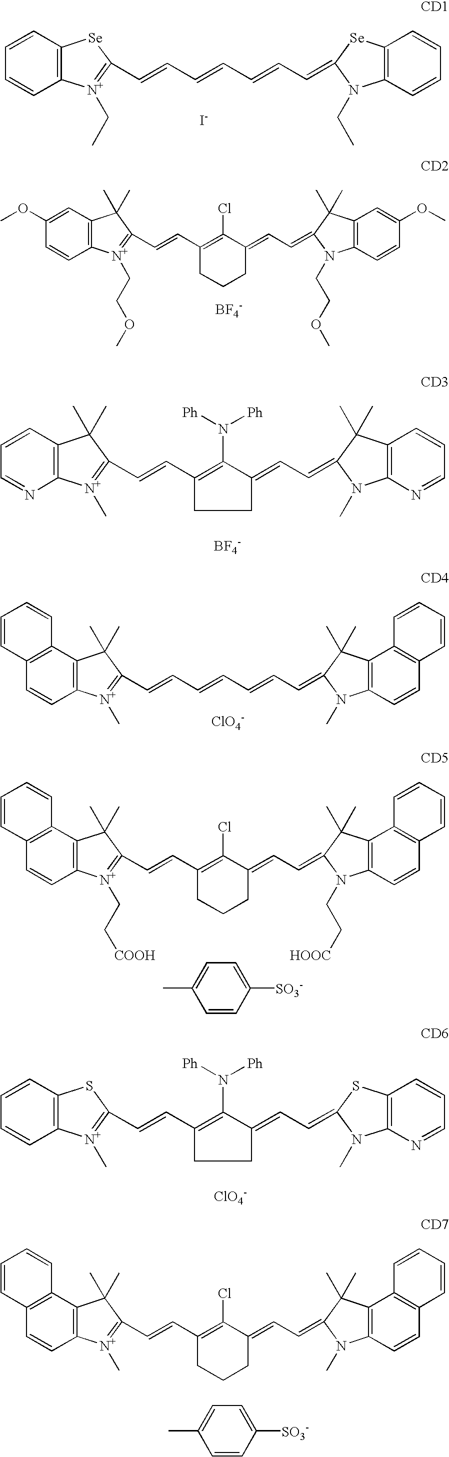

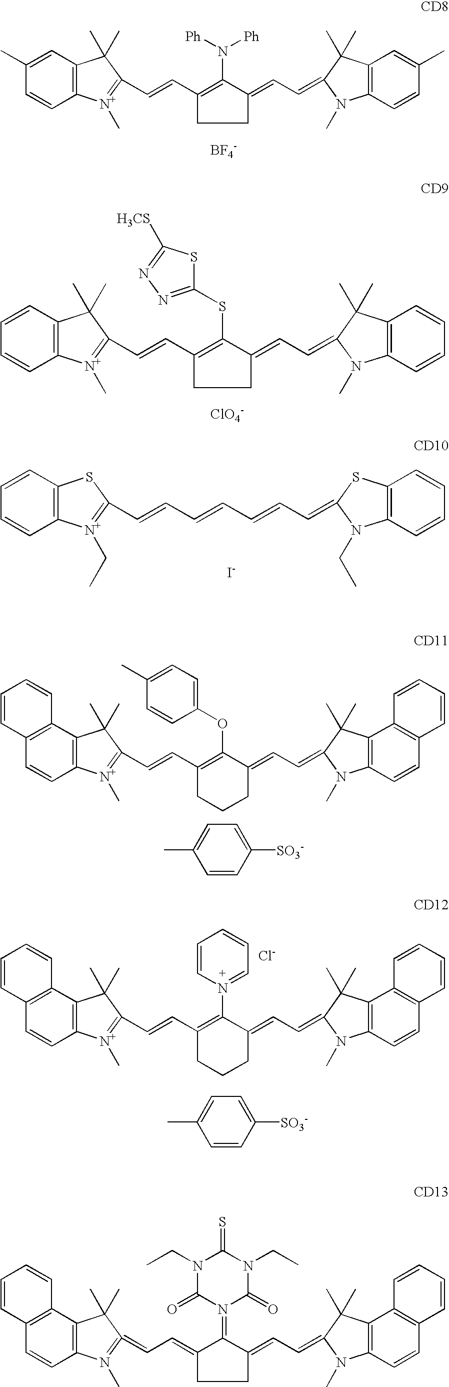

Specific examples of the cyanine dye represented by Formula (CD) above include ones disclosed in Japanese Patent O.P.I. Publication No. 2001-133969, paragraphs [0017]-[0019], Japanese Patent O.P.I. Publication No. 2002-40638, paragraphs [0012]-[0038], and Japanese Patent O.P.I. Publication No. 2002-23360, paragraphs [0012]-[0023], in addition to ones listed above.

The infrared absorbing dye content of a light-sensitive layer in which the dye is contained is preferably 0.01-30% by weight, more preferably 0.1-10% by weight, and still more preferably 0.1-5% by weight, in view of sensitivity, resistance to chemicals and printing durability.

### (Acid Decomposable Compound)

The light-sensitive layer in the present invention contains an acid decomposable compound represented by foregoing Formula (1).

In Formula (1), n represents an integer of 1 or more; m represents an integer of 0 or more; X represents a carbon atom or a silicon atom; and R₄ represents an ethyleneoxy group or a propyleneoxy group.

Each of R₂ and R₅ independently represents a hydrogen atom, an alkyl group or an aryl group, and each of R₃ and R₆ independently represents an alkyl group or an aryl group, but R₂ and R₃, or R₅ and R₆ may combine with each other to form a substituted or unsubstituted ring.

R₇ represents an alkylene group; R₁ represents a hydrogen atom, an alkyl group, an aryl group, an alkoxy group, an aryloxy group or a halogen atom; and R₈ represents a hydrogen atom, —XR₂R₃R₁ or —XR₅R₆R₁.

Of the acid decomposable compound represented by Formula (1), acetal is preferable. It is preferred in view of good yield that such the acetal is synthesized by polycondensation of dimethylacetal or diethylacetal derivatives of aldehydes or ketones with diol compounds such as ethylene glycol, diethylene glycol, triethylene glycol, tetraethylene glycol, pentaethylene glycol, polyethylene glycol, propylene glycol, dipropylene glycol, tripropylene glycol, tetrapropylene glycol, pentapropylene glycol, polypropylene glycol, and polyethylene glycol-polypropylene glycol copolymer.

Examples of the aldehydes for preparation of the acetals include acetoaldehyde, chloral, ethoxyacetoaldehyde, benzyloxyacetoaldehyde, phenylacetoaldehyde, diphenylacetoaldehyde, phenoxyacetoaldehyde, propionaldehyde,. 2-phenyl or 3-phenylaldehyde, isobutoxypivalic aldehyde, benzyloxypivalic aldehyde, 3-ethoxypropanal, 3-cyanopropanal, n-butanal, isobutanal, 3-chloro-butanal, 3-methoxy-butanal, 2,2-dimethyl-4-cyano-butanal, 2 or 3-ethylbutanal, n-pentanal, 2 or 3-methylpentanal, 2-bromo-3-methylpentanal, 2-hexanal, cyclopentanecarbaldehyde, n-heptanal, cyclohexanecarbaldehyde, 1,2,3,6-tetrahydrobenzaldehyde, 3-ethylpentanal, 3- or 4-methyl-hexanal, n-octanal, 2- or 4-ethylhexanal, 3,5,5-trimethylhexanal, 4-methylheptanal, 3-ethyl-n-heptanal, decanal, dodecanal, crotonaldehyde, benzaldehyde, 2-, 3- or 4-bromobenzaldehyde, 2,4-, or 3,4-dichlorobenzaldehyde, 4-methoxybenzaldehyde, 2,3- or 2,4-dimethoxybenzaldehyde, 2-, 3- or 4-fluorobenzaldehyde, 2-, 3- or 4-methylbenzaldehyde, 4-isopropylbenzaldehyde, 3- or 4-tetrafluoroethoxybenzaldehyde, 1-, or 2-naphthoaldehyde, furfural, thiophene-2-aldehyde, terephthalaldehyde, piperonal, 2-pyridinecarbaldehyde, p-hydroxy-benzaldehyde, 3,4-dihydroxy-benzaldehyde, 5-methyl-furaldehyde and vanillin. Ketones for preparation of the ketals include phenylacetone, 1,3-diphenylacetone, 2,2-diphenylacetone, chloro, or bromoacetone, benzylacetone, methyl ethyl ketone, benzyl propyl ketone, ethylbenzyl ketone, isobutyl ketone, 5-methyl-hexane-2-one, 2-methyl-pentane-2-one, 2-methyl-pentane-3-one, hexane-2-one, pentane-3-one, 2-methyl-butane-3-one, 2,2-dimethyl-butane-3-one, 5-methyl-heptane-3-one, octane-2-one, octane-3-one, nonane-2-one, nonane-3-one, nonane-5-one, heptane-2-one, heptane-3-one, heptane-4-one, undecane-2-one, undecane-4-one, undecane-5-one, undecane-6-one, dodecane-2-one, dodecane-3-one, triecane-2-one, tridecane-3-one, triecane-7-one, dinonyl ketone, dioctyl ketone, 2-methyl-octane-3-one, cyclopropyl methyl ketone, decane-2-one, decane-3-one, decane-4-one, methyl-α-naphthyl ketone, didecyl ketone, diheptyl ketone, dihexyl ketone, acetophenone, 4-methoxy-acetophenone, 4-chloro-acetophenone, 2,4-dimethyl-acetophenone, 2-, 3- or 4-fluoroacetophenone, 2-3- or 4-methylacetophenone, 2-, 3- or 4-methoxyacetophenone, propiophenone, 4-methoxy-propiophenone, butyrophenone, valerophenone, benzophenone, 3,4-dihydroxybenzophenone, 2,5-dimethoxybenzophenone, 3,4-dimethoxybenzophenone, 3,4-dimethylbenzophenone, cyclohexanone, 2-phenyl-cyclohexanone, 2-, 3- or 4-methyl-cyclohexanone, 4-t-butyl-cyclohexanone, 2,6-dimethyl-cyclohexanone, 2-chloro-cyclohexanone, cyclopentanone, cycloheptanone, cyclooctanone, cyclononanone, 2-cyclohexene-1-one, cyclohexylpropanone, flavanone, cyclohexane-1,4-dione, cyclohexane-1,3-dione, tropone, and isophorone.

Aldehydes or ketones having a solubility in 25° C. water of 1-100 g/liter are preferable in view of prevention of generating sludge via continuous processing and degrading image resolution power.

Examples thereof include benzaldehyde, 4-hydroxybenzaldehyde, 3,4-dihydroxybenzaldehyde, 2-pyridinecarbaldehyde, piperonal, phthalaldehyde, terephthalaldehyde, 5-methyl-2-phthalaldehyde, phenoxyacetoaldehyde, phenylacetoaldehyde, cyclohexanecarbaldehyde, vanillin, cyclohexanone, cyclohexene-1-one, isobutylaldehyde, and pentanal. Of these, cyclohexanone is more preferable in view of processing stability.

The silyl ether compound in the present invention is synthesized by polycondensation of a silyl compound with the above diol compound.

In the present invention, a silyl compound, which forms on decomposition of the silylether compound by an acid, has preferably a solubility in 25° C. water of 1-100 g/liter.

Examples of the silyl compound include dichlorodimethyl silane, dichlorodiethyl silane, methylphenyldichloro silane, diphenyldichloro silane, and methylbenzyldichloro silane.

The foregoing acetal compounds or silylether compounds can be synthesized also by copolycondensation using the above diol compounds and alcohol components other than the diol compounds. Examples of the alcohol components include substituted or unsubstituted monoalkyl alcohols such as methanol, ethanol, n-propanol, isopropanol, butanol, pentanol, hexanol, cyclohexanol, and benzyl alcohol; glycol ethers such as ethylene glycol monomethylether, ethylene glycol monoethylether, ethylene glycol monomphenylether, diethylene glycol monomethylether, diethylene glycol monoethylether, diethylene glycol monophenylether, and substituted or unsubstituted polyethylene glycol alkylethers or polyethylene glycol phenylethers. Examples of dihydric alcohols include pentane-1,5-diol, n-hexane-1,6-diol, 2-ethylhexane-1,6-diol, 2,3-dimethylhexane-1,6-diol, heptane-1,7-diol, cyclohexane-1,4-diol, nonane-1,7-diol, nonane-1,9-diol, 3,6-dimethyl-nonane-1,9-diol, decane-1,10-diol, dodecane-1,12-diol, 1,4-bis(hydroxymethyl)-cyclohexane, 2-ethyl-1,4-bis(hydroxymethyl)-cyclohexane, 2-methyl-cyclohexane-1,4-diethanol, 2-methyl-cyclohexane-1,4-dipropanol, thio-dipropylene glycol, 3-methyl-pentane-1,5-diol, dibutylene glycol, 4,8-bis(hydroxymethyl)-tricyclodecane, 2-butene-1,4-diol, p-xylylene glycol, 2,5-dimethyl-hexane-3-yne-2,5-diol, bis(2-hydroxyethyl)-sulfide, and 2,2,4,4-tetramethylcyclobutane-1,3-diol. In this embodiment, the content ratio (by mole) of the diol compound containing an ethylene glycol component or a propylene glycol component to the alcohol component in the acetal compounds or silyl ether compounds is preferably 70:30-100:0, and more preferably 85:15-100:0.

The acid decomposable compound in the present invention has a weight average molecular weight of preferably 500 to 10000, and more preferably 1000 to 3000 in terms of standard polystyrene measured according to gel permeation chromatography (GPC).

As other acid decomposable compound, a compound having a Si—N bond disclosed in Japanese Patent O.P.I. Publication No. 62-222246, a carbonic acid ester disclosed in Japanese Patent O.P.I. Publication No. 62-251743, an orthotitanic acid ester disclosed in Japanese Patent O.P.I. Publication No. 62-280841, an orthosilicic acid ester disclosed in Japanese Patent O.P.I. Publication No. 62-280842, a compound having a C—S bond disclosed in Japanese Patent O.P.I. Publication No. 62-244038, or a compound having a —O—C(═O)— bond disclosed in Japanese Patent O.P.I. Publication No. 63-231442 can be used in combination.

Synthesis examples of the acid decomposable compound used in the present invention will be described below.

### (Synthesis of Acid Decomposable Compound A1)

A mixture of 1.0 mol of 1,1-dimethoxycyclohexane, 1.0 mol of ethylene glycol, 0.003 mol of p-toluene sulfonic acid hydrate and 500 ml of toluene was reacted at 100° C. for 1 hour with stirring, gradually elevated to 150° C. and reacted at 150° C. for additional 4 hours while methanol produced during reaction was removed. The reaction mixture solution was cooled, washed with water, an aqueous 1% sodium hydroxide solution, and an aqueous 1 N sodium hydroxide solution in that order. The resulting mixture was further washed with an aqueous saturated sodium chloride solution, and dried over anhydrous potassium carbonate. The solvent (toluene) of the resulting solution was removed by evaporation under reduced pressure to obtain a residue. The residue was further dried 80° C. for 10 hours under vacuum to obtain a wax compound. Thus, an acid decomposable compound A-1 in a waxy form was obtained. The weight average molecular weight Mw of compound A1 was 1200 in terms of standard polystyrene measured according to GPC.

### (Synthesis of Acid Decomposable Compound A2)

An acid decomposable compound A-2 in a waxy form was prepared in the same manner as in acid decomposable compound A1, except that diethylene glycol was used in place of ethylene glycol. The weight average molecular weight Mw of compound A2 was 2000.

### (Synthesis of Acid Decomposable Compound A3)

An acid decomposable compound A3 in a waxy form was prepared in the same manner as in acid decomposable compound A1, except that triethylene glycol was used in place of ethylene glycol. The weight average molecular weight Mw of compound A3 was 1500.

### (Synthesis of Acid Decomposable Compound A4)

An acid decomposable compound A4 in a waxy form was prepared in the same manner as in acid decomposable compound A1, except that tetraethylene glycol was used in place of ethylene glycol. The weight average molecular weight Mw of compound A4 was 1500.

### (Synthesis of Acid Decomposable Compound A5)

An acid decomposable compound A5 in a waxy form was prepared in the same manner as in acid decomposable compound A1, except that dipropylene glycol was used in place of ethylene glycol. The weight average molecular weight Mw of compound A5 was 2000.

### (Synthesis of Acid Decomposable Compound A6)

An acid decomposable compound A6 in a waxy form was prepared in the same manner as in acid decomposable compound A2, except that benzaldehyde dimethylacetal was used in place of 1,1-dimethoxycyclohexane. The weight average molecular weight Mw of compound A6 was 2000.

### (Synthesis of Acid Decomposable Compound A7)

An acid decomposable compound A7 in a waxy form was prepared in the same manner as in acid decomposable compound A2, except that furaldehyde dimethylacetal was used in place of 1,1-dimethoxycyclohexane. The weight average molecular weight Mw of compound A7 was 2000.

In the present invention, the acid decomposable compound preferably has a content of 0.5-50% by weight, based on the total solid content of the light-sensitive layer composition, and more preferably has a content of 1-30% by weight, in view of sensitivity, development latitude, and safelight property.

The acid decomposable compound may be used singly or as an admixture of two or more kinds thereof. In the case of a light-sensitive layer having a two light-sensitive layer structure, the acid decomposable compound is preferably used for the lower layer in view of sensitivity and development latitude.

### (Acid Generating Agent)

The light-sensitive layer in the present invention preferably contains an acid generating agent. The acid generating agent is a compound generating an acid on light exposure or heat application. As the acid generating agents, there are various conventional compounds and mixtures. For example, a salt of diazonium, phosphonium, sulfonium or iodonium ion with BF₄⁻, PF₆⁻, SbF₆⁻ SiF₆²⁻ or ClO₄⁻, an organic halogen containing compound, o-quinone-diazide sulfonylchloride or a mixture of an organic metal and an organic halogen-containing compound is also an actinic ray sensitive component to form or separate acids during exposure to actinic ray, and can be used as the acid generating agent in the present invention.

An organic halogen-containing compound capable of generating a free radical, which is well known as a photoinitiator, is a compound capable of generating a hydrogen chloride, and can be also used as the acid generating agent. Further, there are compounds represented by iminosulfonates disclosed in Japanese Patent Application No. 3-140109, which are photolytically decomposed to generate an acid, disulfone compounds disclosed in Japanese Patent O.P.I. Publication No. 61-166544, o-naphthoquinonediazide-4-sulfonic acid halides disclosed in Japanese Patent O.P.I. Publication No. 50-36209 (U.S. Pat. No. 3,969,118), and o-naphthoquinonediazides disclosed in Japanese Patent O.P.I. Publication No. 55-62444 (British patent No. 2038801) and Japanese Patent Publication No. 1-11935. Other examples of acid generating agent include sulfonic acid alkyl esters such as cyclohexyl citrate, p-acetoaminobenzene sulfonic acid cyclohexyl ester and p-bromobenzene sulfonic acid cyclohexyl ester, and alkyl sulfonic acid ester disclosed in Japanese Patent O.P.I. Publication No. 9-26878 by the inventor.

Examples of the organic halogen-containing compound capable of forming a hydrogen halide include those disclosed in U.S. Pat. Nos. 3,515,552, 3,536,489 and 3,779,778 and West German Patent No. 2,243,621, and compounds generating an acid by photodegradation disclosed in West German Patent No. 2,610,842. As the photolytically acid generating agent, o-naphthoquinone diazide-4-sulfonylhalogenides disclosed in Japanese Patent O.P.I. Publication No. 50-36209 can also be used.

The acid generating agent is preferably an organic halogen-containing compound in view of sensitivity to infrared rays and storage stability of an image forming material using it. The organic halogen-containing compound is preferably a halogenated alkyl-containing triazines or a halogenated alkyl-containing oxadiazoles. Of these, halogenated alkyl-containing s-triazines are especially preferable. Examples of the halogenated alkyl-containing oxadiazoles include 2-halomethyl-1,3,4-oxadiazole compounds disclosed in Japanese Patent O.P.I. Publication Nos. 54-74728, 55-24113, 55-77742, 60-3626 and 60-138539.

Among compounds generating an acid on radiation exposure or heat application, those especially effectively used will be listed below.

As those effectively used, there are mentioned oxazole derivatives represented by Formula (PAG1) or s-triazine derivatives represented by Formula (PAG2) each having a trihalomethyl group, Iodonium salts represented by Formula (PAG3), sulfonium salts represented by Formula (PAG4), diazonium salts, disulfone derivatives represented by Formula (PAG5) or iminosulfonate derivatives represented by Formula (PAG6).

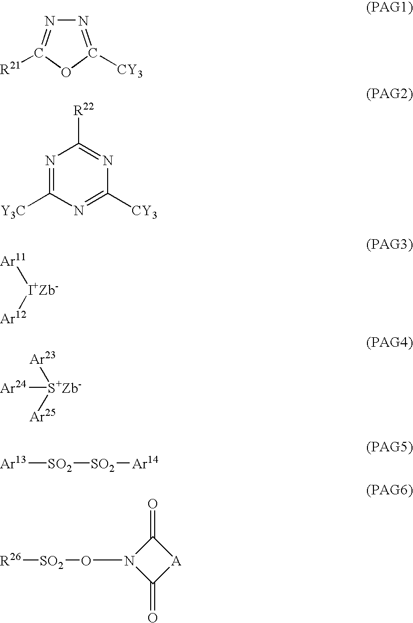

In Formulae (PAG1) and (PAG2) above, R²¹ represents a substituted or unsubstituted aryl group or a substituted or unsubstituted alkenyl group; R²² represents a substituted or unsubstituted aryl group, a substituted or unsubstituted alkenyl group, a substituted or unsubstituted alkyl group, or —C(Y₁)₃ in which Y₁ represents a chlorine atom or a bromine atom; and Y represents a chlorine atom or a bromine atom. In Formulae (PAG3) and (PAG4) above, Ar¹¹ and Ar¹² independently a substituted or unsubstituted aryl group; Ar²³, Ar²⁴ and Ar²⁵ independently a substituted or unsubstituted alkyl group or a substituted or unsubstituted aryl group, provided that Ar¹¹ and Ar¹², or two of Ar²³, Ar²⁴ and Ar²⁵ may combine with each other through a chemical bond or a divalent linkage group; and Zb⁻ represents an anion. In Formulae (PAG5) and (PAG6) above, Ar¹³ and Ar¹⁴ independently a substituted or unsubstituted aryl group; R²⁶ represents a substituted or unsubstituted alkyl group or a substituted or unsubstituted aryl group; and A represents a substituted or unsubstituted alkylene, alkenylene or arylene group.

Examples thereof will be listed below, but the present invention is not limited thereto.

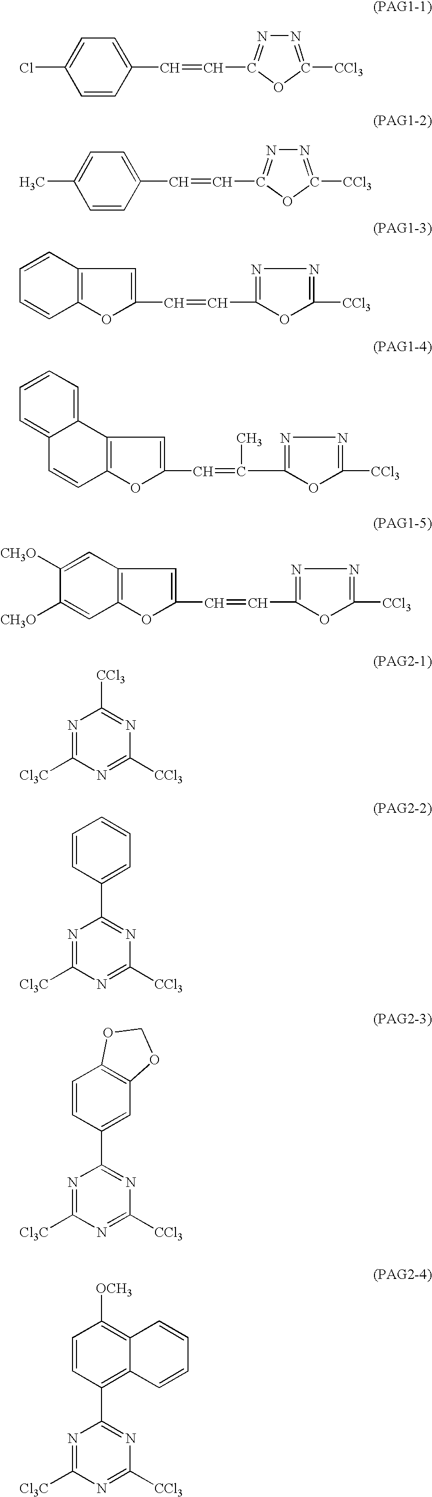

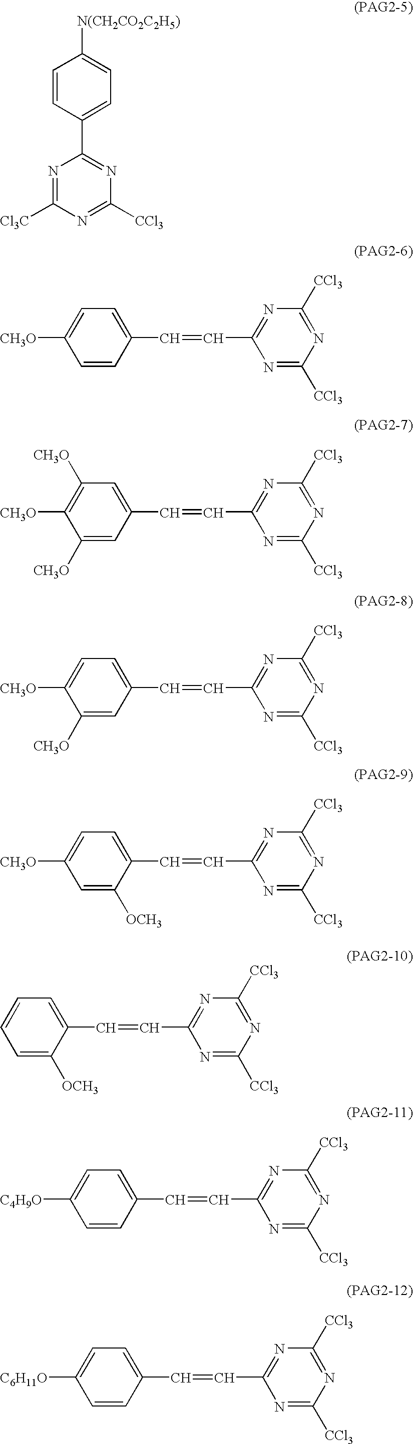

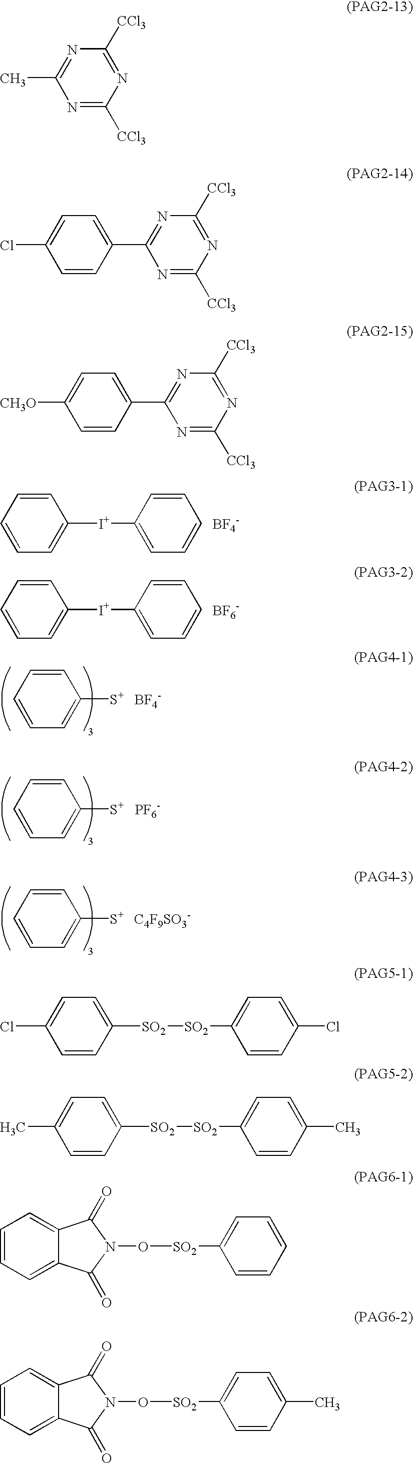

In the present invention, acid generating agents described below can be employed. For example, polymerization initiators disclosed in Japanese Patent O.P.I. Publication No. 2005-70211, radical generating compounds disclosed in Japanese Patent Publication No. 2002-537419, polymerization initiators disclosed in Japanese Patent O.P.I. Publication Nos. 2001-175006, 2002-278057, and 2003-5363, onium salts having two or more cation portions in the molecule disclosed in Japanese Patent O.P.I. Publication No. 2003-76010, N-nitroso amine compounds disclosed in Japanese Patent O.P.I. Publication No. 2001-133966, thermally radical generating compounds disclosed in Japanese Patent O.P.I. Publication No. 2001-343742, compounds of generating a radical or an acid by heat disclosed in Japanese Patent O.P.I. Publication No. 2002-6482, borate compounds disclosed in Japanese Patent O.P.I. Publication No. 2002-116539, compounds of generating a radical or an acid by heat disclosed in Japanese Patent O.P.I. Publication No. 2002-148790, photopolymerization initiators or thermal polymerization initiators each having a polymerizable unsaturated group disclosed in Japanese Patent O.P.I. Publication No. 2002-207293, onium salts having, as a counter ion, a divalent or more valent anion disclosed in Japanese Patent O.P.I. Publication No. 2002-268217, sulfonylsulfone compounds having a specific structure disclosed in Japanese Patent O.P.I. Publication No. 2002-328465, and thermally radical generating compounds disclosed in Japanese Patent O.P.I. Publication No. 2002-341519 can be used if desired.

As the acid generating agents, polyhalogen compounds are preferably usable. Compounds represented by the following Formula (2) are preferable.

R¹—C(X)₂—(C═O)—R² Formula (2)

wherein R¹ represents a hydrogen atom, a bromine atom, a chlorine atom, an alkyl group, an aryl group, an acyl group, an alkylsulfonyl group, an arylsulfonyl group, an iminosulfonyl group or a cyano group; R² represents a hydrogen atom or a monovalent organic substituent, but R¹ and R² may combine with each other to form a ring; and X represents a bromine atom or a chlorine atom.

Among compounds represented by Formula (2), those wherein R¹ is a hydrogen atom, a bromine atom, a chlorine atom are preferred in view of sensitivity. The monovalent organic substituent of R² is not limited, as long as the compounds represented by formula (2) generate a radical on light exposure. Those compounds in which in formula (2), R² represents —O—R³ or —NR⁴—R³ (R³ represents a hydrogen atom or a monovalent organic substituent, and R⁴ represents a hydrogen atom or an alkyl group) are preferably employed. Among these, those compounds in which R¹ is a bromine atom or a chlorine atom are more preferably employed in view of sensitivity.

Of these compounds, a compound having at least one haloacetyl group selected from a tribromoacetyl group, a dibromoacetyl group, a trichloroacetyl group, and a dichloroacetyl group is preferred.

In view of synthesis, a compound having at least one haloacetoxy group selected from a tribromoacetoxy group, a dibromoacetoxy group, a trichloroacetoxy group, and a dichloroacetoxy group, which is obtained by reacting a monohydric or polyhydric alcohol with a corresponding acid chloride, or a compound having at least one haloacetylamino group selected from a tribromoacetylamino group, a dibromoacetylamino group, a trichloroacetylamino group, and a dichloroacetylamino group, which is obtained by reacting a primary monoamine or primary polyamine with a corresponding acid chloride is especially preferred. Compounds having two or more of each of the haloacetyl group, haloacetoxy group, and haloacetylamino group are preferably used. These compounds can be easily synthesized by conventional esterification or amidation.

Typical synthesis method of the photopolymerization initiator represented by Formula (2) is one in which alcohols, phenols or amines are esterified or amidated with acid chlorides such as tribromoacetic acid chloride, diibromoacetic acid chloride, trichlorooacetic acid chloride, or dichloroacetic acid chloride.

The alcohols, phenols or amines used above are arbitrary, and examples thereof include monohydric alcohols such as ethanol, 2-butanol, and 1-adamantanol; polyhydric alcohols such as diethylene glycol, trimethylol propane, and dipentaerythritol; phenols such as phenol, pyrogallol, and naphthol; monoamines such as morpholine, aniline, and 1-aminodecane; and polyamines such as 2,2-dimethylpropylene-diamine, and 1,12-dodecanediamine.

Preferred examples of the polyhalogen compound will be listed below.

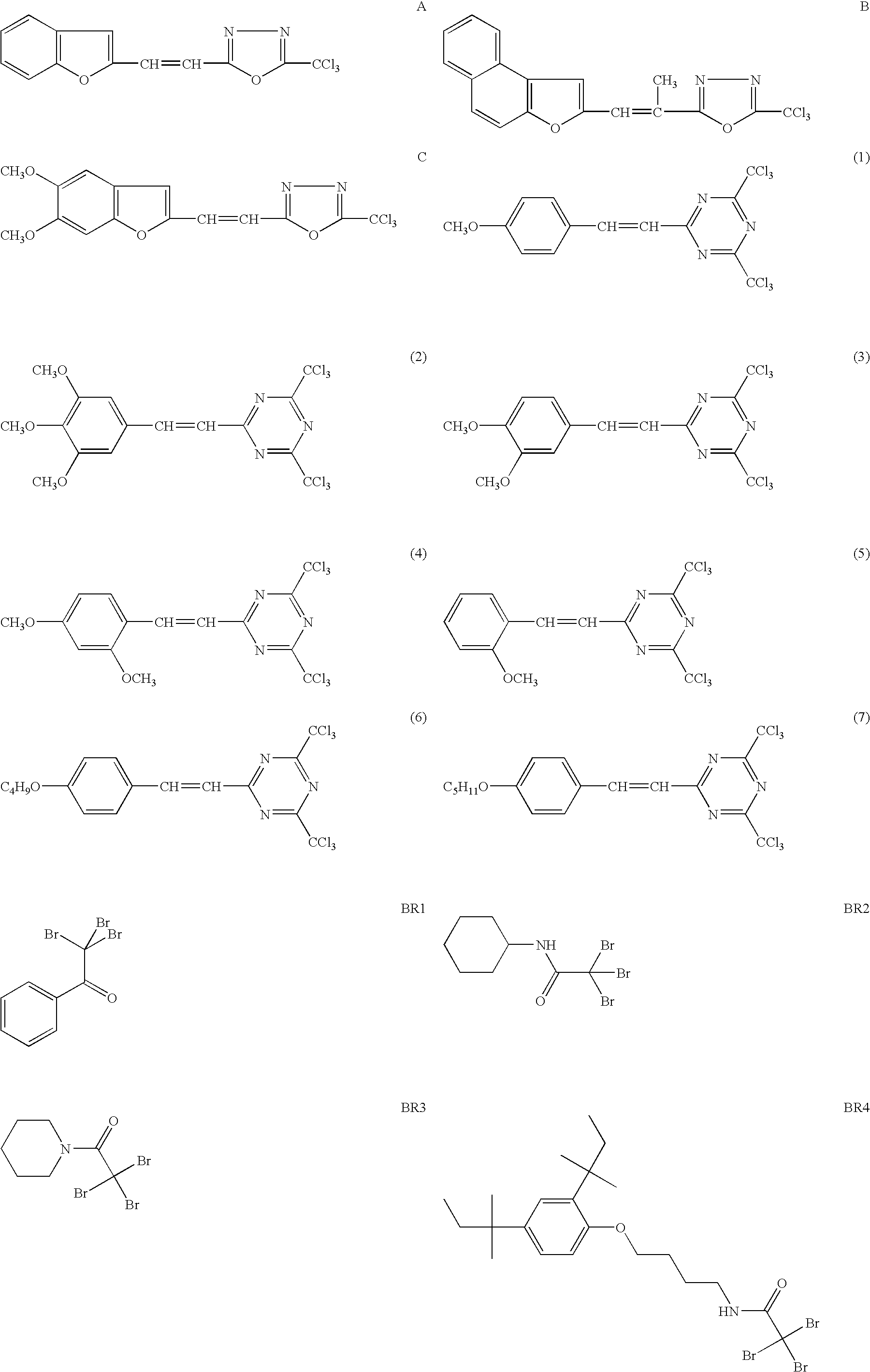

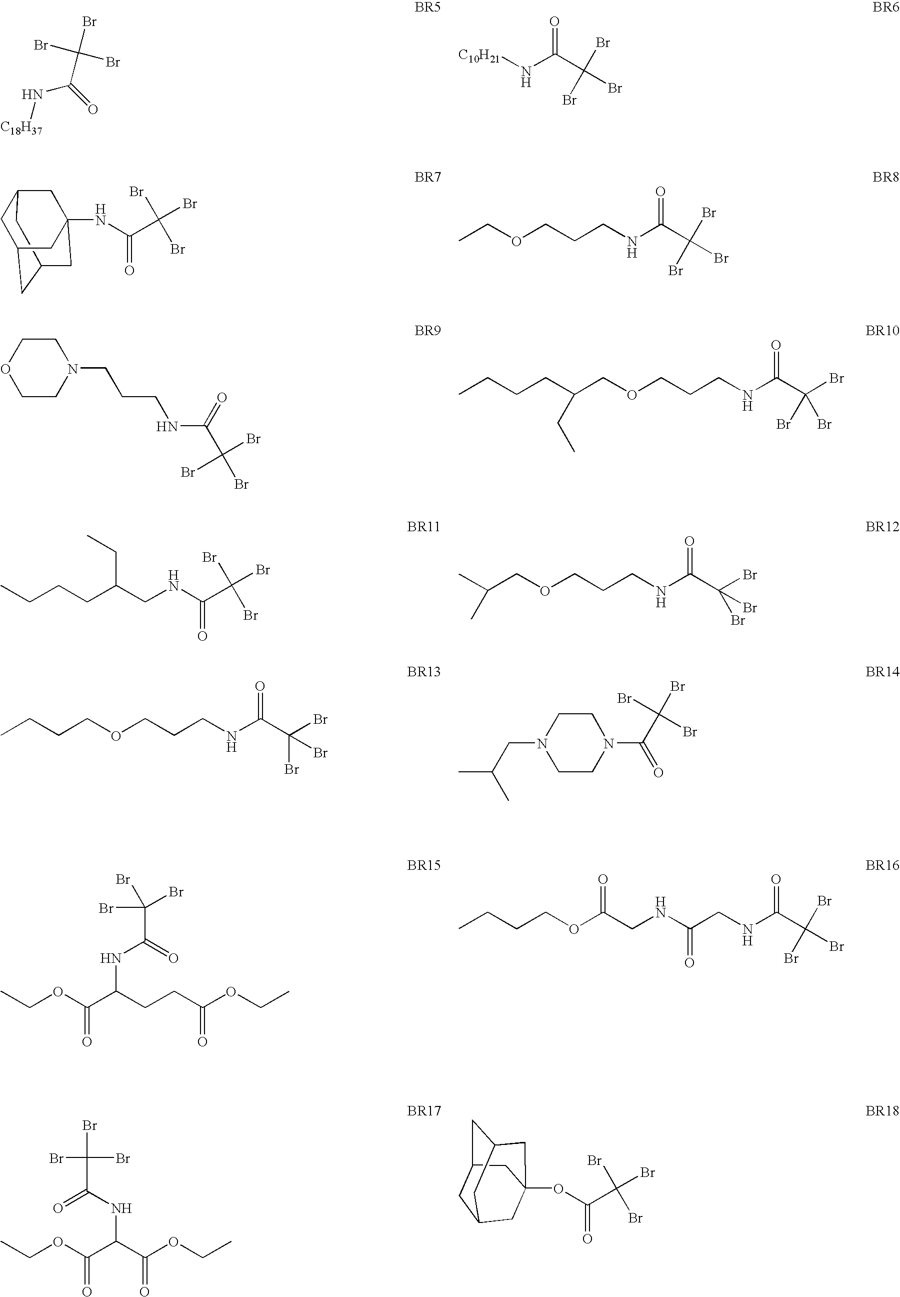

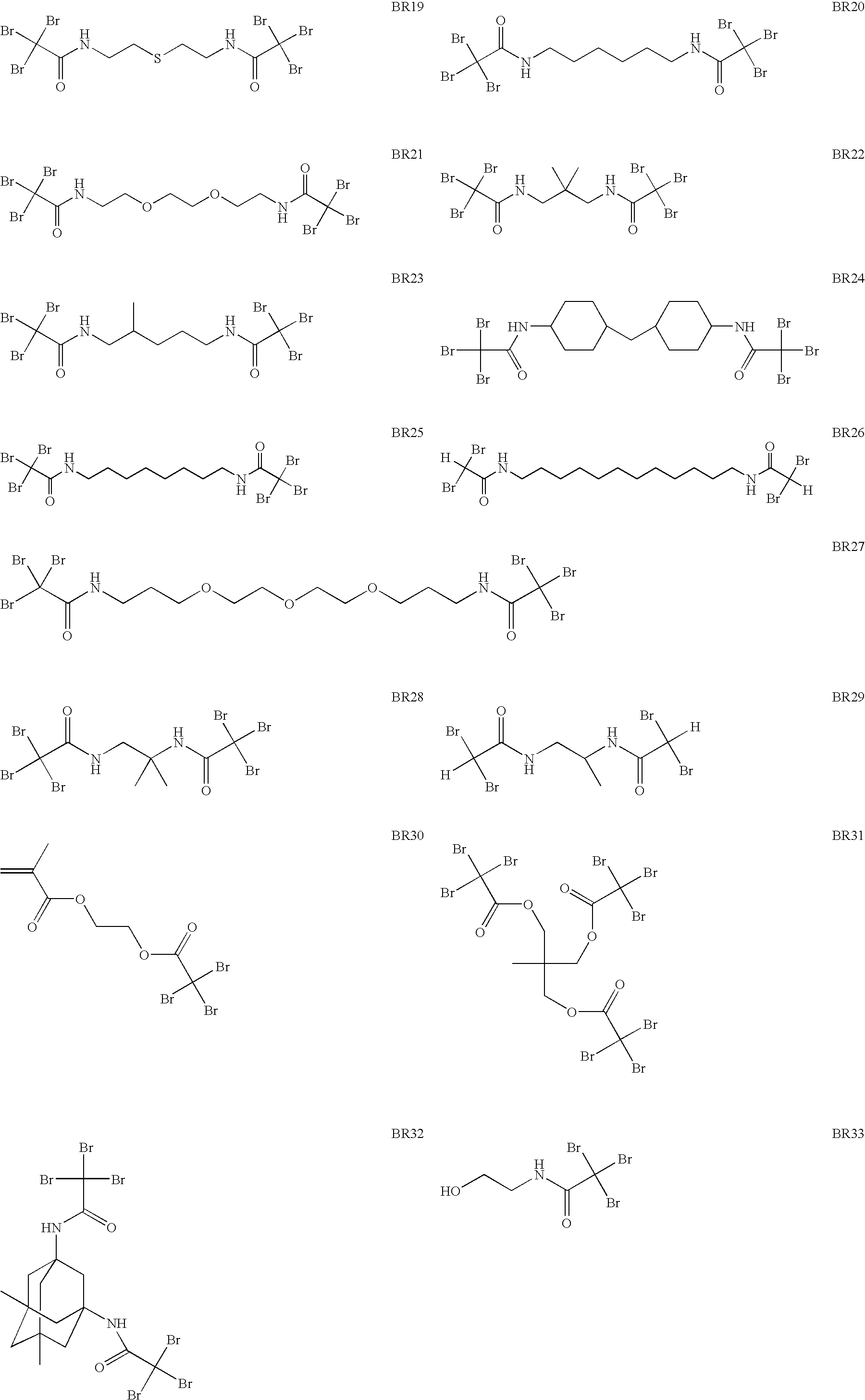

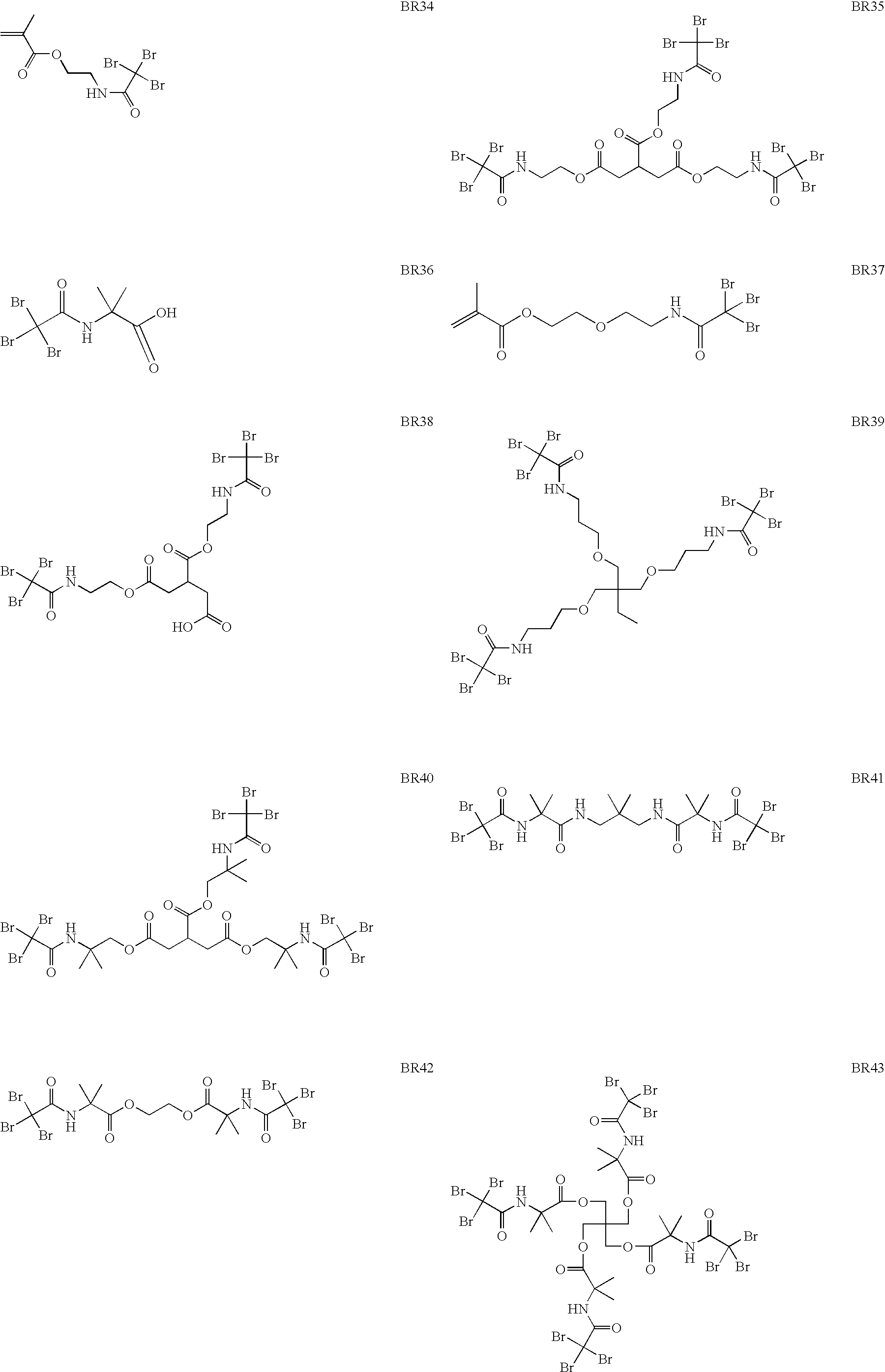

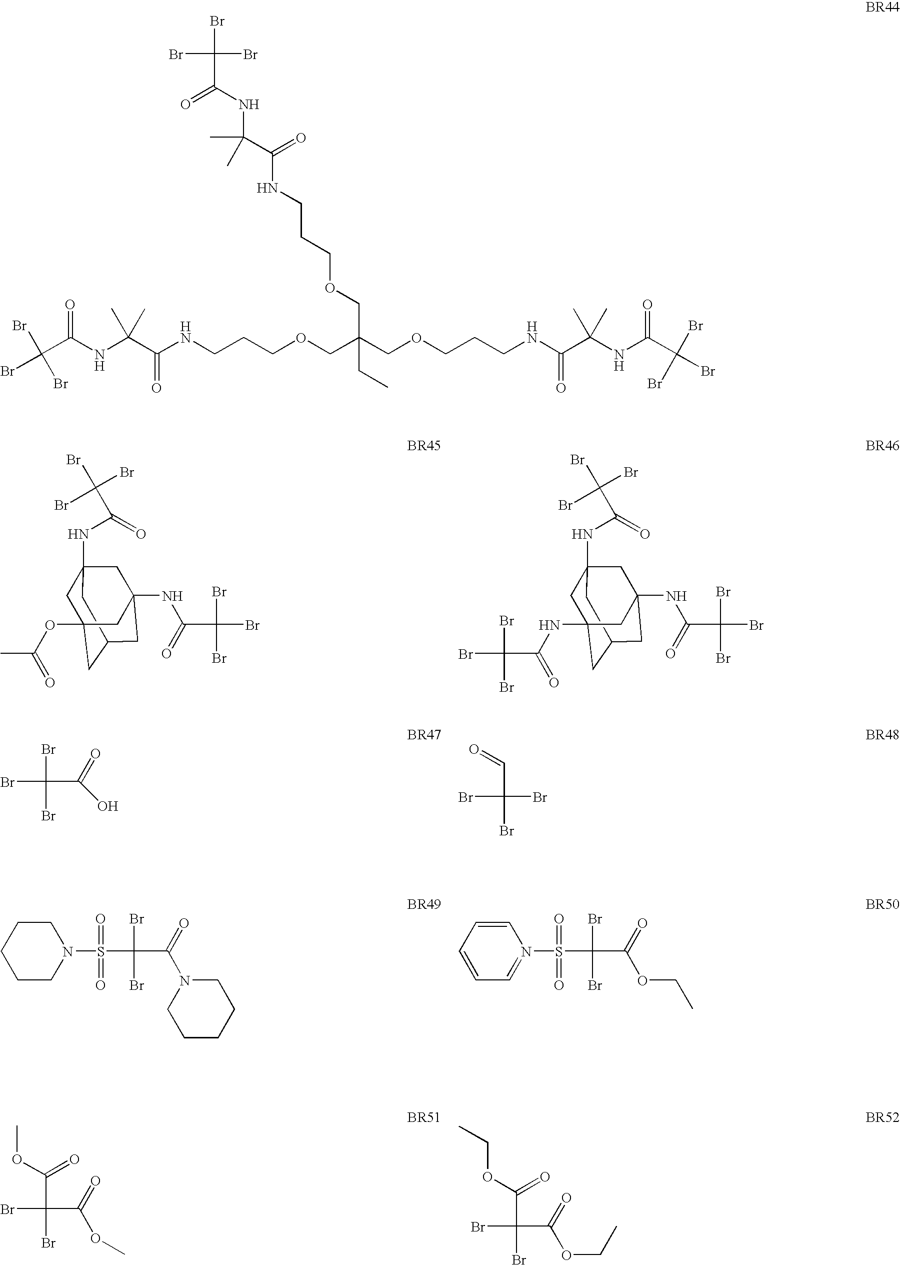

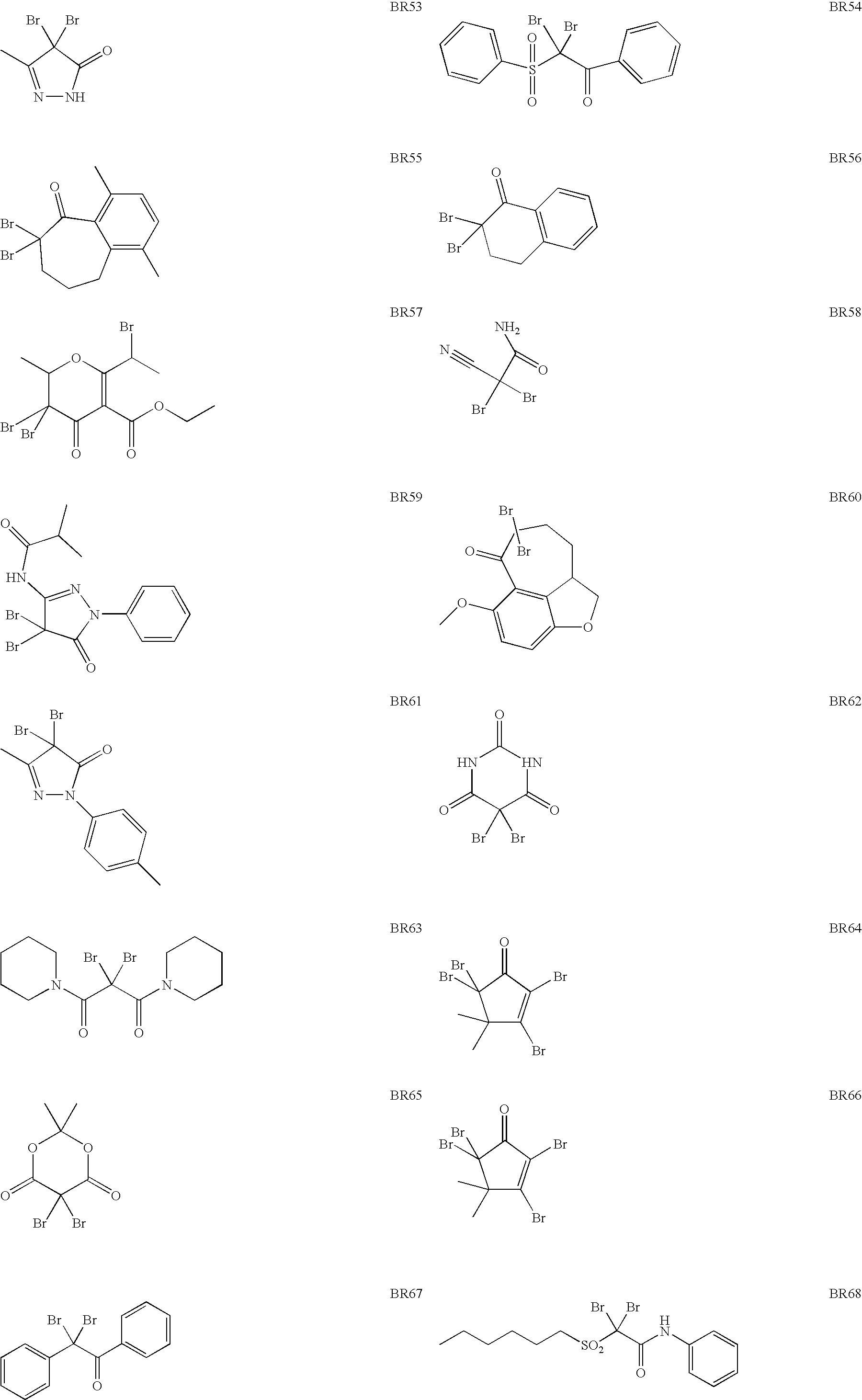

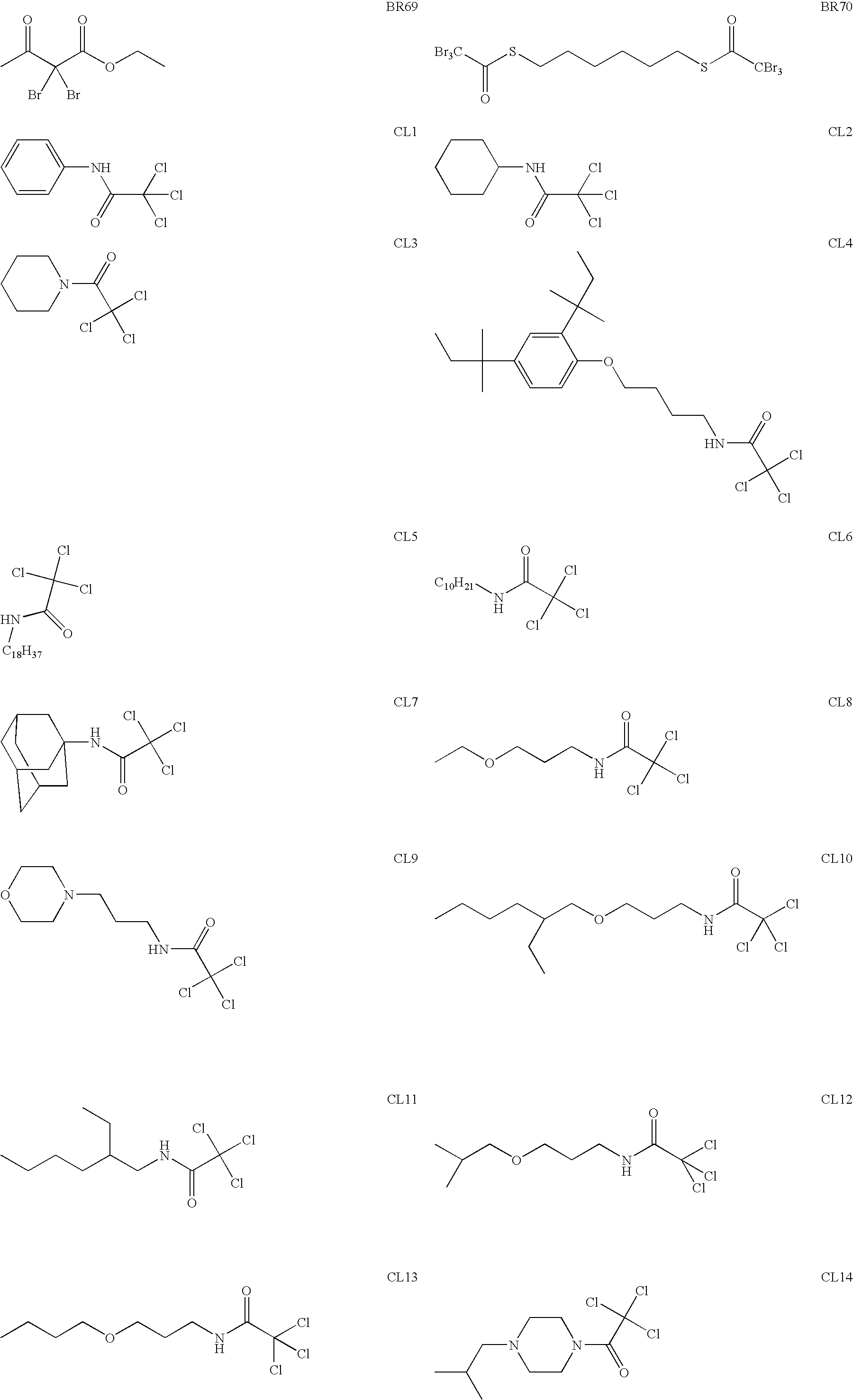

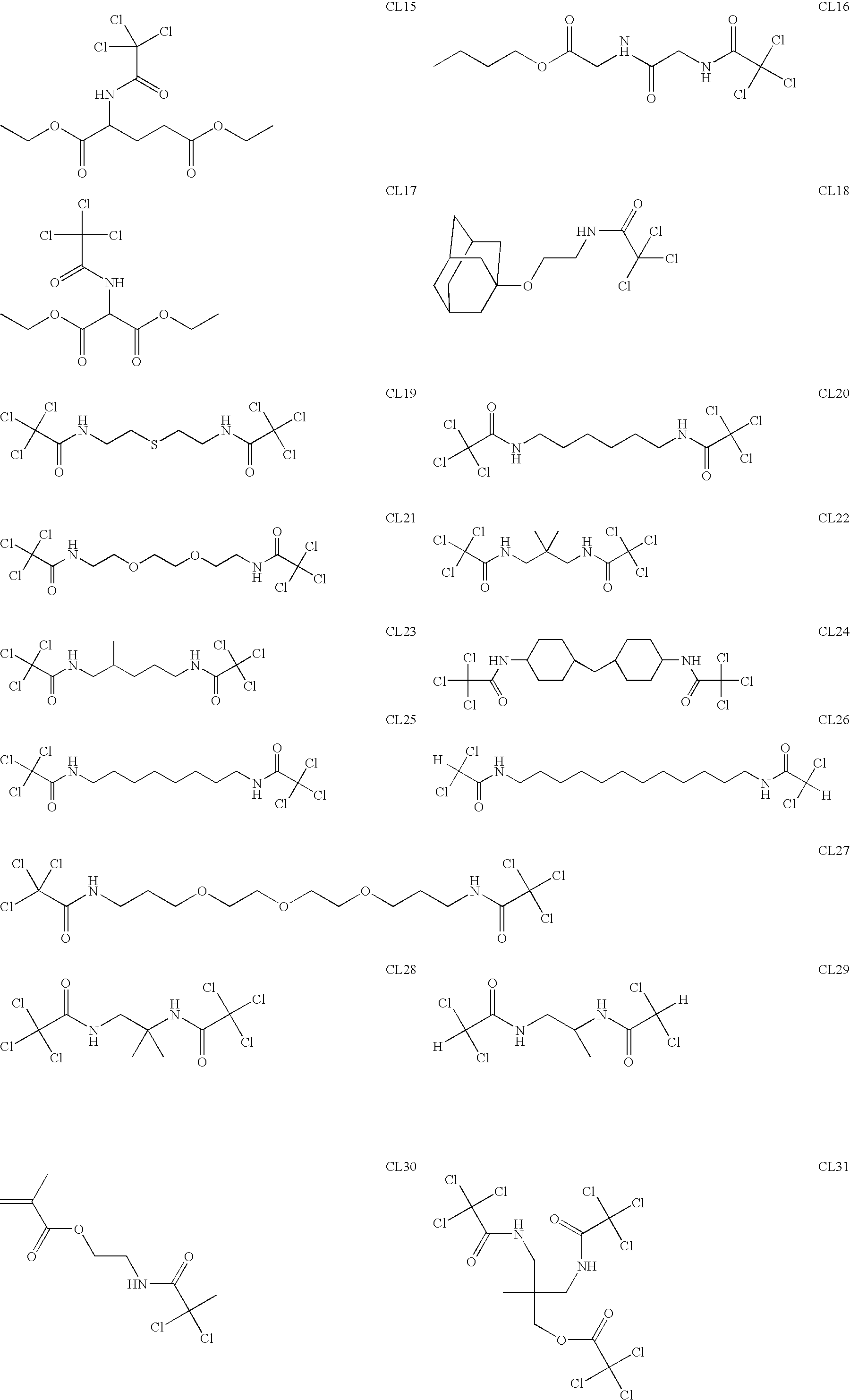

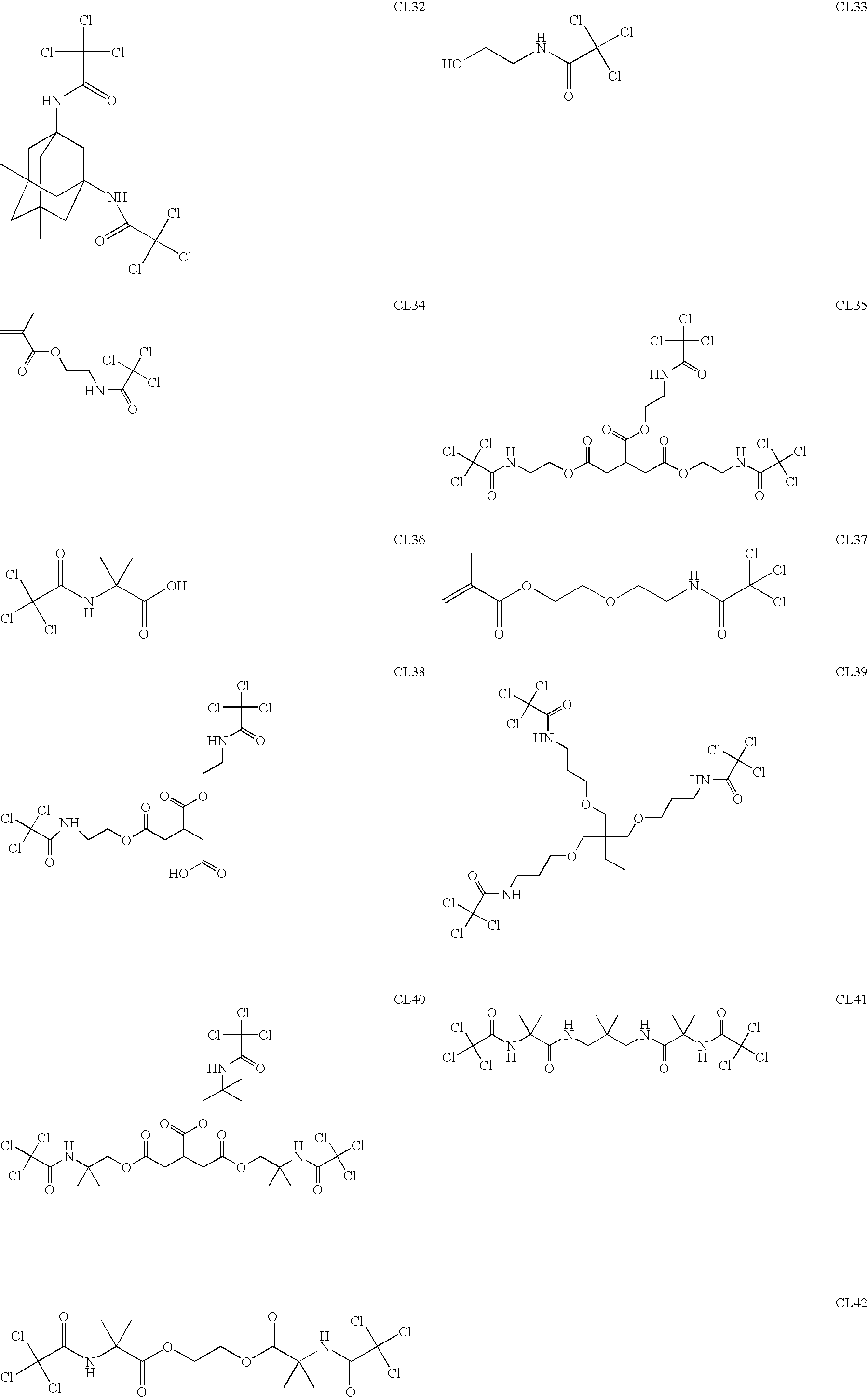

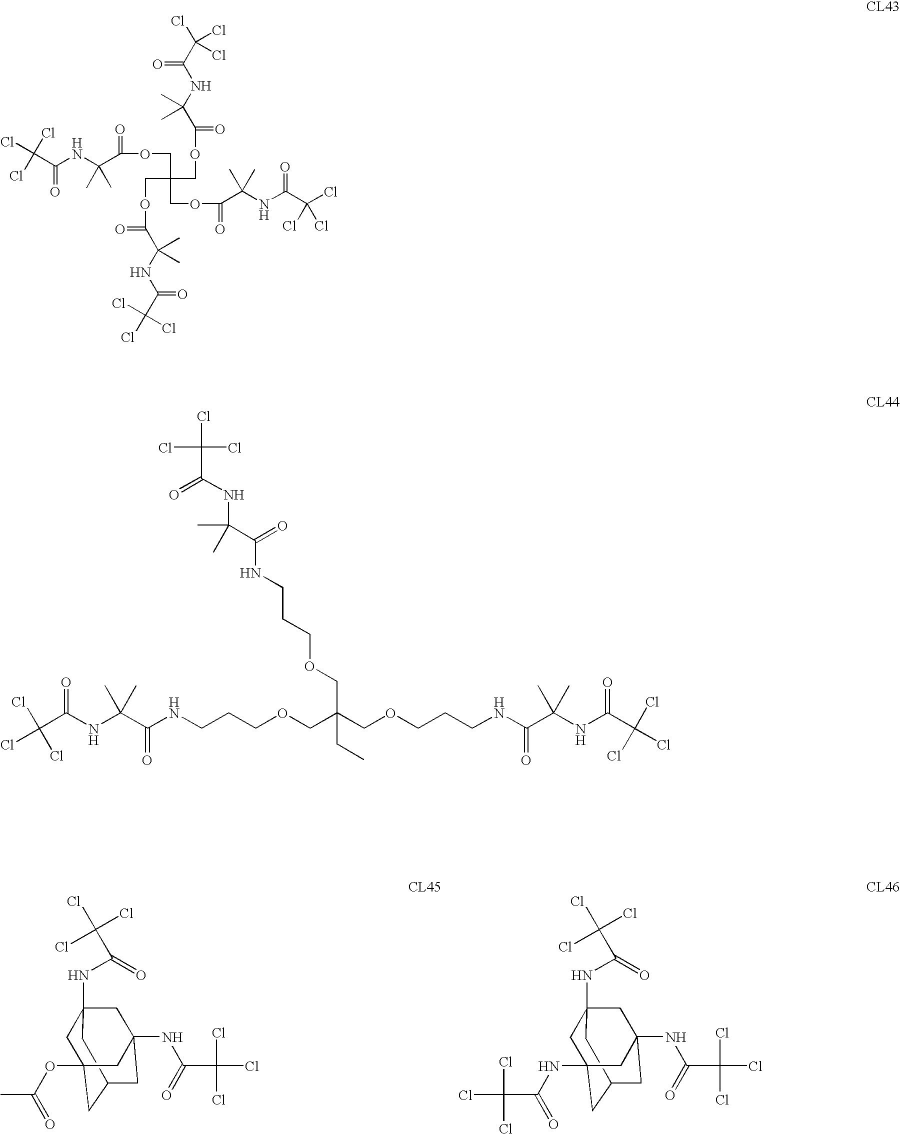

The acid generating agent represented in Formula (2) conventionally has a content of 0.1-30% by weight, based on the total solid content of the light-sensitive layer composition, and preferably has a content of 1-15% by weight, in view of development latitude and safelight property.

As to the acid generating agent represented in Formula (2), in the case of a structure of at least two light-sensitive layers, the agent compound is preferably contained at least one layer among the at least two light-sensitive layers. For example, in the case of a two light-sensitive layer structure, the agent compound is preferably added in the lower layer in view of acid generation ability together with sensitivity and development latitude.

A sulfonium salt compound represented by the following Formula (3) can also be utilized in view of excellent scratch resistance, and is preferably used for the upper layer in the case of a light-sensitive layer having a two light-sensitive layer structure, since the light-sensitive layer exhibits excellent dissolution restraint function.

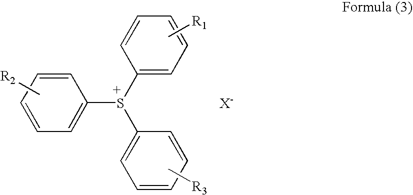

In Formula (3), R₁-R₃ each represent a hydrogen atom or a substituent, but R₁-R₃ are never a hydrogen atom at the same time.

Preferable examples of the substituent represented by R₁-R₃ include an alkyl group such as a methyl group, an ethyl group, a propyl group, an isopropyl group, a butyl group, an isobutyl group, a t-butyl group, a pentyl group or a hexyl group; an alkoxy group such as a methoxy group, an ethoxy group, a propoxy group, a butoxy group, a hexyloxy group, a decyloxy group or a dodecyloxy group; a carbonyl group such as an acetoxy group, a propionyloxy group, a decylcarbonyloxy group, a dodecylcarbonyloxy group, a methoxycarbonyl group, an ethoxycarbonyl group or a benzoyloxy group; a phenylthio group; a halogen atom such as a fluorine atom, a chlorine atom, a bromine atom or an iodine atom; a cyano group; a nitro group and a hydroxyl group.

X represents a non-nucleophilic anionic residual group, and includes a halogen atom such as F, Cl, Br or I; B(C₆F₅)₄; R₁₄COO; R₁₅SO₃; SbF₆; AsF₆; PF₆ and BF₄. However, R₁₄ and R₁₅ each are an alkyl group such as a methyl group, an ethyl group, a propyl group or a butyl group; a halogen atom such as a fluorine atom, a chlorine atom, a bromine atom or an iodine atom; a nitro group; a cyano group; an alkyl group or a phenyl group, which may be substituted by an alkoxy group such as a methoxy group or an ethoxy group. Among them, B(C₆F₅)₄ and PF₆ are preferable in view of safety.

Next, specific examples of the sulfonium salt compound represented by Formula (3) include the following compound Nos. 1-7, but the present invention is not limited thereto.

| | |
|---|---|
| | Formula (3) |
| 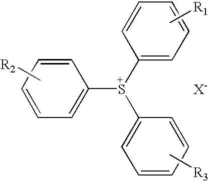 | |

| Exemplified | | | | |
|---|---|---|---|---|
| Compound | R₁ | R₂ | R₃ | X⁻ |
| 1 | —OCH₃ | —OCH₃ | —CF₃ | B(C₆F₅)₄⁻ |
| 2 | —OCH₃ | —OCH₃ | —CF₃ | SbF₆⁻ |
| 3 | —OCH₃ | —OCH₃ | —CF₃ | PF₆⁻ |
| 4 | —OCH₃ | —OCH₃ | —COF₃ | B(C₆F₅)₄⁻ |
| 5 | —OCH₃ | —OCH₃ | —COF₃ | SbF₆⁻ |
| 6 | —OCH₃ | —OCH₃ | —COF₃ | PF₆⁻ |
| 7 | —CH═CH— | —CH═CH— | —COF₃ | B(C₆F₅)₄⁻ |
| 8 | —CH═CH— | —CH═CH— | —COF₃ | SbF₆⁻ |
| 9 | —CH═CH— | —CH═CH— | —COF₃ | PF₆⁻ |
| 10 | —OCH₃ | —CF₃ | —CF₃ | B(C₆F₅)₄⁻ |
| 11 | —OCH₃ | —CF₃ | —CF₃ | SbF₆⁻ |
| 12 | —OCH₃ | —CF₃ | —CF₃ | PF₆⁻ |
| 13 | —CF₃ | —CF₃ | —CF₃ | B(C₆F₅)₄⁻ |
| 14 | —CF₃ | —CF₃ | —CF₃ | SbF₆⁻ |
| 15 | —CF₃ | —CF₃ | —CF₃ | PF₆⁻ |
| 16 | -t-Butyl | -t-Butyl | —CF₃ | B(C₆F₅)₄⁻ |
| 17 | -t-Butyl | -t-Butyl | —CF₃ | SbF₆⁻ |
| 18 | -t-Butyl | -t-Butyl | —CF₃ | PF₆⁻ |
| 19 | -i-Propyl | -i-Propyl | —CF₃ | B(C₆F₅)₄⁻ |
| 20 | -i-Propyl | -i-Propyl | —CF₃ | SbF₆⁻ |
| 21 | -i-Propyl | -i-Propyl | —CF₃ | PF₆⁻ |

In addition, each of R₁, R₂ and R₃ in the above exemplified chemical structure is p-substituted.

The acid generating agent represented in Formula (3) conventionally has a content of 0.1-30% by weight, based on the total solid content of the light-sensitive layer composition, and preferably has a content of 1-15% by weight, in view of development latitude and scratch resistance.

The acid generating agents may be used singly or as an admixture of at least two kinds thereof. The acid generating agents may also be incorporated into the upper layer as long as they do not deteriorate safelight property.

### (Visualizing Agent)

In the present invention, the light-sensitive layer can contain a colorant as a visualizing agent. Further, in the case of the light-sensitive layer having a two light-sensitive layer structure, at least one of the upper layer and the lower layer preferably contains a colorant as a visualizing agent. As the visualizing agent, provided are oil-soluble dyes and basic dyes including salt-forming organic dyes.

Those changing the color by the action of a free radical or an acid are preferably used. The term “changing the color” means changing from colorless to color, from color to colorless, or from the color to different color. Preferred dyes are those changing the color by forming salts with an acid.

Examples of the dyes changing from color to colorless or from the color to different color include triphenyl methane, diphenyl methane, oxazine, xanthene, iminonaphthoquinone, azomethine or anthraquinone dyes represented by Victoria pure blue BOH (product of Hodogaya Kagaku), Oil blue #603 (product of Orient Kagaku kogyo), Patent pure blue (product of Sumitomo Mikuni Kagaku Co., Ltd.), Crystal violet, Brilliant green, Ethyl violet, Methyl violet, Methyl green, Erythrosine B, Basic fuchsine, Marachite green, Oil red, m-cresol purple, Rhodamine B, Auramine, 4-p-diethylaminophenyliminonaphthoquinone or cyano-p-diethylaminophenylacetoanilide.

Examples of the dyes changing from colorless to color include leuco dyes and primary or secondary amines represented by triphenylamine, diphenylamine, o-chloroaniline, 1,2,3-triphenylguanidine, diaminodiphenylmethane, p,p′-bis-dimethylaminodiphenylamine, 1,2-dianilinoethylene, p,p′,p″-tris-dimethylaminotriphenylmethane, p,p′-bis-dimethylaminodiphenylmethylimine, p,p′,p″-triamino-o-methyltriphenylmethane, p,p′-bis-dimethylaminodiphenyl-4-anilinonaphthylmethane, and p,p′,p″-triaminotriphenylmethane. These dyes may be used singly or as an admixture of at least two kinds thereof. Especially preferred dyes are Victoria pure blue BOH (product of Hodogaya Kagaku) and Oil blue #603.

The dye as the visualizing agent can be contained in the lower and/or upper layers, and is preferably contained in the lower layer. As the visualizing agent used in the upper layer, dyes having maximum absorption in the wavelength regions of less than 800 nm, and preferably less than 600 nm are preferably employed. When the acid generating agent is used in the lower layer, the foregoing visualizing agent in the upper layer minimizes transmission of visible light, resulting in preferable results of improving safelight property. Such dyes are preferred since they can be used even when the acid generating agent unfavorable to safelight property is used in the lower layer.

The dye can be added in an amount of 0.01-10% by weight, based on the total solid content of the upper or lower layer, and preferably in an amount of 0.1-3% by weight.

### (Development Restrainer)

In the present invention, the light-sensitive layer may contain a dissolution restrainer as a development restrainer. Further, in the case of the light-sensitive layer having a two light-sensitive layer structure, at least one of the upper layer and the lower layer may contain various dissolution restrainers in order to adjust solubility.

As the dissolution restrainers, there are disulfone compounds or sulfone compounds disclosed in Japanese Patent O.P.I. Publication No. 11-119418. As the development restrainers, 4,4′-bishydroxyphenylsulfone is preferably used. The dissolution restrainer in the layer preferably has a content of 0.05-20% by weight, based on the weight of each layer, and more preferably has a content of 0.5-10% by weight

Development restrainers can be used in order to increase dissolution restraint function. The development restrainers are not specifically limited as long as they are ones which are capable of lowering the solubility at exposed portions by their interaction with the alkali soluble resin described above and of being dissolved in a developer at exposed portions due to weak interaction with the alkali soluble resin. As the restrainers, quaternary ammonium salts or polyethylene glycol derivatives are preferably used.

Examples of the quaternary ammonium salts include tetraalkylammonium salts, trialkylarylammonium salts, dialkyldiarylammonium salts, alkyltriarylammonium salts, tetraarylammonium salts, cyclic ammonium salts and bicyclic ammonium salts, but are not specifically limited thereto.

The quaternary ammonium salt in the upper layer preferably has a content of 0.1-50% by weight, based on the total solid content the upper layer, and more preferably has a content of 1-30% by weight, in view of a development restraining effect and film formation.

### (Development Accelerator)

In the present invention, the light-sensitive layer may contain a development accelerator. Further, in the case of the light-sensitive layer having a two light-sensitive layer structure, at least one of the upper layer and the lower layer may contain cyclic acid anhydrides, phenols or organic acids in order to improve sensitivity. Specifically, solubility of the light-sensitive layer is improved by adding these in the lower layer, and the residue is reduced, whereby it is preferable that generation of stains and a shadow defect are reduced.

As the cyclic acid anhydrides, there are phthalic anhydride, tetrahydrophthalic anhydride, hexahydrophthalic anhydride, 3,6-endoxy-Δ4-tetrahydrophthalic anhydride, tetrachlorophthalic anhydride, maleic anhydride, chloromaleic anhydride, α-phenylmaleic anhydride, succinic anhydride, pyromellitic anhydride disclosed in U.S. Pat. No. 4,115,128.

As the phenols, there are bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, and 4,4′,3″,4″-tetrahydroxy-3,5,3′,5′-tetramethylphenylmethane.

As the organic acids, there are sulfonic acids, sulfinic acids, alkyl sulfates, phosphonic acids, phosphates and carboxylic acids disclosed in Japanese Patent O.P.I. Publication Nos. 60-88942 and 2-96744. Examples thereof include p-toluene sulfonic acid, dodecylbenzene sulfonic acid, naphthalene sulfonic acid, p-toluene sulfinic acid, ethyl sulfuric acid, phenyl phosphonic acid, phenyl phosphinic acid, phenyl phosphate, diphenyl phosphate, benzoic acid, isophthalic acid, adipic acid, p-toluic acid, 3,4-dimethoxybenzoic acid, phthalic acid, telephthalic acid, 4-cyclohexene-1,2-dicarboxylic acid, erucic acid, lauric acid, n-undecylic acid, and ascorbic acid. The content of the cyclic acid anhydrides, phenols or organic acids is preferably 0.05-20% by weight, more preferably 0.1-15% by weight, and still more preferably 0.1-10% by weight, based on the weight of the layer containing them.

Alcohols having in the α-position at least one trifluoromethyl group disclosed in Japanese Patent O.P.I. Publication No. 2005-99298 can be used. This compound increases alkali solubility since acidity of the hydroxy group in the α-position is increased due to electron drawing effect of the trifluoromethyl group.

### (Surfactant)

In the present invention, the light-sensitive layer can contain surfactants. Further, in the case of the light-sensitive layer having a two light-sensitive layer structure, at least one of the upper layer and the lower layer can contain non-ionic surfactants as disclosed in Japanese Patent O.P.I. Publication Nos. 62-251740 and 3-208514, amphoteric surfactants as disclosed in Japanese Patent O.P.I. Publication Nos. 59-121044 and 4-13149, siloxane compounds disclosed in EP 950517, or fluorine-containing copolymers disclosed in Japanese Patent O.P.I. Publication Nos. 62-170950, 11-288093, and 2003-57820, in order to improve the coatability and increase stability under various developing conditions.

Examples of the non-ionic surfactants include sorbitan tristearate, sorbitan monopalmitate, sorbitan trioleate, stearic acid monoglyceride, polyoxyethylene sorbitan monooleate, and polyoxyethylene nonylphenyl ether. Examples of the amphoteric surfactants include alkyldi(aminoethyl)-glycine, alkylpoly(aminoethyl)glycine hydrochloride, 2-alkyl-N-carboxyethyl-N-hydroxyethylimidazolinium betaine, and N-tetradecyl-N,N-betaine type compounds (for example, trade name: AMOGEN K produced by DAIICHI KOGYO CO., LTD.).

Examples of the siloxane compounds include a block copolymer of dimethyl polysiloxane and polyalkylene oxide, for example, polyalkylene oxide-modified silicons such as DBE-224, DBE-621, DBE-712, DBE-732, and DBE-534, each produced by Chisso Co., Ltd., and Tego Glide 100 produced by Tego Co., Ltd. The non-ionic or amphoteric surfactant preferably has a content of 0.01-15% by weight, based on the total solid content of upper or lower layer, and more preferably has a content of 0.1-5% by weight.

### (Support)

In the present invention, supports formed from various materials such as metal, resin so forth are usable, but a support made of aluminum is preferable.

As an aluminum support, an aluminum plate or an aluminum alloy plate is employed.

As the aluminum alloy, there can be used various ones including an alloy of aluminum and a metal such as silicon, copper, manganese, magnesium, chromium, zinc, lead, bismuth, nickel, titanium, sodium or iron. An aluminum plate can be used which is manufactured according to various calender procedures. A regenerated aluminum plate can also used which is obtained by calendering ingot of aluminum material such as aluminum scrap or recycled aluminum.

It is preferable that the aluminum support is subjected to degreasing treatment for removing rolling oil prior to surface roughening (graining). The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting support is preferably subjected to desmut treatment in an aqueous solution of an acid such as phosphoric acid, nitric acid, sulfuric acid, chromic acid, or a mixture thereof, since smut is produced on the surface of the support.

The resulting aluminum plate is subjected to surface roughening treatment. The surface roughening methods include a mechanical surface roughening method and an electrolytic surface roughening method electrolytically etching the support surface. In the present invention, surface roughening is preferably carried out in an acidic electrolyte solution containing hydrochloric acid, employing alternating current. Prior to this treatment, electrolytic surface roughening in an electrolyte solution containing nitric acid or mechanical surface roughening may be carried out.

Though there is no restriction for the mechanical surface roughening method, a brushing roughening method and a honing roughening method are preferable. The brushing roughening method is carried out by rubbing the surface of the support with a rotating brush with a brush hair with a diameter of 0.2-0.8 mm, while supplying slurry in which volcanic ash particles with a particle diameter of 10-100 μm are dispersed in water to the surface of the support. The honing roughening method is carried out by ejecting obliquely slurry with pressure applied from nozzles to the surface of the support, the slurry containing volcanic ash particles with a particle diameter of 10-100 μm dispersed in water. A surface roughening can be also carried out by laminating a support surface with a sheet on the surface of which abrading particles with a particle diameter of 10-100 μm was coated at intervals of 100-200 μm and at a density of 2.5×10³-10×10³/cm², and applying pressure to the sheet to transfer the roughened pattern of the sheet and roughen the surface of the support.

After the support has been roughened mechanically, it is preferably dipped in an acid or an aqueous alkali solution in order to remove abrasives and aluminum dust, etc. which have been embedded in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous alkali solution of for example, sodium hydroxide is preferably used. The dissolution amount of aluminum in the support surface is preferably 0.5-5 g/m². After the support has been dipped in the aqueous alkali solution, it is preferable for the support to be dipped in an acid such as phosphoric acid, nitric acid, sulfuric acid and chromic acid, or in a mixed acid thereof, for neutralization.

When electrolytically surface roughening is carried out in an electrolytic solution containing mainly nitric acid, voltage applied is generally 1-50 V, and preferably 10-30 V. The current density used can be selected from the range of 10-200 A/dm², and preferably of 20-100 A/dm². The quantity of electricity can be selected from the range of 100-5000 C/dm², and is preferably 100-2000 C/dm². The temperature during the electrolytically surface roughening may be in the range of 10-50° C., and is preferably 15-45° C. The nitric acid concentration in the electrolytic solution is preferably 0.1-5% by weight. It is possible to optionally add, to the electrolytic solution, nitrates, chlorides, amines, aldehydes, phosphoric acid, chromic acid, boric acid, acetic acid, oxalic acid or an aluminum ion.

After electrolytically surface roughened is carried out in the electrolytic solution containing mainly nitric acid, it is preferably dipped in an acid or an aqueous alkali solution in order to remove aluminum dust and the like produced in the surface of the aluminum plate. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the plate surface is preferably 0.5-5 g/m². After the plate has been dipped in the aqueous alkali solution, it is preferably dipped in an acid such as phosphoric acid, nitric acid, sulfuric acid and chromic acid, or in a mixed acid thereof, for neutralization.

When electrolytically surface roughening is carried out in an electrolytic solution containing mainly hydrochloric acid, the hydrochloric acid concentration is 5-20 g/liter, and preferably 6-15 g/liter. The current density used is 15-120 A/dm², and preferably 20-90 A/dm². The quantity of electricity is 400-2000 C/dm², and preferably 500-1200 C/dm². The frequency is preferably 40-150 Hz. The temperature during the electrolytically surface roughening is 10-50° C., and preferably 15-45° C. It is possible to optionally add, to the electrolytic solution, nitrates, chlorides, amines, aldehydes, phosphoric acid, chromic acid, boric acid, acetic acid, oxalic acid or an aluminum ion.

After electrolytically surface roughened is carried out in the electrolytic solution containing mainly hydrochloric acid, it is preferably dipped in an acid or an aqueous alkali solution in order to remove aluminum dust and the like produced in the surface of the aluminum plate. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the plate surface is preferably 0.5-2 g/m² After the plate has been dipped in the aqueous alkali solution, it is preferably dipped in an acid such as phosphoric acid, nitric acid, sulfuric acid and chromic acid, or in a mixed acid thereof, for neutralization.

The surface on a light-sensitive layer side of the aluminum plate obtained above preferably has arithmetic average roughness (Ra) of 0.4-0.6 μm. The surface roughness can be controlled by an appropriate combination of hydrochloric acid concentration, current density and quantity of electricity in surface roughening.

After the surface roughening, anodizing treatment is carried out to form an anodization film on the surface of the plate. In the present invention, the anodizing treatment is preferably carried out in a sulfuric acid electrolyte solution or an electrolyte solution containing mainly sulfuric acid. The sulfuric acid concentration is preferably 5-50% by weight, and more preferably 10-35% by weight. The temperature during the anodizing treatment is preferably 10-50° C. The voltage applied is preferably at least 18 V. The current density used is preferably 1-30 A/dm². The quantity of electricity is preferably 20-600 C/dm².

The coated amount of the formed anodization film is preferably 2-6 g/m², and preferably 3-5 g/m². The coated amount of the formed anodization film can be obtained from the weight difference between the aluminum plates before and after dissolution of the anodization film. The anodization film of the aluminum plate is dissolved employing for example, an aqueous phosphoric acid chromic acid solution which is prepared by dissolving 35 ml of 85% by weight phosphoric acid and 20 g of chromium (IV) oxide in 1 liter of water. The micro pores are formed in the anodization film, and the micro pore density is preferably 400-700/μm², and more preferably 400-600/μm².

The aluminum plate, which has been subjected to anodizing treatment, is optionally subjected to sealing treatment. For the sealing treatment, it is possible to use known methods using hot water, boiling water, steam, a sodium silicate solution, an aqueous dichromate solution, a nitrite solution and an ammonium acetate solution.

### <Hydrophilization Processing>

After the above treatments, the resulting aluminum plate is preferably subjected to hydrophilization processing in resistance to chemicals and sensitivity.

The hydrophilization processing method is not specifically limited, but there is a method of undercoating, on a support, a water soluble resin such as polyvinyl phosphonic acid, polyvinyl alcohol or its derivatives, carboxymethylcellulose, dextrin or gum arabic; phosphonic acids with an amino group such as 2-aminoethylphosphonic acid; a polymer or copolymer having a sulfonic acid in the side chain; polyacrylic acid; a water soluble metal salt such as zinc borate; a yellow dye; an amine salt; and so on.

The sol-gel treatment support disclosed in Japanese Patent O.P.I. Publication No. 5-304358, which has a functional group capable of causing addition reaction by radicals as a covalent bond, is suitably used. It is preferred that the support is subjected to hydrophilization processing employing polyvinyl phosphonic acid.

As the processing method, there is for example, a coating method, a spraying method or a dipping method. The solution used in the dipping method is preferably an aqueous 0.05-3% polyvinyl phosphonic acid solution. The dipping method is preferred in that the facility is cheap. The temperature is preferably 20-90° C., and the processing time is preferably 10-180 seconds. After the processing, excessive polyvinyl phosphonic acid is removed from the support surface preferably through washing or squeegeeing. After that, drying is preferably carried out.

The drying temperature is preferably 40-180° C., and more preferably 50-150° C. The drying is preferred in increasing adhesion of the hydrophilization processing layer to the support, improving insulating function of the hydrophilization processing layer, and increasing resistance to chemicals and sensitivity.

The dry thickness of the hydrophilization processing layer is preferably 0.002-0.1 μm, and more preferably 0.005-0.05 μm in view of adhesion to the support, heat insulating property, and sensitivity.

### (Back Coat Layer)

A back coat layer may be provided on the rear surface of the aluminum support (the surface of the aluminum support opposite the upper layer as described above) in order to minimize dissolution of the anodization film on alkali development. The back coat layer is preferred, since it minimizes sludge produced during development, shorten developer exchange period, and lessens supply amount of developer replenisher. The back coat layer preferably contains (a) metal oxides obtained from hydrolysis or polycondensation of organic or inorganic metal compounds, (b) colloidal silica sol and (c) an organic polymeric compound.

Examples of the metal oxides used in the back coat layer include silica (silicon oxide), titanium oxide, boron oxide, aluminum oxide, zirconium oxide, and their composites. The metal oxides used in the back coat layer is formed by coating a sol-gel reaction solution on the rear surface of the aluminum support and drying it, the sol-gel reaction solution being obtained by hydrolyzing and condensing organic or inorganic metal compounds in water and an organic solvent in the presence of a catalyst such as an acid or an alkali. As the organic or inorganic metal compounds used herein, there are metal alkoxide, metal acetylacetonate, metal acetate, metal oxalate, metal nitrate, metal sulfate, metal carbonate, metal oxychloride, metal chloride, and their oligomers obtained by partially hydrolyzing and condensing these metal compounds.

### (Coating and Drying)

The light-sensitive layer of the planographic printing plate material in the present invention is conventionally formed on a support by dissolving each of the foregoing components in a solvent. The following coating solvents are usable as solvents used here. Further, in the case of a light-sensitive layer having a two light-sensitive layer structure, each of the foregoing components is conventionally dissolved in a solvent, and the coating solvent is coated on each of supports to form the upper layer and the lower layer. These solvents may be used singly or as an admixture of at least two kinds thereof.

### <Coating Solvents>

As the coating solvents, there are, for example, n-propanol, isopropyl alcohol, n-butanol, sec-butanol, isobutanol, 2-methyl-1-butanol, 3-methyl-1-butanol, 2-methyl-2-butanol, 2-ethyl-1-butanol, 1-pentanol, 2-pentanol, 3-pentanol, n-hexanol, 2-hexanol, cyclohexanol, methylcyclohexanol, 1-heptanol, 2-heptanol, 3-heptanol, 1-octanol, 4-methl-2-pentanol, 2-hexylalcohol, benzyl alcohol, ethylene glycol, diethylene glycol, triethylene glycol, tetraethylene glycol, 1,3-propane diol, 1,5-pentane glycol, dimethyl triglycol, furfuryl alcohol, hexylene glycol, hexyl ether, 3-methoxy-1-methylbutanol, butyl phenyl ether, ethylene glycol monoacetate, propylene glycol monomethylether, propylene glycol monoethylether, propylene glycol monopropylether, propylene glycol monobutylether, propylene glycol phenylether, dipropylene glycol monomethylether, dipropylene glycol monoethylether, dipropylene glycol monopropylether, dipropylene glycol monombutylether, tripropylene glycol monomethylether, methyl carbitol, ethyl carbitol, ethyl carbitol acetate, butyl carbitol, triethylene glycol monomethylether, triethylene glycol monoethylether, tetraethylene glycol dimethylether, diacetone alcohol, acetophenone, cyclohexanone, methyl cyclohexanone, acetonylacetone, isophorone, methyl lactate, ethyl lactate, butyl lactate, propylene carbonate, phenyl acetate, sec-butyl acetate, cyclohexyl acetate, diethyl oxalate, methyl benzoate, ethyl benzoate, γ-butyrolactone, 3-methoxy-1-butanol, 4-methoxy-1-butanol, 3-ethoxy-1-butanol, 3-methoxy-3-methyl-1-butanol, 3-methoxy-3-ethyl-1-pentanol, 4-ethoxy-1-pentanol, 5-methoxy-1-hexanol, 3-hydroxy-2-butanone, 4-hydroxy-2-butanone, 4-hydroxy-2-pentanone, 5-hydroxy-2-pentanone, 4-hydroxy-3-pentanone, 6-hydroxy-2-pentanone, 6-hydroxy-2-hexanone, 3-methyl-3-hydroxy-2-pentanone, methyl cellosolve (MC), and ethyl cellosolve (EC).

In the case of a light-sensitive layer having a two light-sensitive layer structure, as a coating solvent for the upper layer and the lower layer, preferably selected is the coating solvent in which an alkali soluble polymer used for the upper layer is different in solubility from an alkali soluble polymer for the lower layer. When a thermosensitive layer as an upper layer is coated on a lower layer surface after coating the lower layer, employing, as a coating solvent for the upper layer, a solvent dissolving the alkali soluble polymer of the lower layer, the upper layer is mixed with the lower layer at the interface of the two layers, and the extreme cases of the mixing form a uniform single layer. Accordingly, such mixing is undesirable, since it may not show the effects of the present invention that the two separate layers in the present invention, i.e., the upper and lower layers provide. A solvent used in the upper thermosensitive layer coating solution is preferably a poor solvent of the alkali soluble polymer contained in the lower layer.

In order to prevent mixing of the upper and lower layers, there are a method in which air is blown onto the coated surface with high pressure from slit nozzles arranged at right angle to the running direction of web, a method in which heat is supplied as conductive heat onto the rear surface through a heat roll inside which a heated medium such as vapor is supplied, and their combination, whereby a second coated layer coated on a first coated layer is rapidly dried.

As a method for mixing the two layers to the degree that the effects of the present invention is produced, there is a method employing the solvency difference as described above of the coating solvents or a method rapidly drying the second coated layer coated on the first coated layer, both of which can adjust the degree.

The coating solution for the upper or lower layer has a total solid content (including additives) of preferably 1-50% by weight. Although the dry coating amount of a light-sensitive layer, which has been formed on the support depends on usage, the dry coating amount of the light-sensitive layer is preferably 0.05-1.0 g/m², and the dry coating amount of the lower layer is preferably 0.3-3.0 g/m². The total dry coating amount of the upper layer and the lower layer is preferably 0.5-3.0 g/m² in view of layer properties and sensitivity.

The resulting coating composition (light-sensitive layer coating solution) is coated on a support according to a conventional method and dried to obtain a planographic printing plate material. As the coating methods, there are an air doctor coating method, a blade coating method, a wire bar coating method, a knife coating method, a dip coating method, a reverse roll coating method, a gravure coating method, a cast coating method, a curtain coating method, and an extrusion coating method.

The drying temperature is preferably 60-160° C., more preferably 80-140° C., and still more 90-120° C. An infrared radiation device can be utilized as a drying device to improve drying efficiency.

In the present invention, a planographic printing plate material, which is obtained by coating the coating solution on a support and drying it, may be further subjected to aging treatment to stabilize the performance thereof. The aging treatment may be carried out in an aging device provided following a drying device or in an aging device provided separately. As disclosed in Japanese Patent O.P.I. Publication No. 2005-17599, the aging treatment may be used as a step in which OH groups on the layer surface are brought into contact with each other. In the aging treatment, a compound having a polar group represented by water permeates and diffuses from the layer surface to the inside of the layer whereby interaction in the layer is enhanced through water, cohesion is enhanced by heating, and performance of the layer is improved. Temperature at the aging treatment is preferably set so that a compound to be diffused is evaporated beyond a specific amount. Typical examples of the compound to be diffused and permeate include water, and a compound having a polar group such as a hydroxyl group, a carboxyl group, a ketone group, an aldehydes group or an ester group. The boiling point of these compounds is preferably not more than 200° C., more preferably not more than 150° C., but preferably at least 50° C., more preferably at least 70° C. The molecular weight is preferably not more than 150, and more preferably not more than 100.

### <Exposure and Development for Image Formation>

The above-obtained planographic printing plate material is imagewise exposed and developed to prepare a planographic printing plate for printing.

A light source employed for imagewise exposure is preferably one having an emission wavelength in the wavelength regions of from near infrared to infrared, and more preferably a solid laser or a semiconductor laser. Imagewise exposure is carried out through an infrared laser based on digital converted data, employing a setter for CTP available on the market, followed by development, whereby a planographic printing plate with an image on the aluminum support used for printing is obtained.

In the present invention, after the planographic printing plate material is exposed to infrared laser having a wavelength of 780-1200 nm, it is preferably treated with an alkaline developer to remove non-image portions.

An exposure device used in the present invention is not specifically limited, as long as it is a laser method. Any of a method of laser scanning on an outer surface of a drum (an outer drum scanning method), a method of laser scanning on an inner surface of a drum (an inner drum scanning method), and a method of laser scanning on a plane (a flat head scanning method) can be used. The outer drum scanning method is preferably used which can easily provide multi-beams for improving productivity of low exposure intensity and long time exposure. An exposure device with a GLV modulation element employing the outer drum scanning method is especially preferred.

It is preferred in the present invention that imagewise exposure is carried out employing an exposure device with a GLV modulation element whereby laser beams are multi-channeled, which improves productivity of planographic printing plates. The GLV modulation element is preferably one capable of dividing laser beams into at least 200 channels, and more preferably one capable of dividing laser beams into at least 500 channels. The laser beam spot diameter is preferably not more than 15 μm, and more preferably not more than 10 μm. The laser output power is preferably 10-100 W, and more preferably 20-80 W. The drum rotation number is preferably 20-300 rpm, and more preferably 30-200 rpm.

### (Developer)

It is a feature that the positive-working planographic printing plate material of the present invention is exposed to light to form images, and is subsequently subjected to a development treatment employing water or an alkaline developer.

A developer or developer replenisher applicable to the planographic printing plate material of the present invention is one having a pH of 9.0-14.0 at 25° C., and preferably a pH of 12.0-13.5.

A developer including a developer replenisher (hereinafter also referred to as simply a developer) in the present invention is a well known aqueous alkaline solution containing, as an alkali agent, sodium hydroxide, ammonium hydroxide, potassium hydroxide or lithium hydroxide. These alkali agents may be used singly or as an admixture of two or more kinds thereof. Other alkali agents include potassium silicate, sodium silicate, lithium silicate, ammonium silicate, potassium metasilicate, sodium metasilicate, lithium metasilicate, ammonium metasilicate, potassium phosphate, sodium phosphate, lithium phosphate, ammonium phosphate, potassium hydrogenphosphate, sodium hydrogenphosphate, lithium hydrogenphosphate, ammonium hydrogenphosphate, potassium carbonate, sodium carbonate, lithium carbonate, ammonium carbonate, potassium hydrogencarbonate, sodium hydrogencarbonate, lithium hydrogencarbonate, ammonium hydrogencarbonate, potassium borate, sodium borate, lithium borate and ammonium borate. Sodium hydroxide, ammonium hydroxide, potassium hydroxide or lithium hydroxide may be added to developer in order to adjust the pH of developer. An organic alkali agent such as monomethhylamine, dimethylamine, trimethylamine, monoethylamine, diethylamine, triethylamine, monoisobutylamine, diisobutylamine, triisobutylamine, n-butylamine, monoethanolamine, diethanolamine, triethanolamine, monoisopropanolamine, diisopropanolamine, ethyleneimine, ethylenediamine or pyridine can be used in combination. Among these, potassium silicate or sodium silicate is preferred. The concentration of silicate in the developer is preferably 2-4% by weight in terms of SiO₂ concentration. The ratio by mole (SiO₂/M) of SiO₂ to alkali metal M is preferably 0.25-2.

The developer of the present invention refers to a developer (so-called working developer) replenished with developer replenisher in order to maintain activity of the developer which lowers during development of infrared laser thermosensitive planographic printing plate material, as well as fresh developer used at the beginning of development.

The developer or developer replenisher in the present invention can contain various surfactants or organic solvents as necessary, in order to accelerate development, disperse smuts occurring during development, or enhance ink receptivity at the image portions of printing plate.

The developer or developer replenisher may contain the following additives in order to increase development performance. Examples of the additives include a neutral salt such as sodium chloride, potassium chloride, potassium bromide, as disclosed in Japanese Patent O.P.I. Publication No. 58-75152, a complex such as [Co(NH₃)₆]Cl₃ as dislosed in Japanese Patent O.P.I. Publication No. 59-121336, an amphoteric polymer such as a copolymer of vinylbenzyl-trimethylammonium chloride and sodium acrylate as disclosed in Japanese Patent O.P.I. Publication No. 56-142258, the organic metal containing surfactant containing Si or Ti as disclosed in Japanese Patent O.P.I. Publication No. 59-75255, and the organic boron containing compound disclosed in Japanese Patent O.P.I. Publication No. 59-84241.

The developer or developer replenisher in the present invention can further contain an antiseptic agent, a colorant, a viscosity increasing agent, an antifoaming agent, or a water softener.

The developer or developer replenisher used in the present invention is an aqueous concentrated solution with a low water content, which is diluted with water and used for development. The aqueous concentrated solution is advantageous in view of its transport. The degree of concentration of the concentrated solution is such that the components contained in the solution are not separated nor precipitated. The concentrated solution may contain a solubilizing agent. As the solubilizing agent, preferred is so-called hydrotrope such as toluene sulfonic acid, xylene sulfonic acid, or their alkali metal salt, which is disclosed in Japanese Patent O.P.I. Publication Nos. 6-32081.

### (Non-Silicate Developer)

Development of the positive-working planographic printing plate material of the present invention can be also carried out employing a so-called “non-silicate developer” containing a non-reducing saccharide and a base but containing no alkali silicate. Development of the planographic printing plate material employing this developer provides a recording layer with good ink receptivity at the image portions without deteriorating the recording layer surface. Generally, development latitude of a planographic printing plate material is narrow, and the line width of line images of a developed planographic printing plate material is greatly changed due to pH of developer. Since the non-silicate developer contains a non-reducing saccharide with buffering property restraining a pH change, it is more advantageous than a developer containing a silicate. The non-silicate developer is also advantageous, since the non-reducing saccharide makes it difficult to contaminate an electrical conductivity sensor, a pH sensor, and the like controlling the activity of a developer, compared with a silicate. Further, the non-silicate developer greatly improves discrimination between the image and non-image portions.

The non-reducing saccharide is one having neither aldehyde group nor ketone group and exhibiting no reducing power. The saccharide is classified into trehalose type oligosaccharide, in which the reducing groups are bonded to each other; glycoside, in which a reducing group of a saccharide is bonded to a non-saccharide; and saccharide alcohol obtained by reducing a saccharide by hydrogenation. In the present invention, any one of these saccharides is preferably used. In the present invention, non-reducing saccharides disclosed in Japanese Patent O.P.I. Publication No. 8-305039 can be suitably used.

These no-reducing saccharides may be used singly or as an admixture of at least two kinds thereof. The no-reducing saccharide content of the non-silicate developer is preferably 0.1-30% by weight, and more preferably 1-20% by weight, in view of availability and easiness of concentration.

### (Processing Method)

It is preferred that an automatic developing machine is used in order to prepare a positive-working planographic printing plate.

It is preferred that the automatic developing machine used is equipped with a mechanism of automatically introducing a developer replenisher in a necessary amount into a developing bath, a mechanism of discharging any excessive developer and a device for automatically introducing water in necessary amounts to the developing bath. It is preferred that the automatic developing machine comprises a mechanism of detecting a planographic printing plate material to be transported, a mechanism of calculating the area to be processed of the planographic printing plate material based on the detection, or a mechanism of controlling a replenishing amount of a developer replenisher, a replenishing amount of water to be replenished or replenishing timing based on the detection and calculation. It is also preferred that the automatic developing machine comprises a mechanism of controlling a temperature of a developer, a mechanism of detecting a pH and/or electric conductivity of a developer, or a mechanism of controlling a replenishing amount of the developer replenisher, a replenishing amount of water to be replenished and/or the replenishing timing based on the detected pH and/or electric conductivity.

The automatic developing machine may be provided with a pre-processing section to allow the plate to be immersed in a pre-processing solution prior to development. The pre-processing section is provided preferably with a mechanism of spraying a pre-processing solution onto the plate surface, preferably with a mechanism of controlling the pre-processing solution at a temperature within the range of 25 to 55° C., and preferably with a mechanism of rubbing the plate surface with a roller-type brush. Water and the like are employed as the pre-processing solution.

The planographic printing plate material exposed and developed with the developer is preferably subjected to post-processing. The post-processing comprises the step of processing the developed planographic printing plate material with a post-processing solution such as washing water, a rinsing solution containing a surfactant, a finisher or a protective gumming solution containing gum arabic or starch derivatives as a main component. The post-processing is carried out employing an appropriate combination of the post-processing solutions described above. For example, a method is preferred in which the developed planographic printing plate material is post-washed with washing water, and then processed with a rinsing solution containing a surfactant, or a developed planographic printing plate precursor is post-washed with washing water, and then processed with a finisher, since it reduces fatigue of the rinsing solution or the finisher.

It is also preferred that a multi-step countercurrent processing is carried out employing a rinsing solution or a finisher. The post-processing is carried out employing an automatic developing machine having a development section and a post-processing section. In the post-processing step, the developed printing plate is sprayed with the post-processing solution from a spray nozzle or is immersed into the post-processing solution in a post-processing tank. A method is known in which supplies a small amount of water onto the developed printing plate precursor to wash the precursor, and reuses the water used for washing as dilution water for developer concentrate. In the automatic developing machine, a method is applied in which each processing solution is replenished with the respective processing replenisher according to the area of the printing plate precursor to have been processed or the operating time of the machine. A method (use-and-discard method) can be applied in which the developed printing plate material is processed with fresh processing solution and discarded. The thus obtained planographic printing plate is mounted on a printing press to print a large number of printing sheets.

### (Burning Treatment)

The planographic printing plate obtained above is subjected to burning treatment in order to obtain a printing plate with high printing durability.

When the planographic printing plate is subjected to burning treatment, it is preferred that prior to the burning treatment, the printing plate is surface-processed with a cleaning solution disclosed in Japanese Patent Publication Nos. 61-2518 and 55-28062, and Japanese Patent O.P.I. Publication Nos. 62-31859 and 61-159655.

As the surface-processing method, there is a method coating the cleaning solution on the planographic printing plate, employing a sponge or absorbent cotton impregnated with the cleaning solution, a method immersing the planographic printing plate in the vessel charged with the cleaning solution or a method coating the cleaning solution on the planographic printing plate employing an automatic coater. It is preferred that the coated cleaning solution is squeegeed with for example, a squeegee roller to give uniform coating.

The coating amount of the cleaning solution is ordinarily 0.03-0.8 g/m², in terms of dry coating amount. If necessary, a planographic printing plate coated with the cleaning solution is dried and heated to high temperature, employing a burning processor (for example, a burning processor BP-1300, available from Fuji Photo Film Co., Ltd.). The heating temperature is preferably 180-300° C., and the heating period is preferably 1-20 minutes, although they are different due to kinds of components forming an image.

A planographic printing plate subjected to burning treatment can be subjected to conventional processing such as water washing or gumming, if necessary, but when the cleaning solution containing a water-soluble polymer is used, desensitizing treatment such as gumming can be eliminated.

The thus obtained planographic printing plate is mounted on a printing press, followed by printing, whereby a large number of prints are obtained.

### (Packaging Material and Interleaf)

An interleaf is preferably inserted between the two of the planographic printing plate materials of the present invention, in order to prevent physical impact to the planographic printing plate material during storage or to minimize undesired impact during transportation. The Interleaf is selected from many kinds thereof.

As an interleaf, one, which is manufactured employing inexpensive materials, is often used in order to reduce material cost. Examples thereof include a paper sheet comprised of 100% wood pulp, a paper sheet comprised of wood pulp and synthetic pulp, and a paper sheet in which a low or high density polyethylene film is provided on the paper sheet comprised of 100% wood pulp or the paper sheet comprised of wood pulp and synthetic pulp. A paper sheet, which does not employ synthetic pulp or polyethylene film can be manufactured at low cost, since the material cot is low.

A preferred Interleaf is one having a basis weight of 30-60 g/m², a smoothness of 10-100 seconds, the smoothness measured according to a Bekk smoothness measuring method described in JIS 8119, a moisture content of 4-8% the moisture content measured according to a moisture content measuring method described in JIS 8127, and a density of 700-900 kg/m³. An interleaf is preferably one in which a polymer film is not laminated on the surface facing the light-sensitive layer, in order to absorb the residual solvents.

### (Printing)

Printing is carried out employing a conventional printing press.

In recent years, printing ink containing no petroleum volatile organic compound (VOC) has been developed and used in view of environmental concern. The present invention provides excellent effects in employing such a printing ink. Examples of such a printing ink include soybean oil ink “Naturalith 100” produced by Dainippon Ink Kagaku Kogyo Co., Ltd., VOC zero ink “TK HIGH ECO NV” produced by Toyo Ink Manufacturing Co., Ltd., and process ink “Soycelvo” produced by Tokyo Ink Co., Ltd.

### EXAMPLE

Next, the present invention will be explained in detail referring to examples, but embodiments of the present invention are not limited thereto. In the examples, “parts” is “parts by weight”, unless otherwise specified.

### (Preparation of Support)

### Preparation of Supports 1 and 2

A 0.24 mm thick aluminum plate (material 1050, refining H16) was immersed in an aqueous 5% by weight sodium hydroxide solution at 50° C. so as to give an aluminum dissolution amount of 2 g/m², washed with water, subsequently immersed in an aqueous 10% by weight nitric acid solution at 25° C. for 30 seconds to neutralize, and then washed with water.

Subsequently, the aluminum plate was subjected to electrolytic surface-roughening treatment in an electrolytic solution containing 10 g/liter of hydrochloric acid and 0.5 g/liter of aluminum at a current density of 60 A/dm² employing an alternating current with a sine waveform.

In this case, the distance between the plate surface and the electrode was 10 mm. The electrolytic surface-roughening treatment was divided into 12 treatments, in which the quantity of electricity used in one treatment (at anodic time) was 80 C/dm², and the total quantity of electricity used (at anodic time) was 960 C/dm². Standby time of 1 second, during which no surface-roughening treatment was carried out, was provided after each of the separate electrolytic surface-roughening treatments.

Subsequently, the resulting aluminum plate was immersed in an aqueous 10% by weight phosphoric acid solution at 50° C. and etched so as to give an aluminum etching amount (including smut produced on the surface) of 1.2 g/m², and washed with water.

Next, the aluminum plate was subjected to anodizing treatment in an aqueous 20% by weight sulfuric acid solution at a quantity of electricity of 250 C/dm² under a constant voltage of 20V, and washed with water. The aluminum plate surface was squeegeed to remove the residual water on the surface, and the plate was immersed in an aqueous 2% by weight sodium silicate No. 3 solution at 85° C. for 30 seconds, washed with water, then immersed in an aqueous 0.4% by weight polyvinyl phosphonic acid solution at 60° C. for 30 seconds, and washed with water. The aluminum plate surface being squeegeed, the aluminum plate was subjected to heating treatment at 130° C. for 50 seconds. Thus, a support was obtained.

The surface roughness Ra of the resulting support was 0.55 μm, measured by SE 1700a (available from Kosaka Kenkyusho Co., Ltd.). The support surface being observed with an SEM at a magnification of 100,000 times, the pore diameter of the anodization film was 40 nm. The polyvinyl phosphonic acid layer had a thickness of 0.01 μm.

### Example 1

### (Preparation of Planographic Printing Plate Material Sample)

### (Coating and Drying)

A light-sensitive layer coating solution with the following composition was coated on the above-described surface-treated substrate (support), employing a three-roll coater and dried at 120° C. for 1 minute so as to give a dry coating amount of 1.40 g/m².

The resulting planographic printing plate sample was cut into a size of 600 mm×400 mm, and the resulting plate was inserted with interleaf P to stack 200 sheets thereof. After drying the light-sensitive layer in this situation, an aging treatment was conducted at 50° C. and at absolute humidity of 0.037 kg/kg for 24 hours.

### (Interleaf P)

A content of 0.4% by weight of rosin sizing agent was added into the paper stock solution having a 4% concentration via bleached kraft pulp processing, and aluminum sulfate was added thereto so as to give a pH of 5. Thereafter, a reinforcing agent comprised mainly of starch, having a content of 5.0% by weight, was added into the resulting paper stock solution for papermaking to prepare interleaf P with a basis weight of 40 g/m² and a moisture content of 0.5%.

(light-sensitive layer coating solution)

| | |
|---|---|
| Acryl resin 1 | 10 parts |
| Cresol novolac resin (m/p = 6/4 and | 80 parts |
| a molecular weight of 4000) | |
| Victoria Pure Blue dye | 3.0 parts |
| Acid decomposable compound | Amount described |
| (refer to Table 1) | in Table 1 |
| Acid generating agent BR22 (The foregoing | 5.0 parts |
| exemplified compound) | |
| Infrared absorbing dye (Dye 1) | 5.0 parts |
| Fluorine-containing surfactant Megafac F178K | 0.8 parts |
| (produced by Dainippon Ink & Chemicals Inc.) | |
| compound containing a residue of | Amount described |
| a cyclic ureide compound | in Table 1 |
| Melamine group or triazine group-containing | Amount described |
| compound (refer to Table 1) | in Table 1 |

The above components were dissolved in a solvent of methyl ethyl ketone/1-methoxy-2-propanol (2/1) to prepare 1,000 parts by weight of a light-sensitive layer coating solution.

As described above, the compound of the present invention shown in Table 1, the acid decomposable compound and the melamine group, the triazine group-containing compound and so forth were employed to prepare planographic printing plate samples 1-21.

TABLE 1

| | Compound | | | | | | |
|---|---|---|---|---|---|---|---|
| | containing | | | | | | |
| | residue | | Acid | | Melamine group | | |
| | of cyclic | | decom- | | or triazine | | |
| | ureide | | posable | | group-containing | | |
| | compound | | compound | | compound | | |
| *1 | Kinds | *2 | Kinds | *2 | Kinds | *2 | Remarks |
| 1 | — | — | — | — | — | — | Comp. |
| 2 | — | — | A4 | 5 | — | — | Comp. |
| 3 | — | — | — | — | Melamine | 3 | Comp. |
| | | | | | resin | | |
| 4 | — | — | — | — | Triazine | 4 | Comp. |
| 5 | — | — | A4 | 5 | Melamine | 3 | Comp. |
| | | | | | resin | | |
| 6 | I-1 | 5 | — | — | — | — | Inv. |
| 7 | I-2 | 5 | — | — | — | — | Inv. |
| 8 | I-3 | 5 | — | — | — | — | Inv. |
| 9 | I-4 | 5 | — | — | — | — | Inv. |
| 10 | I-5 | 5 | — | — | — | — | Inv. |
| 11 | I-6 | 5 | — | — | — | — | Inv. |
| 12 | I-7 | 5 | — | — | — | — | Inv. |
| 13 | I-8 | 5 | — | — | — | — | Inv. |
| 14 | I-9 | 5 | — | — | — | — | Inv. |
| 15 | I-9 | 7.5 | — | — | — | — | Inv. |
| 16 | I-10 | 10 | — | — | — | — | Inv. |
| 17 | I-11 | 5 | A4 | 5 | — | — | Inv. |
| 18 | I-12 | 5 | A4 | 5 | — | — | Inv. |
| 19 | I-5 | 5 | A4 | 5 | Melamine | 3 | Inv. |
| | | | | | resin | | |
| 20 | I-7 | 5 | A4 | 5 | Triazine | 4 | Inv. |
| 21 | I-8 | 5 | A4 | 7 | Triazine | 4 | Inv. |

*1: Sample No.,
*2: parts,
Comp.: Comparative example,
Inv.: Present invention
A4: Acid decomposable compound A4, represented by Formula (1) Melamine group or triazine group-containing compound: Melamine resin SumirezResin 613 (produced by Sumitomo Chemical Co., Ltd.), and Triazine TAZ-107 (produced by Midori Kagaku Co., Ltd.)

### (Exposure and Development)

Employing PTR-4300 (manufactured by Dainippon Screen Manufacturing Co., Ltd.), each of the resulting planographic printing plate material samples was imagewise exposed at a drum rotation number of 1,000 rpm and at a resolution of 2400 dpi while the laser output power was changed from 30% to 100% to form a dot image with a screen line number of 175 lines. Herein, “dip” means a dot number per 2.54 cm.

Employing an automatic developing machine Raptor 85 Thermal (available from GLUNZ & JENSEN Co., Ltd.), the exposed sample was developed with developer TD-1 (available from Kodak Polychrome Graphics Co., Ltd.) at 30° C. for 15 seconds to obtain a planographic printing plate sample.

### <Evaluation>

### (Sensitivity)

The printing plate material sample was exposed to laser light while varying the laser light exposure energy, and developed in the same manner as above to obtain solid image portions and non-image portions. The optical density of the resulting non-image portions was measured through a densitometer D196 (produced by GRETAG Co., Ltd.). The exposure energy providing an optical density of the support (uncoated) surface optical density plus 0.01 was determined, and defined as sensitivity.

### (Development Latitude)

Employing PTR-4300 (manufactured by Dainippon Screen Manufacturing Co., Ltd.), each of the resulting positive working planographic printing plate material samples was imagewise exposed at a drum rotation number of 1000 rpm and at a resolution of 2400 dpi while the laser output power was changed from 30% to 100% to form a dot image of a test pattern with a screen line number of 175 lines.

Employing an automatic developing machine Raptor 85 Thermal (available from GLUNZ & JENSEN Co., Ltd.), exposed samples were developed with a (1:8) developer TD-1 (available from Kodak Polychrome Graphics Co., Ltd.) at 30° C. for 15 seconds. Ten thousand infrared thermal positive type printing plates were continuously developed with developer TP-W (available from Kodak Polychrome Graphics Co., Ltd.) to conduct a developing treatment at 30° C. for 5-30 seconds (at intervals of 4 seconds) employing the solution used for the above continuous treatment.

The developed sample was observed with a magnifier at a magnification of 50 times, and the developing time range during which neither contamination at non-image portions nor layer thickness reduction was determined and defined as development latitude.

### (Scratch Resistance)

The surface of the sample obtained above was scratched with a sapphire needle having a tip diameter of 0.5 mm through a scratch tester HEIDON-18 produced by Heidon Co., Ltd., load, the weight changed from 1 to 40 g at intervals of 1 g, being applied to the sapphire needle. The scratched sample was developed with a (1:4) high concentration developer TD-1 (available from Kodak Polychrome Graphics Co., Ltd.), and the scratched portions were observed. A minimum load (g) at which the layer was peeled off the support was observed. The more the minimum load is, the higher the scratch resistance.

The above-described evaluation results are shown in Table 2.

TABLE 2

| | | Development | Scratch | |
|---|---|---|---|---|
| Sample | Sensitivity | latitude | resistance | |
| No. | (mJ/cm²) | (sec) | (g) | Remarks |
| 1 | 260 | 5 | 1 | Comp. |
| 2 | 190 | 15 | 2 | Comp. |
| 3 | 210 | 10 | 2 | Comp. |
| 4 | 200 | 15 | 1 | Comp. |
| 5 | 180 | 15 | 3 | Comp. |
| 6 | 150 | 25 | 3 | Inv. |
| 7 | 140 | 30 | 3 | Inv. |
| 8 | 130 | 35 | 4 | Inv. |
| 9 | 130 | 40 | 4 | Inv. |
| 10 | 150 | 30 | 3 | Inv. |
| 11 | 120 | 50 | 4 | Inv. |
| 12 | 150 | 50 | 3 | Inv. |
| 13 | 120 | 55 | 4 | Inv. |
| 14 | 110 | 60 | 4 | Inv. |
| 15 | 130 | 50 | 4 | Inv. |
| 16 | 105 | 65 | 4 | Inv. |
| 17 | 100 | 75 | 4 | Inv. |
| 18 | 120 | 65 | 4 | Inv. |
| 19 | 95 | 75 | 5 | Inv. |
| 20 | 90 | 70 | 5 | Inv. |
| 21 | 100 | 60 | 5 | Inv. |

Comp.: Comparative example,
Inv.: Present invention

As is clear from Table 2, it is to be understood that positive-working planographic printing plate material samples of the present invention exhibit excellent sensitivity, development latitude and scratch resistance in comparison to those of Comparative examples.

### Example 2

The following two light-sensitive layer planographic printing plate material samples were prepared employing the substrate (support) produced in Example 1.

(Preparation of Planographic Printing Plate Material Samples with Two Light-Sensitive Layers)

### (Coating and Drying)

A lower light-sensitive layer coating solution with the following composition was coated on the above-described surface-treated support (substrate), employing a three-roll coater and dried at 120° C. for 1 minute so as to give a dry coating amount of 0.85 g/m².

Thereafter, an upper light-sensitive layer coating solution with the following composition was coated, employing a double-roll coater and dried at 120° C. for 1.5 minutes so as to give a dry coating amount of 0.25 g/m². Further, the resulting positive-working planographic printing plate material sample was cut into a size of 600 mm×400 mm, and the resulting plate was inserted with interleaf P to stack 200 sheets thereof. After coating and drying the light-sensitive layer in this situation, an aging treatment was conducted at 50° C. and at absolute humidity of 0.037 kg/kg for 24 hours.

### (Interleaf P)

A content of 0.4% by weight of rosin sizing agent was added into the paper stock solution having a 4% concentration via bleached kraft pulp processing, and aluminum sulfate was added thereto so as to give a pH of 5. Thereafter, a reinforcing agent comprised mainly of starch, having a content of 5.0% by weight, was added into the resulting paper stock solution for papermaking to prepare interleaf P with a basis weight of 40 g/m² and a moisture content of 0.5%.

(Lower light-sensitive layer coating solution)

| | |
|---|---|
| Acryl resin 1 | 80 parts |
| Victoria Pure Blue dye | 3.0 parts |
| Acid decomposable compound (refer to | Amount described |
| Tables 3 and 6) | in Tables 3 and 6 |
| Lower layer acid generating agent (refer to | Amount described |
| Tables 3 and 6) | in Tables 3 and 6 |
| Infrared absorbing dye (Dye 1) | 5.0 parts |
| Fluorine-containing surfactant Megafac F178K | 0.8 parts |
| (produced by Dainippon Ink & Chemicals Inc.) | |
| Compound containing residue of | Amount described |
| cyclic ureide compound (refer to | in Tables 3 and 6 |
| Tables 3 and 6) | |

The above components were dissolved in a solvent of γ-butyrolactone/methyl ethyl ketone/1-methoxy-2-propanol (1/2/1) to prepare 1,000 parts by weight of a lower layer coating solution.

(Upper light-sensitive layer coating solution)

| | |
|---|---|
| Cresol novolac resin (m/p = 6/4 and | 80 parts |
| a molecular weight of 4000) | |
| Acryl resin 1 | 4.0 parts |
| Infrared absorbing dye (Dye 1) | 1.5 parts |
| Fluorine-containing surfactant Megafac F178K | 0.5 parts |
| (produced by Dainippon Ink & Chemicals Inc.) | |
| Upper layer acid generating agent (refer to | Amount described |
| Tables 4 and 7) | in Tables 4 and 7 |
| Acrylic resin containing a fluoroalkyl group | Amount described |
| (refer to Tables 4 and 7) | in Tables 4 and 7 |
| Compound containing residue of | Amount described |
| cyclic ureide compound. (refer to | in Tables 4 and 7 |
| Tables 4 and 7) | |

The above components were dissolved in a solvent of methyl ethyl ketone/1-methoxy-2-propanol (1/2) to prepare 1,000 parts by weight of an upper layer coating solution.

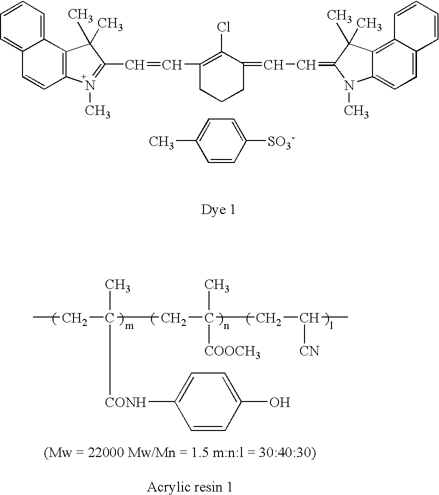

As described above, upper and lower light-sensitive layers were formed employing components shown in Tables 3 and 6 to prepare positive-working planographic printing plate material samples 1-13. Further, upper and lower light-sensitive layers were formed employing components shown in Tables 4 and 7 to prepare positive-working planographic printing plate material samples 14-26.

The same items as in Example 1 were evaluated via the same exposure and development as in Example 1.

Evaluation results are shown in Tables 5 and 8.

TABLE 3

| | Lower layer | | | | | | |
|---|---|---|---|---|---|---|---|
| | Compound | | | | | | |
| | containing | | | | | | |
| | residue | | Acid | | | | |
| | of cyclic | | decom- | | Acid | | |
| | ureide | | posable | | generating | | |
| Sample | compound | | compound | | agent | | |
| No. | Kinds | *1 | Kinds | *1 | Kinds | *1 | Remarks |
| 1 | — | — | — | — | — | — | Comp. |
| 2 | — | — | A4 | 5 | BR22 | 3 | Comp. |
| 3 | — | — | — | — | — | — | Comp. |
| 4 | — | — | — | — | TAZ107 | 3 | Comp. |
| 5 | — | — | A4 | 5 | — | — | Comp. |
| 6 | I-1 | 5 | — | — | — | — | Inv. |
| 7 | I-2 | 5 | A4 | 5 | — | — | Inv. |
| 8 | I-3 | 5 | A4 | 5 | BR22 | 3 | Inv. |
| 9 | I-4 | 5 | A4 | 5 | BR22 | 3 | Inv. |
| 10 | I-5 | 5 | A4 | 5 | BR22 | 3 | Inv. |
| 11 | I-6 | 5 | A4 | 5 | BR22 | 3 | Inv. |
| 12 | I-7 | 5 | A4 | 5 | BR22 | 3 | Inv. |
| 13 | I-8 | 5 | A4 | 5 | TAZ107 | 3 | Inv. |

*1: Parts by weight
Comp.: Comparative example
Inv.: Present invention
A4: Acid decomposable compound BR22 (previously shown)

TABLE 4

| | Upper layer | | | | | | |
|---|---|---|---|---|---|---|---|
| | Compound | | | | | | |
| | containing | | | | | | |
| | residue of | | Acid | | | | |
| | cyclic ureide | | generating | | Fluoroacrylic | | |
| Sample | compound | | agent | | resin | | |
| No. | Kinds | *1 | Kinds | *1 | Kinds | *1 | Remarks |
| 1 | — | — | — | — | — | — | Comp. |
| 2 | — | — | — | — | — | — | Comp. |
| 3 | — | — | S1 | 4 | — | — | Comp. |
| 4 | — | — | S1 | 4 | AP-1 | 10 | Comp. |
| 5 | — | — | S1 | 4 | AP-1 | 10 | Comp. |
| 6 | I-1 | 5 | — | — | — | — | Inv. |
| 7 | I-2 | 5 | — | — | — | — | Inv. |
| 8 | I-3 | 5 | — | — | — | — | Inv. |
| 9 | I-4 | 5 | — | — | — | — | Inv. |
| 10 | I-5 | 5 | S1 | 4 | AP-1 | 10 | Inv. |
| 11 | I-6 | 5 | S1 | 4 | AP-1 | 10 | Inv. |
| 12 | I-7 | 5 | S1 | 4 | AP-1 | 10 | Inv. |
| 13 | I-10 | 5 | S1 | 4 | AP-1 | 10 | Inv. |

*1: Parts by weight
Comp.: Comparative example
Inv.: Present invention
S1: Acid generating agent (shown below)
AP-1: Fluoroacrylic resin described in Japanese Patent O.P.I. Publication
No. 2006-106723

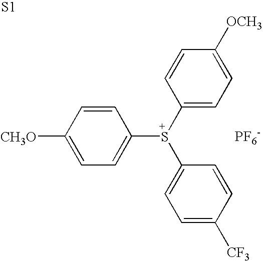

TABLE 5

| | | Development | Scratch | |
|---|---|---|---|---|
| Sample | Sensitivity | latitude | resistance | |
| No. | (mJ/cm²) | (sec) | (g) | Remarks |
| 1 | 160 | 20 | 1 | Comp. |
| 2 | 140 | 30 | 1 | Comp. |
| 3 | 155 | 20 | 1 | Comp. |
| 4 | 140 | 25 | 2 | Comp. |
| 5 | 150 | 25 | 2 | Comp. |
| 6 | 90 | 60 | 3 | Inv. |
| 7 | 80 | 70 | 3 | Inv. |
| 8 | 110 | 45 | 3 | Inv. |
| 9 | 80 | 80 | 3 | Inv. |
| 10 | 90 | 70 | 4 | Inv. |
| 11 | 100 | 60 | 3 | Inv. |
| 12 | 70 | 90 | 5 | Inv. |
| 13 | 60 | 100 | 5 | Inv. |

Comp.: Comparative example,
Inv.: Present invention

TABLE 6

| | Lower layer | | | | | | |
|---|---|---|---|---|---|---|---|
| | Compound | | | | | | |
| | containing | | Acid | | | | |
| | residue of | | decom- | | Acid | | |
| | cyclic ureide | | posable | | generating | | |
| Sample | compound | | compound | | agent | | |
| No. | Kinds | *1 | Kinds | *1 | Kinds | *1 | Remarks |
| 14 | — | — | — | — | — | — | Comp. |
| 15 | — | — | A4 | 5 | BR22 | 3 | Comp. |
| 16 | — | — | — | — | — | — | Comp. |
| 17 | — | — | — | — | TAZ107 | 3 | Comp. |
| 18 | — | — | A4 | 5 | — | — | Comp. |
| 19 | Uracilic acid | 5 | — | — | — | — | Inv. |
| | derivative (1) | | | | | | |
| 20 | Uracilic acid | 5 | A4 | 5 | — | — | Inv. |
| | derivative (3) | | | | | | |
| 21 | Uracilic acid | 5 | A4 | 5 | BR22 | 3 | Inv. |
| | derivative (6) | | | | | | |
| 22 | Uracilic acid | 5 | A4 | 5 | BR22 | 3 | Inv. |
| | derivative (8) | | | | | | |
| 23 | Uracilic acid | 5 | A4 | 5 | BR22 | 3 | Inv. |
| | derivative (9) | | | | | | |
| 24 | Uracilic acid | 5 | A4 | 5 | BR22 | 3 | Inv. |
| | derivative (12) | | | | | | |
| 25 | Uracilic acid | 5 | A4 | 5 | BR22 | 3 | Inv. |
| | derivative (15) | | | | | | |
| 26 | Uracilic acid | 5 | A4 | 5 | TAZ107 | 3 | Inv. |
| | derivative (18) | | | | | | |

*1: Parts by weight
Comp.: Comparative example
Inv.: Present invention
A4: Acid decomposable compound BR22 (previously shown)

TABLE 7

| | Upper layer | | | | | | |
|---|---|---|---|---|---|---|---|
| | Compound | | | | | | |
| | containing | | | | | | |
| | residue of | | Acid | | | | |
| | cyclic ureide | | generating | | Fluoroacrylic | | |
| Sample | compound | | agent | | resin | | |
| No. | Kinds | *1 | Kinds | *1 | Kinds | *1 | Remarks |
| 1 | — | — | — | — | — | — | Comp. |
| 2 | — | — | — | — | — | — | Comp. |
| 3 | — | — | S1 | 4 | — | — | Comp. |
| 4 | — | — | S1 | 4 | AP-1 | 10 | Comp. |
| 5 | — | — | S1 | 4 | AP-1 | 10 | Comp. |
| 6 | Uracilic acid | 5 | — | — | — | — | Inv. |
| | derivative (1) | | | | | | |
| 7 | Uracilic acid | 5 | — | — | — | — | Inv. |
| | derivative (3) | | | | | | |
| 8 | Uracilic acid | 5 | — | — | — | — | Inv. |
| | derivative (6) | | | | | | |
| 9 | Uracilic acid | 5 | — | — | — | — | Inv. |
| | derivative (8) | | | | | | |
| 10 | Uracilic acid | 5 | S1 | 4 | AP-1 | 10 | Inv. |
| | derivative (9) | | | | | | |
| 11 | Uracilic acid | 5 | S1 | 4 | AP-1 | 10 | Inv. |
| | derivative (12) | | | | | | |
| 12 | Uracilic acid | 5 | S1 | 4 | AP-1 | 10 | Inv. |
| | derivative (15) | | | | | | |
| 13 | Uracilic acid | 5 | S1 | 4 | AP-1 | 10 | Inv. |
| | derivative (18) | | | | | | |

*1: Parts by weight
Comp.: Comparative example
Inv.: Present invention
S1: Acid generating agent (shown below)
AP-1: Fluoroacrylic resin described in Japanese Patent O.P.I. Publication No. 2006-106723

TABLE 8

| | | Development | Scratch | |
|---|---|---|---|---|
| Sample | Sensitivity | latitude | resistance | |
| No. | (mJ/cm²) | (sec) | (g) | Remarks |
| 14 | 160 | 20 | 1 | Comp. |
| 15 | 140 | 30 | 1 | Comp. |
| 16 | 155 | 20 | 1 | Comp. |
| 17 | 140 | 25 | 2 | Comp. |
| 18 | 150 | 25 | 2 | Comp. |
| 19 | 95 | 55 | 3 | Inv. |
| 20 | 85 | 65 | 3 | Inv. |
| 21 | 115 | 40 | 5 | Inv. |
| 22 | 85 | 75 | 3 | Inv. |
| 23 | 95 | 65 | 4 | Inv. |
| 24 | 105 | 55 | 5 | Inv. |
| 25 | 75 | 85 | 4 | Inv. |
| 26 | 65 | 95 | 3 | Inv. |

Comp.: Comparative example,
Inv.: Present invention

As is clear from Tables 5 and 8, it is to be understood that planographic printing plate material samples of the present invention exhibit excellent sensitivity, development latitude and scratch resistance in comparison to those of Comparative examples.

### EFFECT OF THE INVENTION

By utilizing the foregoing structures, provided is a planographic printing plate material exhibiting scratch resistance useful for high productivity in large size printing, and excellent sensitivity and development latitude against a developer having a pH of not more than 13.0 or a worn-out inactive developer, as well as a method of preparing a positive-working planographic printing plate employing the planographic printing plate material.

The mechanism of the present invention is not clear, but it is assumed that a compound containing a residue of a cyclic ureide compound having at least two amide bonds is capable of having at least two hydrogen bonds with respect to the one compound, and mechanical strength is improved at image portions together with solubility lowered against a developer and chemicals since at least one of intercomound interaction and inter additive interaction is further enhanced to improve mechanical strength at image portions, scratch resistance, resistance to chemicals and printing durability (refer to the following chemical structure 1).

On the other hand, it is assumed that non-image portions are easy to be dissolved with a developer since the above-described hydrogen bonds are thermally released via exposure to light to improve sensitivity and development latitude. This effect is presumably produced by adding melamine or triazine capable of having four hydrogen bonds together with the above-described residue of the cyclic ureide compound having at least two amide bonds in a light-sensitive layer, and by having a situation where the cyclic ureide compound is hydrogen-bonded to a compound containing a melamine group or a triazine group (refer to the following chemical structure 2).

These are presumably caused by forming a supermolecule via the compound of the present invention, at least one of the intercomound interaction and the inter additive interaction, and the hydrogen bonding.

The effect of the present invention can further be produced by using a specific acid decomposable compound, acid generating compound and resin binder in combination, in addition to the compound containing the residue of the cyclic ureide compound having the above-described amide bonds. This is further effective in the case of a functionally separated light-sensitive layer having a two light-sensitive layer structure, and excellent printing plates can be obtained by utilizing and dispensing the compound of the present invention appropriately, and placing it in the right places.

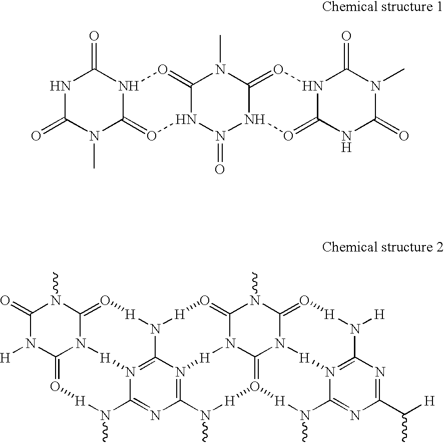

What is claimed is:

1. A positive-working planographic printing plate material comprising a support and provided thereon, a light-sensitive layer,
wherein the light-sensitive layer comprises a compound containing a residue of a cyclic ureide compound having a cyclic structure having at least two amide bonds (—NHCO—) in a cycle.

2. The positive-working planographic printing plate material of claim 1,
wherein the compound containing a residue of a cyclic ureide compound comprises a compound containing a residue of another cyclic ureide compound, and at least two hydrogen bonds.

3. The positive-working planographic printing plate material of claim 1,
wherein the compound containing a residue of a cyclic ureide compound forms a supermolecule via hydrogen bonding.

4. The positive-working planographic printing plate material of claim 1,
wherein the cyclic ureide compound having the cyclic structure is urazol, a parabanic acid, uracil, thymine, orotic acid or an isocyanuric acid.

5. The positive-working planographic printing plate material of claim 1,
wherein the light-sensitive layer comprises an acid decomposable compound and an acid generating compound.

6. The positive-working positive-working planographic printing plate material of claim 5,
wherein the acid decomposable compound is represented by Formula (1): 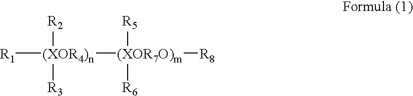
wherein R₁ represents a hydrogen atom, an alkyl group, an aryl group, an alkoxy group, an aryloxy group or a halogen atom; each of R₂ and R₅ represents a hydrogen atom, an alkyl group or an aryl group; each of R₃ and R₆ represents an alkyl group or an aryl group; R₄ represents an ethyleneoxy group or a propyleneoxy group; R₂ and R₃, or R₅ and R₆ may combine with each other to form a substituted ring; R₇ represents an alkylene group; R₈ represents a hydrogen atom, —XR₂R₃R₁ or —XR₅R₆R₁; X represents a carbon atom or a silicon atom; n represents an integer of 1 or more; and m represents an integer of 0 or more.

7. The positive-working planographic printing plate material of claim 6,
wherein the compound represented by Formula (1) is acetal.

8. The positive-working planographic printing plate material of claim 1,
wherein the light-sensitive layer comprises an upper light-sensitive layer and a lower light-sensitive layer, and
at least one of the light-sensitive layers comprises the residue of the cyclic ureide compound having the cyclic structure.

9. The positive-working planographic printing plate material of claim 8,
wherein the lower light-sensitive layer comprises a compound represented by Formula (1) or a compound represented by the following Formula (2):
R¹—C(X)₂—(C═O)—R² Formula (2)
wherein R¹ represents a hydrogen atom, a bromine atom, a chlorine atom, an alkyl group, an aryl group, an acyl group, an alkylsulfonyl group, an arylsulfonyl group, an iminosulfonyl group or a cyano group; R² represents a hydrogen atom or a monovalent organic substituent, but R¹ and R² may combine with each other to form a ring; and X represents a bromine atom or a chlorine atom.

10. The positive-working planographic printing plate material of claim 1,
wherein the light-sensitive layer comprises a compound containing a melamine group or a triazine group.

11. The positive-working planographic printing plate material of claim 10,
wherein the compound is a resin.

12. The positive-working planographic printing plate material of claim 10,
wherein the light-sensitive layer comprises the compound containing a residue of a cyclic ureide compound hydrogen-bonded to the compound containing a melamine group or a triazine group.

13. The positive-working planographic printing plate material of claim 1,
wherein the light-sensitive layer comprises an infrared absorbing compound.

14. The positive-working planographic printing plate material of claim 1,
wherein the support is made of aluminum.

15. The positive-working planographic printing plate material of claim 1,
wherein the positive-working planographic printing plate material is an alkaline-developing planographic printing plate material.

16. A method of preparing a planographic printing plate comprising the steps of:
exposing the positive-working planographic printing plate material of claim 1 to infrared laser having a wavelength of 780-1200 nm; and
treating the planographic printing plate material with an alkaline developer to remove non-image portions.
